(19) United States
(12) Patent Application Publication
(10) Pub. No.: US 2023/0343504 A1
(43) Pub. Date: Oct. 26, 2023

(54) IMPROVED PERFORMANCE OF CONVERTER

(71) Applicant: EGGTRONIC ENGINEERING SPA, Modena (IT)

(72) Inventors: Igor SPINELLA, Modena (IT); Andrea ZANETTI, Modena (IT); Lorenzo FERRARI, Modena (IT); Filippo MUCCINI, Modena (IT); Fabrizio CARAMASCHI, Modena (IT); Alice ROVERSI, Modena (IT); Davide ANTONELLI, Modena (IT)

(21) Appl. No.: 18/017,203

(22) PCT Filed: Jul. 20, 2021
(86) PCT No.: PCT/EP2021/070298

§ 371 Date: Jan. 20, 2023

(30) Foreign Application Priority Data
Jul. 20, 2020 (GB) 2011208.2
Jan. 8, 2021 (GB) 2100262.1
May 28, 2021 (GB) 2107640.1

(51) Int. Cl. H01F 27/26; H01F 27/28

(52) U.S. Cl. CPC H01F 27/266; H01F 27/2804

(57) ABSTRACT

There is provided an electromagnetic device comprising multiple inductors. Each inductor having windings arranged near or on a single core, in which the device is configured such that the multiple inductors are substantially independent or magnetically isolated from one another.

### BACKGROUND OF THE INVENTION

### 1. Field of the Invention

The field of the invention relates to power converters, and more particularly, to power converters including an electromagnetic device comprising multiple inductors, and to methods of operating or controlling the power converters.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### 2. Description of the Prior Art

Magnetic elements are essential components in a lot of circuits, such as switching circuits. They are used for example in a number of converter circuit topologies such as buck, boost, buck-boost, flyback, forward, LLC, LCC, or class-E and class F.

Depending on the size of the inductor and the switch-on time of the switches, different operating modes may be used: continuous current mode, critical/boundaries current mode or discontinuous current mode.

Critical current mode and discontinuous current mode are often used to achieve very good efficiency because of a reduction in switching losses. However these modes also increase the ripple in the inductor at the expense of losses in the inductor because of increased losses for hysteresis and eddy currents in the core of the inductor, skin effect and proximity effect in the wire of the inductor, radiated and conducted emissions, and therefore typically require the use of bigger cores and additional filters (at both input and output). Hence the topologies are often more oversized as compared to continuous current mode topologies.

In general, for each of the operation modes, inductors are typically very bulky.

A common technique for reducing the size of the inductors includes using multiphase systems, in which converter circuits include several branches in parallel.

Multiphase converters are also referred to as interleaved systems in which multiple branches in parallel work out of phase with each other, with the aim of reducing the current in each branch, and reducing the current ripple. Interleaved systems are also able to reduce the power dissipated as well as the size of the components due to the reduction of losses. Interleaved systems are often used for high power applications, such as above 1 kW applications.

However, there is still a need for a solution that would provide an inductor achieving high efficiency while being less bulky in physical size, even at low power applications.

The Wireless Power Consortium (WPC) defines a switching frequency between 110 and 205 kHz in its Qi wireless inductive standard, which is able to deliver up to 30 W and is broadly adopted by most phone manufacturers. The coupling factor k is in the range from 0.75 to 0.5 (charging distance approximately from 2 mm to 7 mm).

When the distance increases over 10 mm the coupling factor k between the transmitter and receiver coils becomes low and the Qi system is usually not able to transfer energy.

It is recommended by WPC to tune the natural frequency of Qi wireless systems to around 100 kHz using an LC resonant tank, where the inductance L is given by the transmitting coil. This allows the wireless charger to work close to the maximum power transfer while remaining safely far from the resonance and thus simplifying the feedback loop control.

Inductive wireless power transfer is a well-known technology capable to re-charge and supply electronic devices from a few Watts up to several kWatts.

A conventional wireless power transfer system for low power application is typically made of several power conversion stages including:
a transmitter comprising an AC/DC isolated adapter, an optional DC/DC power converter (usually a buck, a boost or a buck-boost converter) and a DC/AC Converter for coil driving.

an isolation barrier between the transmitting coil located in the transmitter and the receiving coil located in the receiver.
a receiver comprising an AC/DC rectifier circuit and a DC/DC power converter (a linear converter or a switching converter) able to act as battery charger, a voltage regulator or a current regulator.

Because of the number of stages in the wireless power transfer system each adds some inefficiency, the overall system can usually achieve only up to 60% of efficiency measured from AC input to DC output.

The wireless power transmitter that excites the transmitting coil may be configured using a number of topologies including for example class D topology, Class E topology or push pull Class E amplifier.

However, standard topologies still either suffer from either high radiation emissions or the use of a large number of components, very low efficiency or efficiency strongly dependent on the load conditions. There is a need for a simplified solution that would meet the radiation emission regulations as well as provide high efficiency over a broad range of load variation while being able to provide high power.

The present invention addresses the above vulnerabilities and also other problems not described above.

### SUMMARY OF THE INVENTION

The invention relates to an electromagnetic device comprising multiple inductors, as defined in the appended Claims. The device is being configured such that the multiple inductors are substantially independent or magnetically isolated from one another.

A consolidated list of key features is at the Appendix.

### BRIEF DESCRIPTION OF THE FIGURES

Aspects of the invention will now be described, by way of example(s), with reference to the following Figures, which each show features of the invention:

FIG. 1 shows top views of a single inductor used in a converter system and of two inductors in parallel used in an interleaved system.

FIG. 2 shows cross sectional views of a single inductor used in a converter system and of two inductors implemented in an interleaved system.

FIG. 3 shows an electromagnetic device with multiple independent inductors wound on a single core of magnetic material.

FIG. 4 shows a sectional view of an assembled electromagnetic device including a plastic component or coil former.

FIG. 5 shows different views of two inductors in parallel implemented in an interleaved converter system as compared to an assembled electromagnetic device with two independent inductors.

FIG. 6 shows further examples of windings configuration including a calibrated gap.

FIG. 7 shows an electromagnetic device configuration with three multiple inductors.

FIG. 8 shows a weakly coupled transformer.

FIG. 9 shows a plot of the drain voltage of an interleaved boost converter implementing a weakly coupled transformer with k=0.

FIG. 10 shows a plot of the inductor current of an interleaved boost converter implementing a weakly coupled transformer with k=0.

FIG. 11 shows a plot of the drain voltage of an interleaved boost converter implementing a weakly coupled transformer with k about 0.35.

FIG. 12 shows a plot of the inductor current of an interleaved boost converter implementing a weakly coupled transformer with k about 0.35.

FIG. 13 shows a circuit diagram of a power factor conversion (PFC) circuit comprising a weakly coupled transformer.

FIG. 14 shows a plot of the waveforms related to branch 131 of the boost converter.

FIG. 15 shows a perspective view of a 3D CAD model of the plastic component (or coil former) to wind the wires of the weakly coupled transformer.

FIG. 16 shows a top view of a 3D CAD model of the plastic component to wind the wires of the weakly coupled transformer. When not specified, dimensions are expressed in mm.

FIG. 17 shows a cross section view of a 3D CAD model of the plastic component to wind the wires of the weakly coupled transformer.

FIG. 18 shows an assembled weakly coupled transformer.

FIG. 19 shows an LLC converter including the half-bridge implementation of the switching network and a full-wave rectifier.

FIG. 20 shows a plot of the output voltage in dB illustrating a change in resonant frequency related to the load increase.

FIG. 21 shows an example of an LLC resonant converter.

FIG. 22 shows an LLC resonant converter.

FIG. 23 shows an example of windings configuration of the LLC resonant converter.

FIG. 24 shows a further example of windings configuration of the LLC resonant converter.

FIG. 25 shows a further example of windings configuration of the LLC resonant converter.

FIG. 26 shows further examples of windings configuration including a dummy wire winding.

FIG. 27 shows examples of windings configuration including planar windings printed on a PCB.

FIG. 28 shows another example of windings configuration including planar windings printed on a PCB.

FIG. 29 shows plots of the control signals for the different windings configuration.

FIG. 30 shows plots of the control signals for the different windings configuration.

FIG. 31 shows plots of the voltage Vout of FIG. 22 using the different windings configuration.

FIG. 32 shows plots of the voltage Vout of FIG. 22 using the different windings configuration.

FIG. 33 shows an example of a circuit capable of generating an active-low enable signal for the ideal diode controllers.

FIG. 34 shows plots of the voltage of different signals of FIG. 33.

FIG. 35 shows a conventional wireless charging circuit.

FIG. 36 shows a conventional wireless power transmitter implemented using a Class D topology.

FIG. 37 shows a conventional wireless power transmitter implemented using a Class E topology.

FIG. 38 shows a conventional wireless power transmitter implemented using a Class E push pull topology.

FIG. 39 shows a plot of the signals of the circuit of FIG. 38.

FIG. 40 shows a single isolated device that integrates an AC/DC converter and wireless charger.

FIG. 41 shows an integrated AC/DC converter and wireless power transmitter provided as a single stage.

FIG. 42 shows a proposed short range topology of the integrated AC/DC converter.

FIG. 43 shows a plot of the currents measured at the inductor L1.

FIG. 44 shows the line tendencies for the PushPull, Switching nodes, coil voltage and coil current.

FIG. 45 shows a proposed long range topology of the integrated AC/DC converter.

FIG. 46 shows the line tendencies for the PushPull, Switching nodes, coil voltage and coil current.

FIG. 47 shows circuit diagrams of the single stage bridgeless and capless wireless architecture.

FIG. 48 shows a circuit comprising a resonant class D inverter with the addition of the sensing network.

FIG. 49 shows a plot of the voltage at the node between L1 and C1.

FIG. 50 shows a plot of the voltage at the node between R1 and R2.

FIG. 51 shows a plot of the voltage at the node between C2 and R3.

FIG. 52 shows a diagram of a distance calibration setup.

FIG. 53 shows the working principle of the calibration setup.

FIG. 54 shows a diagram of an insulated converter with the secondary side circuit configured as a voltage doubler.

FIG. 55 shows a diagram of an insulated converter with the secondary side circuit configured as a full bridge circuit.

FIG. 56 shows a diagram illustrating the different phases of the insulated converter.

FIG. 57 shows a diagram illustrating the different phases of the insulated converter.

FIG. 58 shows a diagram illustrating the different phases of the insulated converter.

FIG. 59 shows a diagram illustrating the different phases of the insulated converter.

FIG. 60 shows a diagram illustrating the different phases of the insulated converter.

FIG. 61 shows a diagram illustrating the different phases of the insulated converter.

FIG. 62 shows a diagram illustrating the different phases of the insulated converter.

FIG. 63 shows a diagram illustrating the different phases of the insulated converter.

FIG. 64 shows a diagram of the insulated converter used as an isolated PFC.

Index

| | |
|---|---|
| Electromagnetic device with multiple inductors | 1 |
| First inductor wound on single magnetic core | 10 |
| Second inductor wound on single magnetic core | 11 |
| Magnetic core | 12 |
| Gap of first lateral leg of the magnetic core | 13 |
| Gap of second lateral leg of the magnetic core | 14 |
| Flux path of the first inductor | 15 |
| Flux path of the second inductor | 16 |
| Central leg of magnetic core | 17 |
| Bottom part of plastic component or coil former | 41 |
| Top part of plastic component or coil former | 42 |
| First inductor of the electromagnetic device including three inductors | 70 |
| Second inductor of the electromagnetic device including three inductors | 71 |
| Third inductor of the electromagnetic device including three inductors | 72 |
| Central leg of the electromagnetic device including three inductors | 74 |
| Visible gap on one of the lateral leg | 75 |
| Visible gap on another lateral leg | 76 |
| Weakly coupled transformer | 80 |
| Primary winding of weakly coupled transformer | 81 |
| Secondary winding of weakly coupled transformer | 82 |
| Magnetic core of weakly coupled transformer | 83 |
| Central air gap of weakly coupled transformer | 84 |
| First lateral air gap of weakly coupled transformer | 85 |
| Second lateral air gap of weakly coupled transformer | 86 |
| First branch of the boost converter | 131 |
| Second branch of the boost converter | 132 |
| Switch or MOSFET of branch 131 | 133 |
| Switch or MOSFET of branch 132 | 134 |
| First switch of LLC converter | 220 |
| DC voltage input of LLC converter | 221 |
| Half bridge or switching node | 222 |
| Second switch of LLC converter | 223 |
| Ground input of LLC converter | 224 |
| Central leg of single core of a weakly coupled transformer | 230 |
| Lateral leg of single core of a weakly coupled transformer | 231 |
| Lateral leg of single core of a weakly coupled transformer | 232 |
| End member of single core of a weakly coupled transformer | 233 |
| End member of single core of a weakly coupled transformer | 234 |
| Air gap of central leg | 235 |
| Primary winding of transformer | 236 |
| Secondary winding of transformer | 237 |
| Central leg of single core of a weakly coupled transformer | 240 |
| Lateral leg of single core of a weakly coupled transformer | 241 |
| Lateral leg of single core of a weakly coupled transformer | 242 |
| End member of single core of a weakly coupled transformer | 243 |
| End member of single core of a weakly coupled transformer | 244 |
| Air gap of central leg | 245 |
| Primary winding of transformer | 246 |
| Secondary winding of transformer | 247 |
| Primary winding | 250 |
| First secondary winding | 251 |
| Second secondary winding | 252 |
| Central leg of magnetic core | 253 |
| Air gap of central leg | 254 |
| Primary winding | 260 |
| Coil former | 261 |
| Opening for inserting magnetic core | 262 |
| Dummy winding | 263 |
| Secondary winding | 264 |
| Separation layer between primary and secondary winding | 266 |
| Calibrated coil former for the secondary winding | 267 |
| Substrate or PCB for printing the planar inductors | 280 |
| Transmitter coil of wireless charger | 520 |
| Wireless repeater | 521 |
| First inductor of the wireless repeater | 523 |
| Second inductor of the wireless repeater | 524 |
| Series resonant capacitor of wireless repeater | 525 |

### DETAILED DESCRIPTION

The specification is organised around the following categories or core technology:
SECTION I. IMPROVED PERFORMANCE OF CONVERTERS
SECTION II. IMPROVED LLC CONVERTER
SECTION III. WIRELESS CHARGING
SECTION IV. INSULATED CONVERTER

### Section I. Improved Performance of Converters

### 1.1 Multiple Independent Inductors on a Single Core

Multi-phase converters, also called interleaved converters, are typically able to achieve the following goals:
Reduction of the power dissipated (in the case of a two-branch system, a factor 2 of reduction of the current leads by a reduction of a factor 4 of the power dissipated in each branch R * I ^ 2, and therefore of a halving of the power dissipated overall).
Reduction of the size of the components due to the reduction of losses. Typically, the doubling of the number of components is more than compensated, in particular for high powers (for example hundreds or thousands of watts) by the reduced dimensions.
Reduction of the output ripple.
Reduction of radiated and conducted emissions due to noise cancellation.

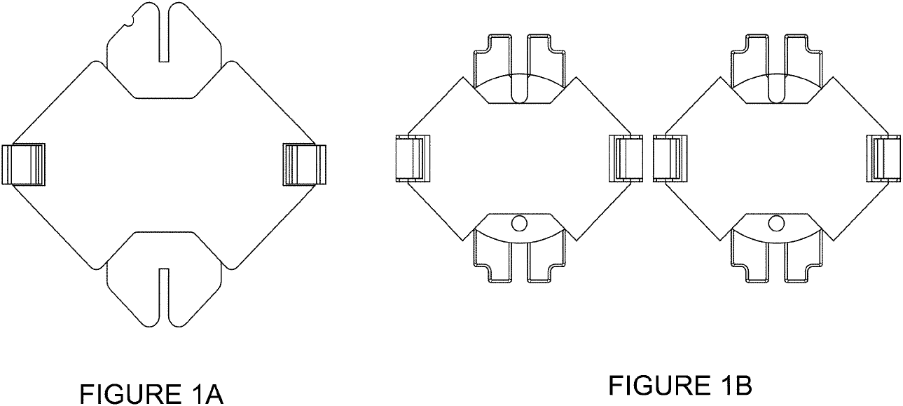

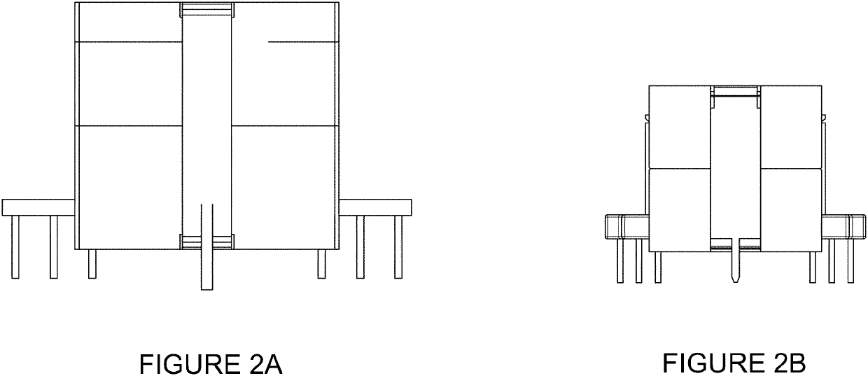

FIGS. 1 and 2 illustrate a comparison of the size of inductors for a converter using a single inductor and an interleaved converter system using two inductors in parallel.

FIGS. 1A and 2A show the top view and cross sectional view of a single inductor while FIGS. 1B and 2B show the top view and cross sectional view of two inductors in parallel implemented in an interleaved system. The theoretical dimensions and the volumetric efficiency losses related to construction problems of the inductor itself are apparent.

Interleaved systems are able to reduce the power dissipated as well as the size of the components due to the reduction of losses. Interleaved systems are often used for high power applications, such as above 1 kW applications. This is, in part, due to the fact that each component entails a quantity of “wasted” area for packages, pinouts, soldering space on the board, minimum distance from other components, etc. that is small in comparison with the size of the active part of the core in high power converters.

By contrast, for lower power devices, such as for hundreds of Watts or tens of Watts, the wasted space is greater in size than the saved space, hence interleaved solutions are often not chosen.

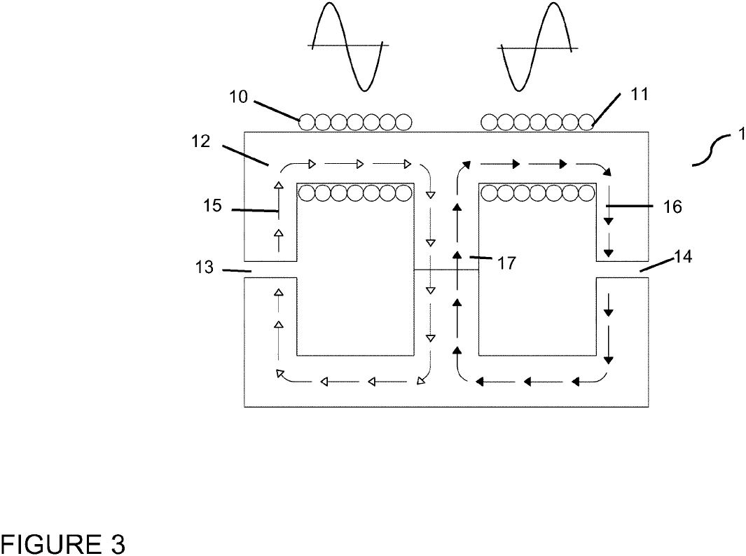

With reference to FIG. 3, an electromagnetic device 1 is provided with multiple independent inductors (10, 11) wound near or on a single core 12 of magnetic material. The structure of the multiple inductors comprises a magnetic core 12 with lateral legs and a central leg. Unlike a standard transformer where there is a gap on the central leg, there is no gap on the central leg but a gap on each lateral leg (13, 14), in order to avoid the saturation of the magnetic core 12.

As shown, the magnetic flux path of the first inductor 15 is independent of the magnetic flux path of the other inductor 16. Therefore, the two inductors (10, 11) are substantially independent or magnetically isolated from one another. The magnetic energy of the flux path of the first inductor 15 is substantially concentrated within the first lateral leg air gap 13 and the magnetic energy of the flux path of the second inductor 16 is substantially concentrated within the second opposite lateral leg air gap 14. Additionally, in this configuration, the central leg 17 of the core effectively has zero or near zero magnetic field.

The two independent inductors are obtained by winding the inductors on a portion of the core without a gap, provided that these windings are not on the central leg, and choosing the direction of winding to make sure that the magnetic fields are erased or almost erased in the central leg 17.

The electromagnetic device can be configured such that the multiple coupling k between the inductors (10, 11) is close to 0.

The electromagnetic device can be used to improve the performance of converters. For multiphase converters, the coupling k may be configured to be for example between 0 and 0.4.

The multiple inductors are highly manufacturable with standard material and standard manufacturing process and with the inductors being wound on standard bobbins with opposite directions.

Further advantages include, but are not limited to: reduced physical size as compared to standard applications for similar cost, magnetic permeability of the core needed is reduced hence cheaper magnetic can be used, multiple inductors with multiple phases can be implemented on a single magnetic core, the inductors can each be driven in a random way.

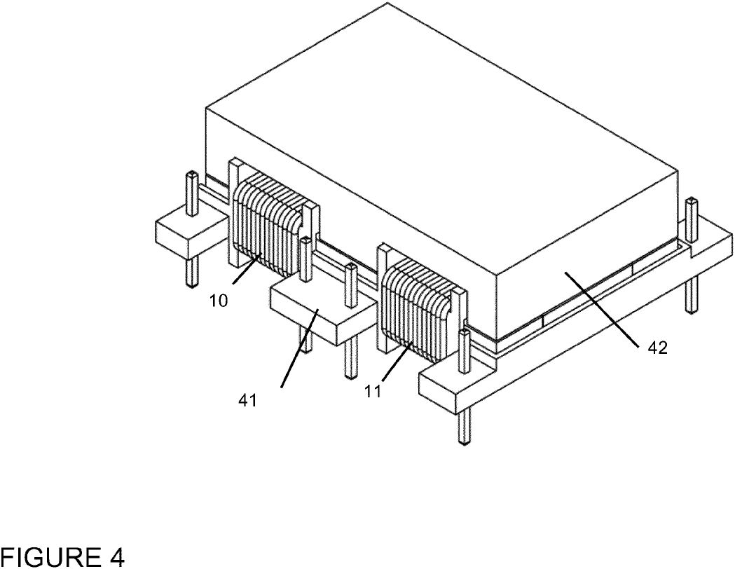

With reference to FIG. 4, a sectional view of an assembled electromagnetic device is shown including a plastic component or coil former (41, 42), including two dedicated channels for winding the wires of the inductors (10,11). The coil former includes 8 pins, a top part 42 to fix the wires and a bottom part 41 to solder the electromagnetic device to a PCB.

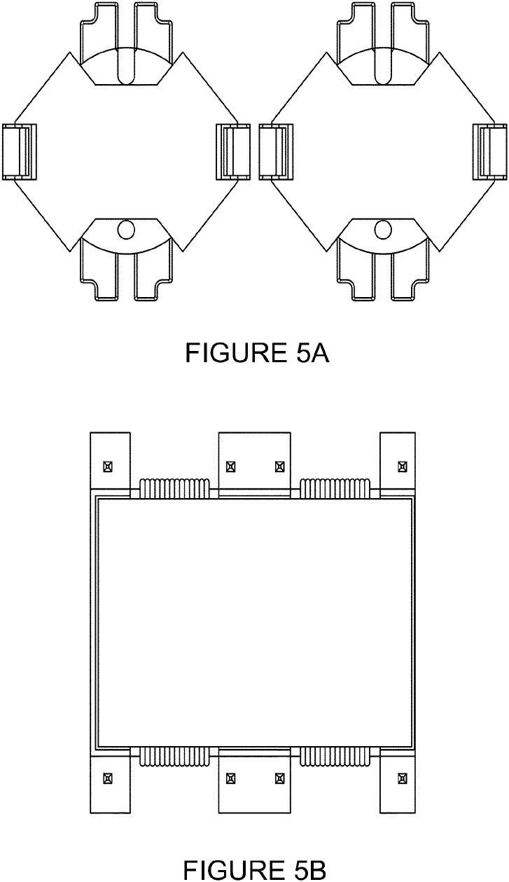

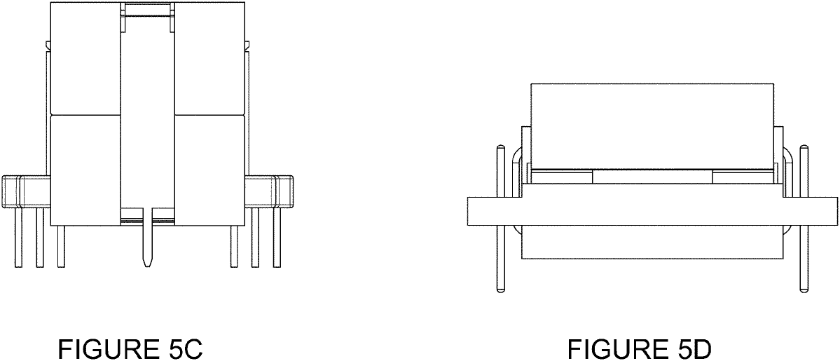

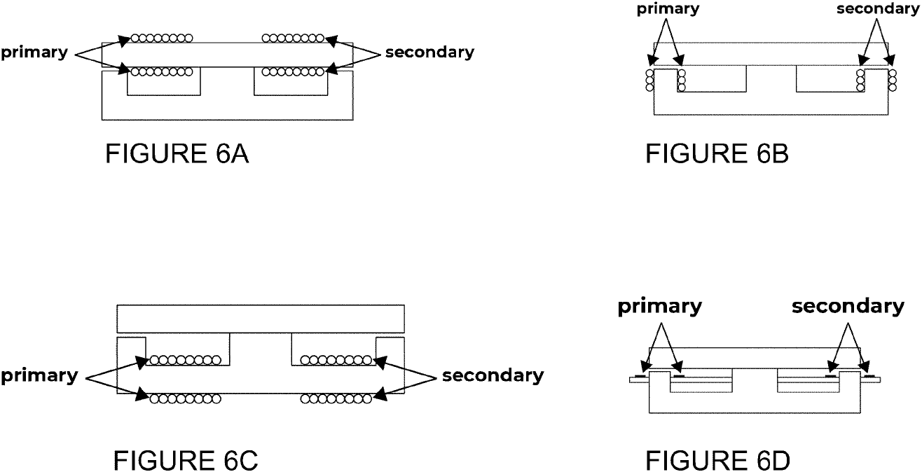

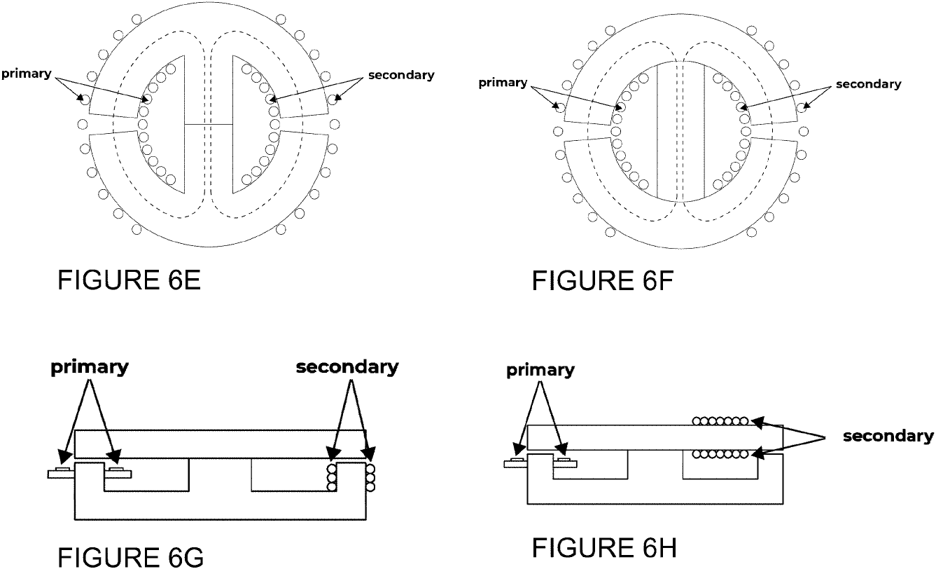

FIGS. 5 and 6 illustrate a comparison between a standard interleaved configuration as shown in FIGS. 1 and 2 and a custom design as shown in FIG. 4. A substantial reduction of the physical size is exhibited.

FIGS. 5A and 5C show the top view and cross sectional view of two inductors in parallel implemented in an interleaved system. FIGS. 5B and 5D show the top view and cross sectional view of the assembled electromagnetic device with two independent inductors.

A number of other configurations are possible, such as, but not limited to: asymmetrical winding configuration or flat structure.

Alternatively, the windings of the inductors may be either wire windings or planar windings printed on a substrate or a combination thereof, as shown in FIG. 6.

The windings may independently be wire-wound or realized on a printed circuit board (planar inductor), the core may have a common or custom shape, including (but not limited to) toroidal, EFD, E, POT, P, PQ, RQ, etc. FIG. 6 shows examples of transformers based on E and I cores (wire-wound as shown in FIG. 6A, FIG. 6B and FIG. 6C, PCB planar in FIG. 6D, hybrid planar and wire-wound as shown in FIG. 6G and FIG. 6H) and toroidal cores (FIG. 6E and FIG. 6F) with k close to 0.

Further modifications are also provided in Section II below.

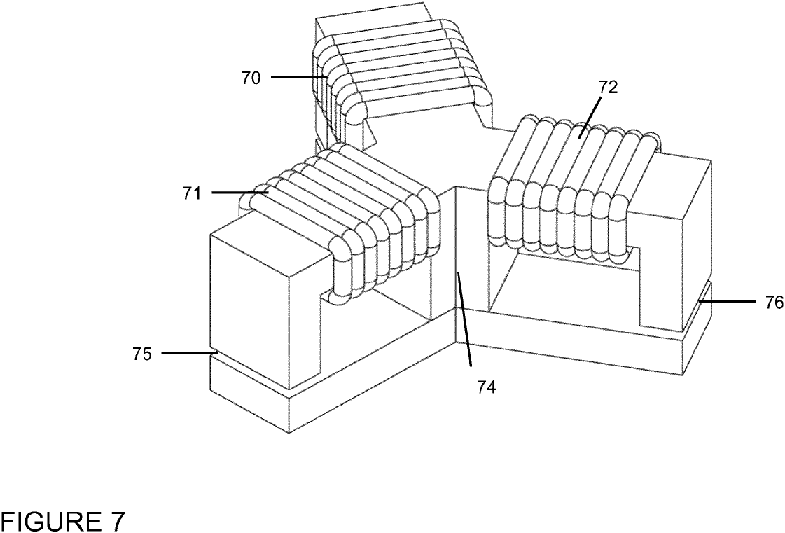

The proposed multiple inductors architecture may include two or more inductors on a single core. With reference to FIG. 7, an example electromagnetic device comprising three independent inductors (70, 71, 72) is shown, in which the three lateral legs each include a gap, and the central part 74 does not comprise a gap. Two lateral gaps are visible (75, 76).

The multiple independent inductors architecture or electromagnetic device may be used in any circuits in which multiple phases in parallel are used in order to reduce the average current.

The electromagnetic device may be used in a number of interleaved systems and/or push-pull systems, such as: a boost, buck, buck-boost and resonant (interleaved LLC, class-E or class-F type) converters.

More specifically, the proposed electromagnetic device may be implemented as the output inductor of a buck or the input inductor of a boost or class-E converter, or the inductor of every interleaved or push-pull converter.

The electromagnetic device may also be used in a PFC (power factor correction) converter based on one of the converters listed above, in which therefore the main feedback variable is not the output voltage or current imposed on the load, but the input current, which in the PFC converters are in phase with the input voltage.

The multiple independent inductors system may also be used in an interleaved DC / AC converter (for example inverters for renewable energy applications, wireless chargers, or applications for hybrid and electric cars).

In a 300 W interleaved PFC boost design, two 0.7 \$ inductors can be replaced with a single 0.5-1 \$ or less weakly coupled inductor. A further minor BOM cost improvement (around 0.1-0.3 \$) may be obtained by replacing the FETs with less capable FETs, for example with higher channel resistance or output capacitance.

### 1.2 Weakly Coupled Transformer

An electromagnetic device in which multiple inductors arranged on the same core are configured to have a weak mutual coupling k is now described.

The electromagnetic device or weakly coupled transformer may be implemented as part of a PFC interleaved boost application, or may be implemented as part of a LLC application. The weakly coupled transformer may also be applied to any architecture using an interleaved or multiphase converter.

As a comparison, in a generic DC/DC interleaved or push-pull converter the main single inductor is split in two inductors with a lower current rating and lower dimension. The disadvantages of this solution are the increased total cost, due to component doubling, and the underuse of the total magnetic area at low power. The same issue may happen in LLC applications, where the need for a resonating inductor and a transformer leads to two bulky magnetic components. A single-core solution could improve both the magnetic cost and the core area use.

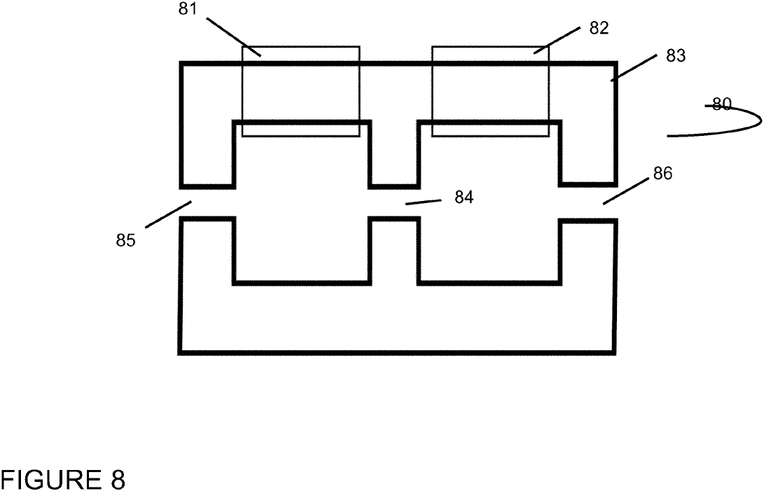

With reference to FIG. 8, a weakly coupled transformer 80 is provided including a primary winding 81 and a second winding 82 arranged on or near a single core with a central leg and two lateral legs. A weak coupling between the two inductors is created by introducing an air gap 84 on the central leg of the magnetic core 83 as well as air gaps (85,86) on the lateral legs. As shown, the central air gap located on the central leg is smaller than the lateral air gaps.

The main idea is to enhance the dynamic performances of the FETs of the interleaved converter by creating a weak coupling between the inductors. By intentionally designing a bad transformer or weakly coupled inductors, the first inductor can be driven as an independent inductor, while some coupling still goes to the second inductor, with the isolation needed still being formed. This weak coupling is able to reduce the hard switching voltage in the FETs, eventually forcing Zero Voltage Switching in the FETs, without changing the working principle of interleaved converters based on independent inductors. Thus, multiple advantages are achieved: in comparison with a standard interleaved solution, a single magnetic component is used rather than two, and higher efficiency is achieved thanks to lower switching voltages. In contrast to an ideal transformer presenting a perfect coupling between different windings (k=1), a weakly coupled transformer may refer to a transformer not optimized to have a coupling factor k close to 1. More generally, a transformer with k < 0.95 may therefore be considered weakly coupled.

Similarly as above, the windings of the inductors may be either wire windings or planar windings printed on a substrate or a combination thereof.

A use case example is now described, in which the weakly coupled transformer is applied to an interleaved boost converter.

Having a weak coupling between the two inductors increases the slope of the current during the discharge phase of the converter (i.e. for a boost converter FET in the OFF condition). The increased slope allows for a higher current during the recovery time of the diode that leads to a better (lower loss) turn on condition of the low side MOSFET, because of the discharge of the parasitic capacitance of the low side FET.

Even if this condition worsens both input peak-to-peak current and reverse recovery losses of the boost diode (which can be minimized using another FET to substitute the diode) globally we can have an improvement of efficiency due to a lower hard switching voltage.

An increase in k factor allows a greater improvement in the hard switching condition, but with higher current in the magnetics. Thus, a compromise between k=0 (minimum losses in the magnetics) and 0 < k < 1 (minimum losses in the FETs) can be selected in order to minimize global losses.

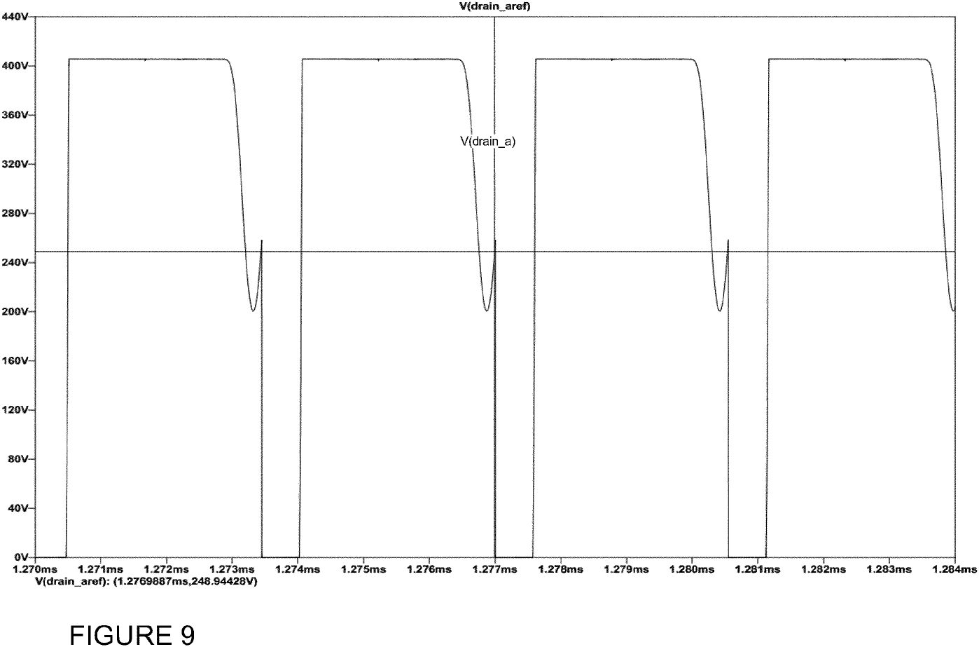

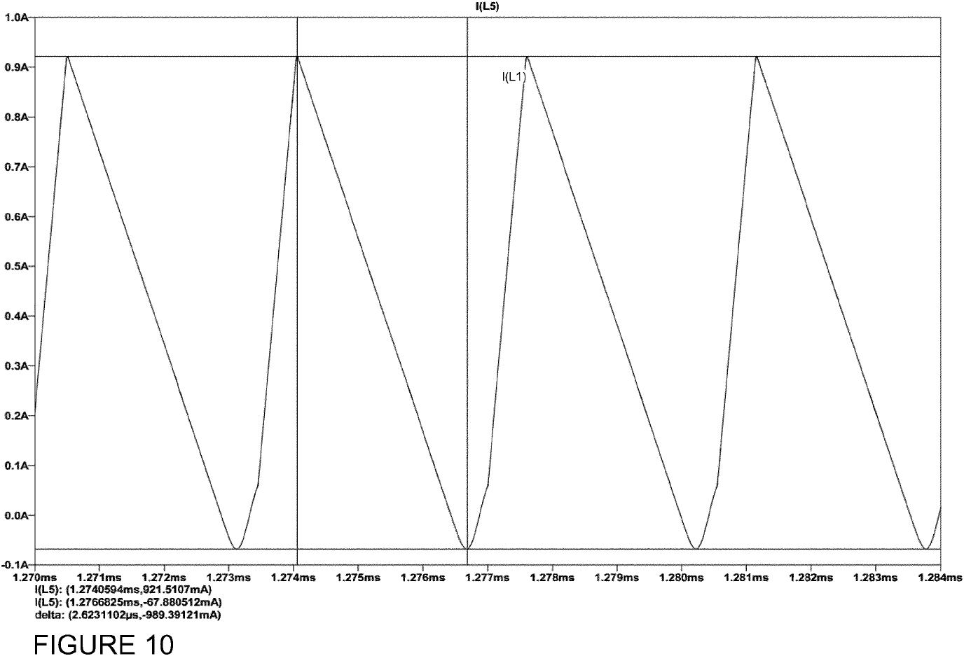

In the case of no coupling (k = 0), the hard switching condition (V_drain) and the inductor current are shown, respectively, in FIG. 9 and FIG. 10.

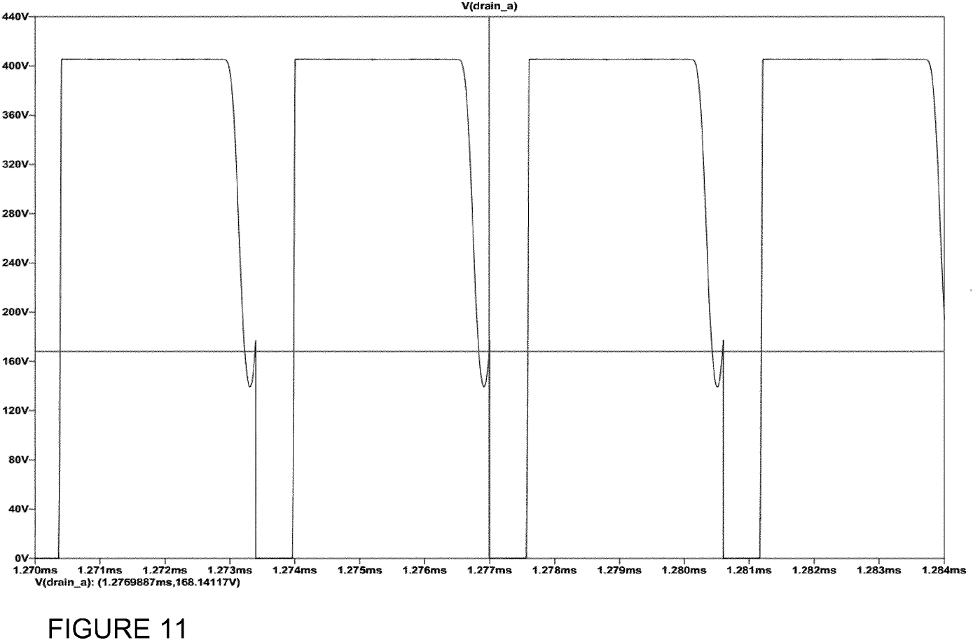

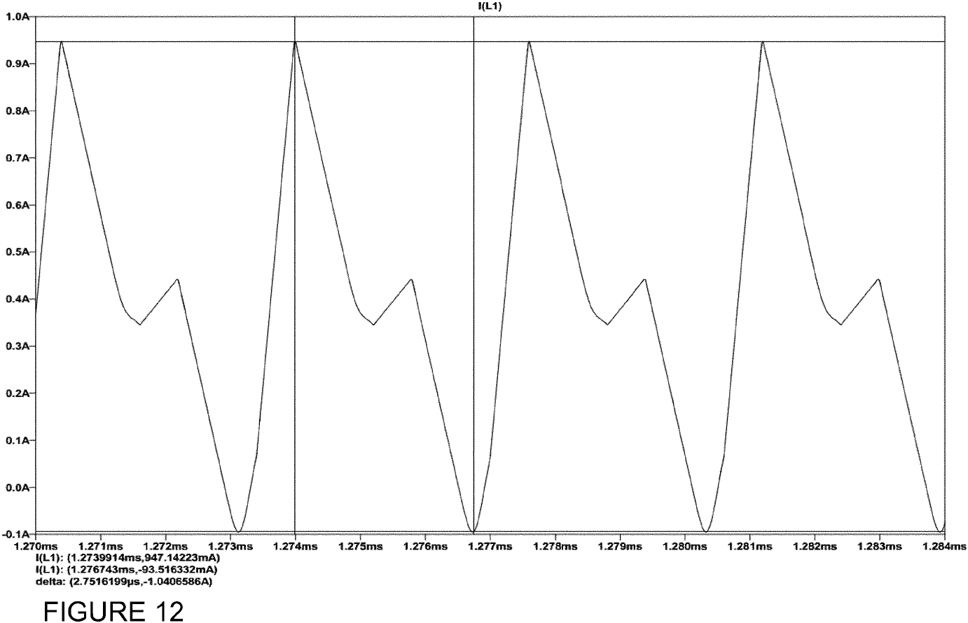

Considering the case of a 300 W interleaved boost converter, a mutual coupling k of less than 0.4, such as about 0.35, has been selected to significantly reduce the hard switching losses without introducing other significant drawbacks. For k about 0.35, the hard switching condition (V_drain) and the inductor current are shown, respectively, in FIG. 11 and FIG. 12.

In general, the mutual coupling k may be selected based on a number of parameters, such as: the specific technology used for the magnetics and the FETs, the input/output voltage and current. Therefore, each circuit may lead to a different optimal mutual coupling k.

A weakly coupled transformer may be implemented with the following circuits, but not limited to:
Multi-phase interleaved DC/DC converters;
Multiple output DC/DC converters;
Current doubler rectifiers.

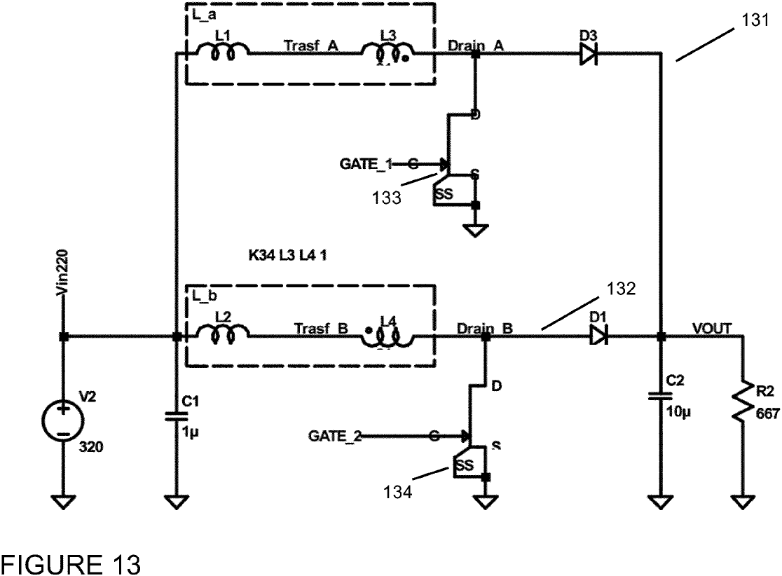

A PFC converter comprising the weakly coupled transformer achieved 99% efficiency; its schematic is shown in FIG. 13 with the weakly coupled transformer (k<1) modelled as two inductors in series in each branch: self inductance (k=0) L1 and L2, and mutual inductance (k=1) L3 and L4.

As a comparison, current PFCs are only able to achieve very high efficiency with very bulky inductors. A standard PFC for the same application would normally yield about 97 to 98 % efficiency but with a much larger physical dimension and about twice the cost.

Small size, high efficiency and low cost may therefore be achieved, either alone or in combination.

Applications include any architecture including a power conversion stage whether for a fixed or altered voltage, such as, but not limited to:
applications delivering between 30 to 300 W of power;
applications delivering up to 1 kW;
applications delivering up to 50 kW;
power supply for TV, high powered laptops, home appliance, electric and hybrid vehicles;
all power supplies including isolation barrier;
switch mode power supply;
power converters;
silicon chips including controller (including timing circuits and microprocessor);
electronic custom built for a specific application;
very high power application, including a fixed output and fixed input, and including a main stage that is tuned to a working point;
USB powered delivery: input changes in US and EU from 90 V to 265 V - energy change (square of voltage) - output changes from 5 V to 20 V - laptops - multi output -other solution - PFC that goes across the barrier.
topology varies if the load is fixed or if there is a wide variation in the load.
fixed case: 2 sequential converters tuned specifically to a working point.

### Coupled Interleaved

With reference to FIG. 13, the circuit topology of an interleaved boost converter including two branches implementing the weakly coupled transformer is provided. The weakly coupled transformer is composed of two weakly coupled inductors, L_a and L_b.

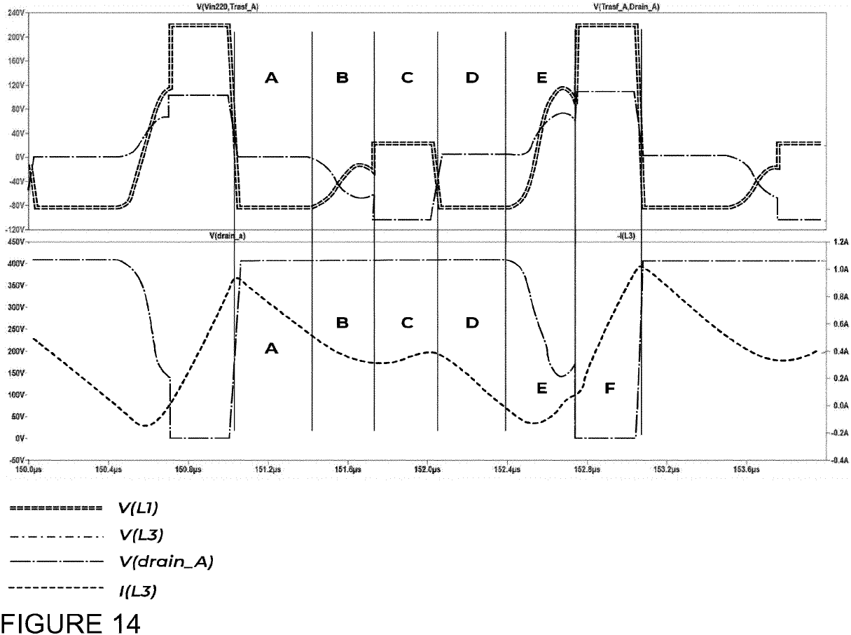

With reference to FIG. 14, the waveforms refer to branch 131 (see FIG. 13) of the interleaved boost converter. The two interleaved branches are indicated as 131 and 132.
For symmetry reasons, in the branch 132, the waveforms are the same, with a phase shift equal to 180°.
Multi-phase converters with n branches have similar behaviour, thus the following explanation may be extended for multi-phase converters with n branches weakly coupled together.
For the sake of simplicity, the weak coupling (k<1) is modelled as two inductors in series in each branch: self inductance (k=0) L1 and L2, and mutual inductance (k=1) L3 and L4. The physical inductors are just 2 windings with a weak mutual inductance ( 0 < k <1) that has substantially the same behaviour as the model composed of the auto inductors L1 and L2 and the ideal transformer including L3 and L4.

We know describe the phases in a cycle in each branch as shown in FIG. 14:

### Phase A

Both MOSFETs are off. The previously loaded L1 inductor discharges with slope:

$$Δ \text{I} / Δ \text{t} = \left(\text{Vin-Vout}\right) / \text{L1} ;$$

This is the curve I(L3) - note that the current in L1 and L3 is the same.

### Phase B

When the inductor L2 (self-inductance of branch 132) is discharged, the drain node of branch 132 starts to oscillate because of the L-C resonator (where C is the parasitic capacitance of the components - i.e. the MOSFET), and this oscillation is reflected on the drain of branch A through the “transformer” (mutual inductance) composed of L4 and L3. The current on L1 begins to change its slope.

### Phase C

The MOSFET 134 of branch 132 is turned on to charge the inductor L_b (shown in FIG. 14 as the series of the self-inductance L2 and the mutual inductance L4) .

Part of the input voltage falls across L4 and this voltage is reflected on L3. Since the turns ratio in the “transformer” given by L3 and L4 is about 1:1, the voltage on L3 is the same as L4.

Since the voltage drop Vin-V_drainA must remain equal to Vin-Vout, and having added on L3 a drop equal to the drop on L4, we will have a drop on L1 equal to Vin-Vout + V_L4. Depending on K, this voltage can take on different values (since k affects how much voltage falls across L4). Indeed, it can be shown that V_L4 = k * Vin; therefore the slope of the current will be equal to:

$$\text{ΔΙ} / \text{Δ} \text{t} = \left(\text{Vin - Vout + k * Vin}\right) / \text{L1}$$

Thus, the higher the coupling k between the two branches, the faster the slope, which is reasonable because the self-inductance of each branch is smaller.

### Phase D

The branch 132 MOSFET 133 is turned off.

The voltage across L4 falls down to 0 and the inductor L1 discharges with the same slope of phase A. It is interesting to underline that L4 does not exist physically as it’s part of L_b, thus this theoretical voltage equal to 0 is given by the superimposition of the effects.

### Phase E

The inductor L1 is completely discharged, the drain A begins to oscillate. Once again - the inductor L1 is not existing in reality, L1 and L3 are the model of the same inductor L_a weakly coupled with L_b.

Due to the coupling between L3 and L4 part of the voltage “falls” across the transformer (being transmitted to the other branch) and the drain node on branch 131 drops to a voltage level lower than the uncoupled condition, this provides a changeover to a lower voltage level.

### Phase F

The MOSFET 133 of branch 131 is turned on when the voltage of the drain reaches the valley.

The input voltage charges L1 and L3 previously discharged. The slope of the current, therefore, is equal to:

$$\text{ΔΙ} / \text{Δ} \text{t} = \text{Vin} / \left(\text{L1 + L3}\right)$$

Everything is repeated periodically, also on the other branch.

As compared to the decoupled version, the introduction of a coupling between the two normally decoupled inductors means that the drain node tends to discharge more, thus a lower voltage at the turn on of the MOSFET 133, during the oscillation in phase E.

As a result, there is less loss due to turn on hard switching on the MOSFETs in comparison with standard uncoupled multi-phase converters.

The choice of this solution is justified in interleaved applications where the currents on the MOSFETs are relatively low, and therefore the static losses are lower than those for hard switching. In other terms, the choice of k is a compromise between lower turn-on hard switching transitions (which require higher k) and lower currents (which require lower k). As an example, starting from a 300 W standard interleaved (k=0) design with 500 mW total FETs′ losses, weakly coupled inductors (k=0.2) can reduce FETs′ losses to 350 mW, and more coupled ones (k=0.4) can bring down losses up to 250 mW.

In a PFC stage with European input voltage and a “low” power target for the standard of an interleaved topology, this solution has shown greater efficiency than the decoupled solution (99% with low cost MOSFETs), because the current is in any case lower because of the multi-branch converter and because of the high voltage input.

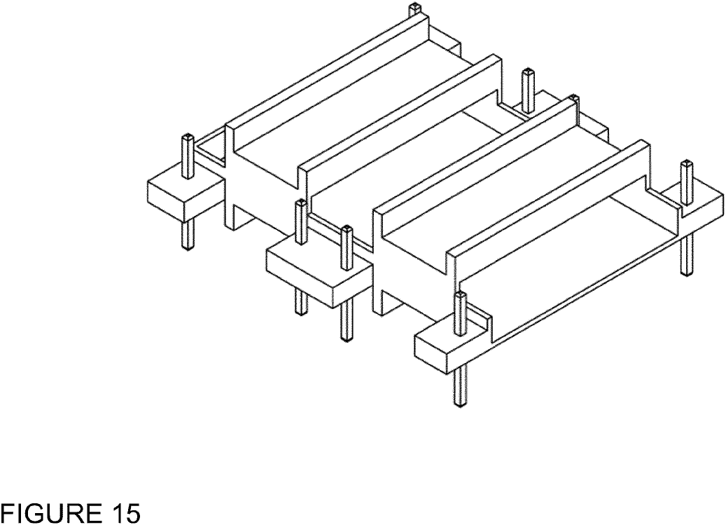

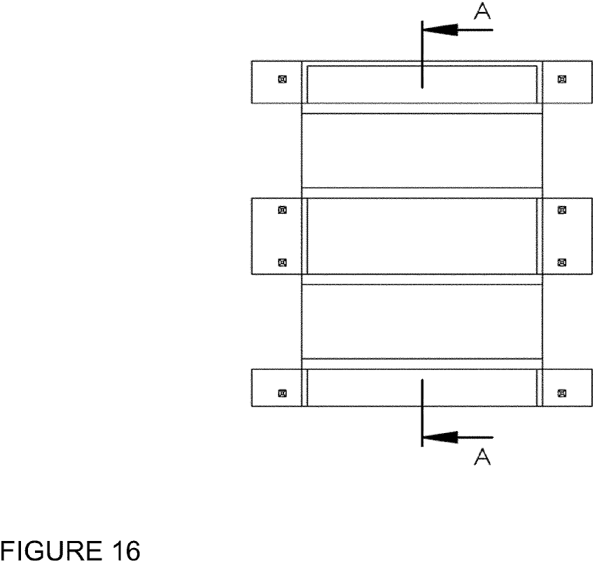

With reference to FIGS. 15-17, different views of a 3D CAD model of the plastic component are provided. The plastic component or coil former is configured to wind the wires of a weakly coupled transformer, with a mutual coupling k around 0.35, that can be used in a PFC outputting about 300 W of power. The overall dimension of the plastic component is about 22 mm x 34 mm.

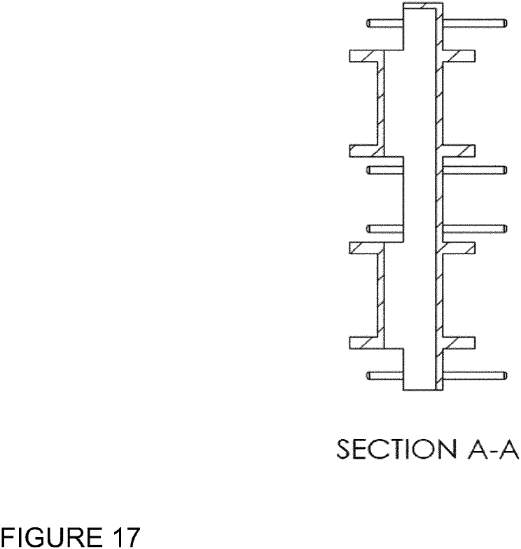

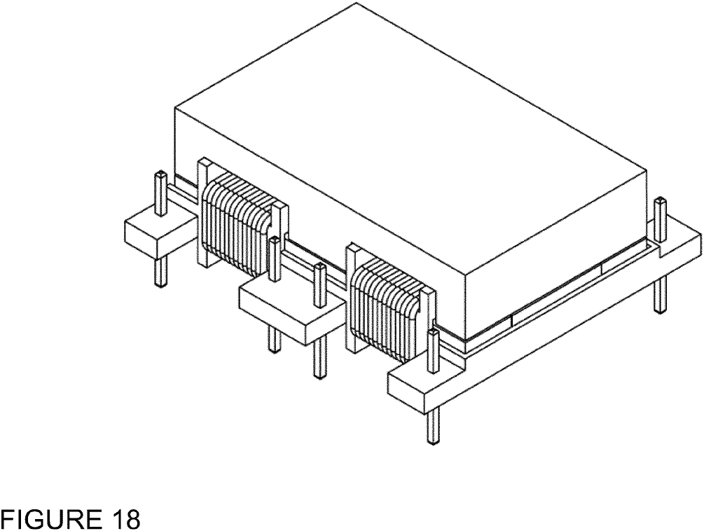

FIG. 17 shows a cross sectional view of the coil former used to wind the inductor. The coil former includes 8 pins, where each one has got a top part used to fix the wire and a bottom part used to solder the inductor to the PCB. The wires are wound around the coil former, in the two dedicated channels. The coil former is designed for a transformer based on an E-shaped core referred as the E-core and an I-shaped core referred as the I-core: the wires are wound around the coil former, then the I-core is inserted inside it, then this block is stuck to the E-core. FIG. 18 shows a finished assembled weakly coupled transformer.

### Section II. Improved LLC Converter

LLC resonant converters belong to the vast family of resonant converters. These are usually switching converters that include a tank circuit which actively influences the input-to-output power transfer. LLC resonant converters are based on a so-called “resonant inverter” i.e. a circuit that converts a DC voltage into a low harmonic content AC voltage (ideally, a sinusoidal voltage) and provides AC power to a load. To do so, a switching network is typically used to produce a square-wave voltage that is applied to a resonant tank tuned to its fundamental component. The tank will respond primarily to this component and in a negligible way to the higher order harmonics, so that its voltage and/or current will be approximately sinusoidal. The resonant inverter is then followed by a rectifier and an output filtering stage; the whole system acts as a DC-DC resonant converter. In most cases the rectifier block is coupled to the resonant inverter through a transformer to guarantee the isolation required by safety regulations. The rectifier block can be configured as either a bridge rectifier (preferable when the output requires high voltage / low current), or a center tap full-wave rectifier (preferable when the output requires low voltage / high current). The low-pass filter, depending on the configuration of the tank circuit, is usually made by capacitors only or by an L-C smoothing filter.

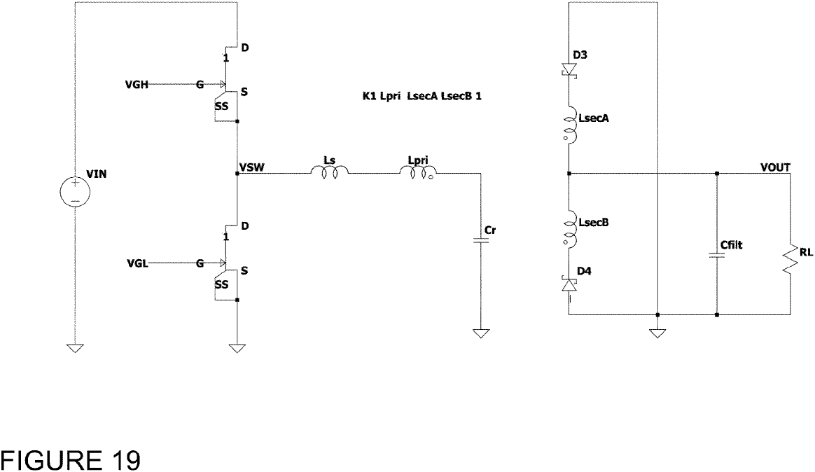

Different types of resonant inverters can be built, depending on the type of switching network and the characteristics of the resonant tank, such as the number of reactive elements and their configuration. When two inductors and one capacitor in series are used, with the load connected in parallel to one L, we obtain the so-called LLC inverter, which is associated with the LLC DC-DC converter. One of the possible existing configurations, with the half-bridge implementation of the switching network and a full-wave rectifier is shown in FIG. 19.

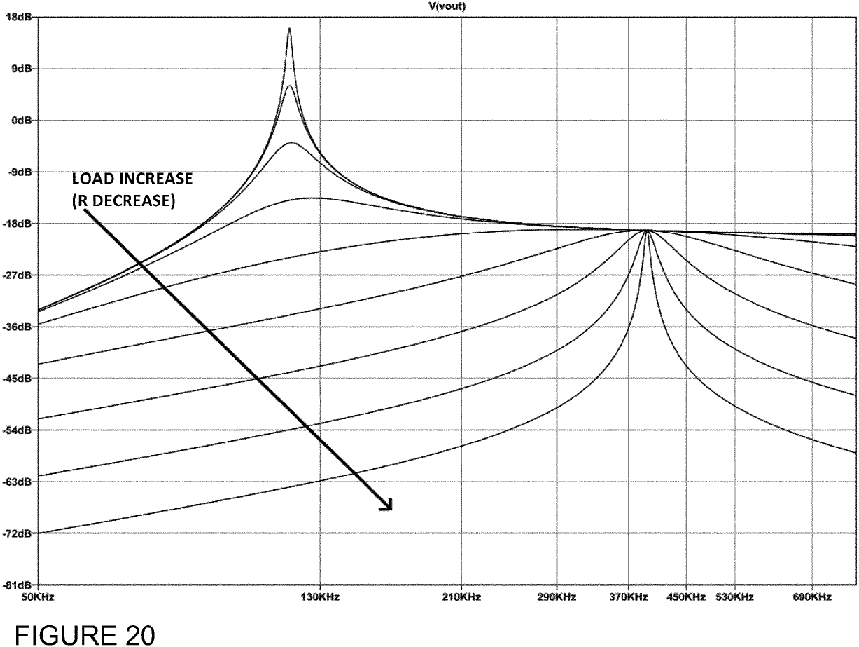

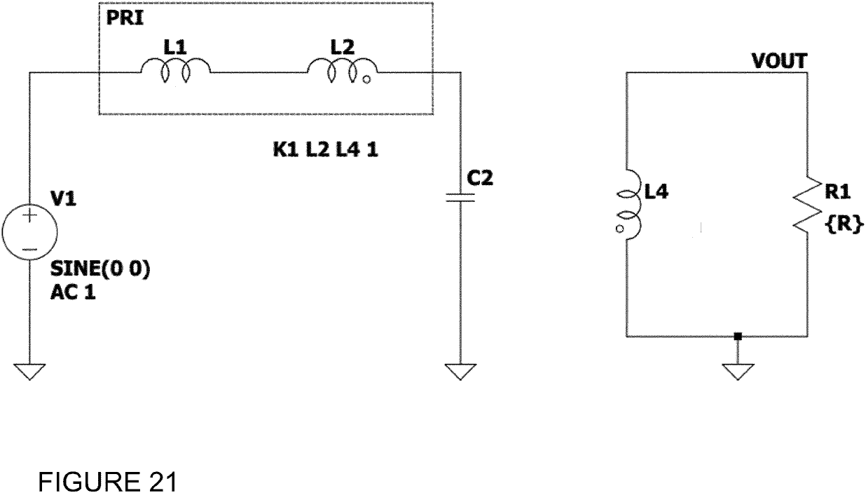

FIG. 20 shows a plot of the output voltage in dB illustrating Vout of FIG. 21 illustrating the change in resonant frequency of the circuit shown in FIG. 21, related to the condition of the secondary windings conducting, is defined as:

$$\text{fr1 =} \text{1} / \left(2 \text{π} √ \left(\text{Ls} ⋅ \text{Cr}\right)\right)$$

Since the resonant tank is made of three reactive elements (Cr, Ls and Lpri), there is also another resonant frequency associated to this circuit, relative to the condition of the secondary windings open, where the tank circuit turns from LLC to LC because Ls and Lpri can be unified in a single inductor:

$$\text{fr2 =} \text{1} / \left(2 \text{π} √ \left(\left(\text{Ls+Lpri}\right) ⋅ \text{Cr}\right)\right)$$

Of course, it is fr1>fr2. The actual resonant frequency of the LLC fr0 circuit then becomes a function of the load moving within the range of fr1≤ fr0≤ fr2 as the load changes. At no load, fr0=fr2. As the load increases, fr0 moves towards fr1. This implies that for f>fr1 the input impedance of the loaded resonant tank is inductive and for frequencies f<fr2 the input impedance is capacitive. For fr2<f< fr1 the impedance can be either inductive or capacitive depending on the load resistance RL. A critical value Rcrit exists so that if RL<Rcrit then the impedance will be capacitive, if RL>Rcrit instead it will be inductive. For any resonant tank configuration it can be shown that:

$$\text{Rcrit =} √ \left(\text{Z0} ⋅ \text{Z0inf}\right)$$

Where Z0 and Z0inf are the resonant tank output impedances with the source input shorted and open-circuited respectively.

The variation of the LLC output voltage with both the frequency and the load is shown in FIG. 20, obtained with an AC analysis of the circuit of FIG. 21.

The LLC resonant converter is normally configured to operate in the region where the input impedance of the resonant tank has inductive nature. This means that the impedance increases with frequency, which implies that power transfer can be controlled by changing the operating frequency of the converter. In this way a reduced power demand from the load requires a frequency rise, while an increased power demand requires a frequency reduction.

With reference to FIG. 19, let’s consider the case in which an half-bridge driver switches two power switches (realized with but not limited to power GaN HEMTs or power MOSFETs) on and off in phase opposition symmetrically, that is, for exactly the same time. This is commonly referred to as “50% duty cycle” operation even if the conduction time of either power switches is actually slightly shorter than 50% of the switching period since a small deadtime is inserted between the turn-off of either switch and the turn-on of the complementary one. The role of this deadtime is essential for the operation of the converter and will be clarified in the next sections as well. For the moment it will be neglected, and the voltage applied to the resonant tank will be considered as a square-wave with 50% duty cycle that swings all the way from 0 to Vin.

In the previous paragraph, the impedance of the tank circuit was mentioned. Impedance is a concept related to linear circuits under sinusoidal excitation, whereas in the circuit of FIG. 19 the excitation voltage is a square wave. However, as a consequence of the selective nature of resonant tanks, most power processing properties of resonant converters are associated with the fundamental component of the Fourier expansion of voltages and currents in the circuit.

The input square wave excitation has a DC component equal to Vin/2. In the LLC resonant tank, the resonant capacitor Cr in series to the voltage source, under steady state conditions presents an average voltage which is also equal to Vin/2 since the average voltage across inductors must be zero. As a result, Cr plays the double role of resonant capacitor and DC blocking capacitor.

We now describe a number of improvements from the LLC resonant converter described above. The following techniques may also be applied more generally to other power converters including an LC resonance.

### LLC Resonant Converter With a Split Resonant Capacitor Configuration

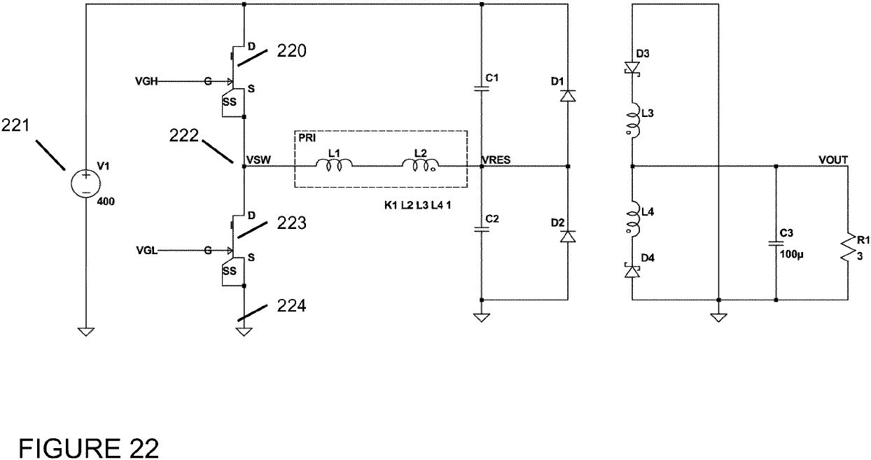

An LLC resonant converter is shown in FIG. 22, comprising a first switch 220 (or high or upper MOSFET) connected between a DC voltage input 221 and an half bridge or switching node vsw 222, and a second switch 223 (or low MOSFET) connected between the half bridge node 222 and a ground input 224.

To improve performances, Cr is split using two capacitors C1 and C2 as shown in FIG. 22. The two capacitors (C1 and C2) are dynamically in parallel, so that the total resonant tank’s capacitance is still Cr. While the sum of C1+C2 is equal to Cr, C1 and C2 may or may not have the same value. This new configuration is useful especially at higher power levels to reduce the current stress in each capacitor. Additionally, it makes the input current to the converter looks like that of a full-bridge converter, with a resulting significant reduction in both the input differential mode noise and the stress of the input capacitor (ideally in parallel with the input voltage). Thus, the proposed design is able to increase the performance of the converter in terms of efficiency, because a given capacitor able to sustain a maximum peak voltage is stressed with lower current. In other terms, for a given target efficiency, lower cost capacitors can be used. In any case, the differential noise of the proposed converter is lower than conventional LLC.

### LLC Resonant Converter Including Two Clamping Diodes

In FIG. 22, in addition to the new split capacitor configuration, diodes D1 and D2 have been added. These diodes clamp the voltage of C1 and C2 between 0 and Vin, acting also as a hardware LLC tank peak current limiters, therefore providing a fast cycle-by-cycle overpower protection. D1 and D2 do not have any kind of impact in regular operation since they step in only when overpower occurs, and efficiency is not affected. Such kind of cheap and simple hardware protection cannot be implemented in the single resonant capacitor case, in which the overpower protection has to be implemented with some kind of voltage and/or current measurement (which may affect efficiency) together with a software algorithm.

### LLC Converter With Improved Electromagnetic Component

The system represented in FIG. 19 appears bulky, with its three magnetic components. To reduce dimensions and cost with no penalty to converter’s characteristics, the resonant inductor and the transformer can be integrated into a single physical magnetic device as shown in FIG. 22, which can be modelled as two inductors weakly coupled together - which is to say as a transformer with coupling factor k lower than 1. From an electric point of view, the leakage inductance of the weakly coupled transformer plays the role previously covered by the external inductor Ls.

This magnetic integration provides several advantages, such as volume and size reduction, cost reduction (just one magnetic component rather than 2, less raw material is needed) and higher efficiency (only one magnetic core is magnetized). To do so, a high leakage magnetic structure is needed, which is contrary to the traditional transformer design best practice that aims at minimizing leakage inductance. The techniques already shown in SECTION I above may also be used.

The LLC converter also provides safety insulation. Various implementations of the weakly coupled transformer including safety insulation are now described as examples. The following weakly coupled transformers may be implemented as part of an LLC power converter, as well as any other topologies which may require a high leakage inductance, such as parallel resonant converter or dual active bridge architectures.

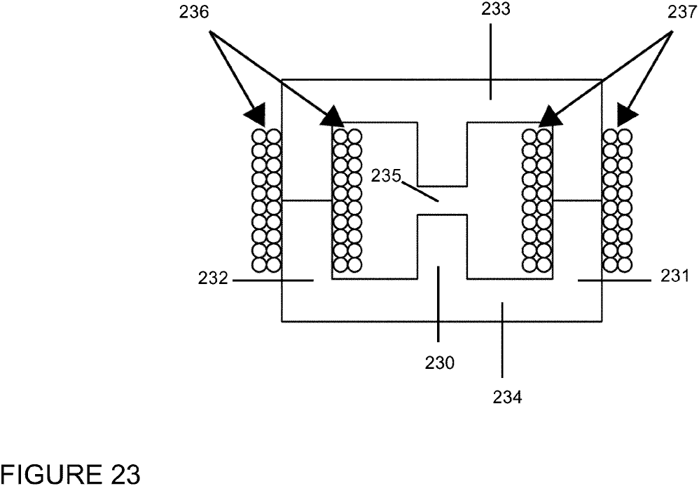

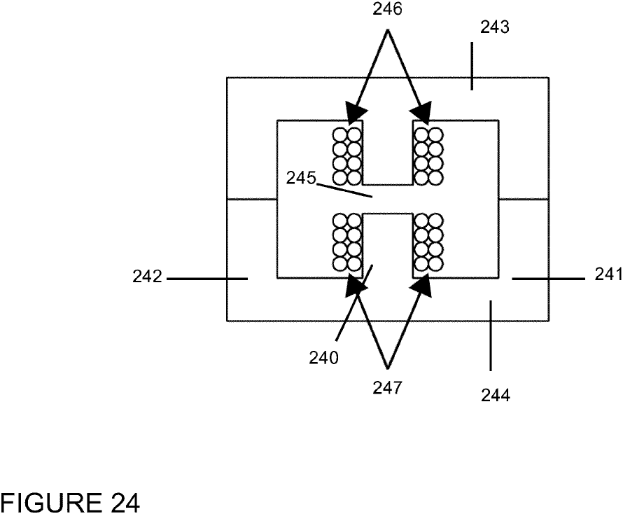

In order to obtain reproducible values, a possibility is to place the windings on separate core legs as shown in FIG. 23 or side by side on the same leg as shown in FIG. 24.

FIG. 23 shows an implementation of a weakly coupled transformer comprising a single core having a central leg 230 and two lateral legs (231, 232) connected to each other using end members (233, 234). The central leg comprises an air gap 235. The transformer further includes a primary winding 236 and a secondary winding 237 each arranged on a lateral leg.

FIG. 24 shows another implementation of a weakly coupled transformer comprising a single core having a central leg 240 and two lateral legs (241, 242) connected to each other using end members (243, 244). The central leg comprises an air gap 245. The transformer further includes a primary winding 246 and a secondary winding 247 each arranged on a section of the central leg 240.

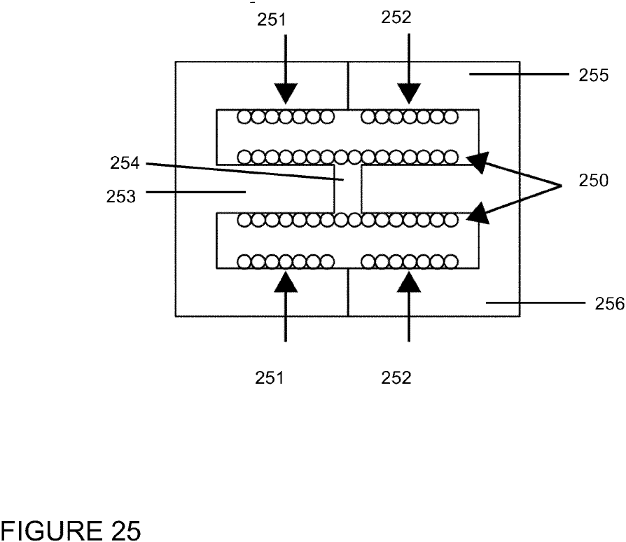

A more compact alternative design is the one shown in FIG. 25 for secondary winding with center tap configuration. Primary 250 and secondary 251, 252 windings are concentric but the two secondary windings (251, 252) are laid side by side. The primary winding is arranged around the central leg 253, in which the central leg comprises an air gap 254. Each secondary winding (251, 252) is arranged on the inside of both lateral legs (251, 252) and are overlapped on a portion of the primary winding 250. This solution provides a very efficient use of the bobbing window (for example primary winding 250 can occupy the whole bobbing height). In addition, in this way only one or few layers of primary and secondary can be used, in order to reduce at the minimum the power losses due to proximity effects. These optimizations allow a very good power density and with the use of a thin shape ferrite core such as but not limited to EFD type, extremely thin transformers may be built with respect to standard solutions.

As an example, the weakly coupled transformer shown in FIG. 25 may be implemented as part of the architecture shown in FIG. 22 having two secondary inductors or windings (L3 and L4).

Hence a weakly-coupled transformer for a 210 W LLC can be thinner than 13 mm thanks to an EFD30 core and a custom thin coil former.

By placing the windings inside the magnetic core as shown for example in FIGS. 24 and 25, an improvement in EMI (electromagnetic interference) robustness may also be achieved.

To further increase the reproducibility of the leakage inductance values, it is necessary to reduce tolerances over the spacing between primary and secondary windings. Alternative configurations are now described in which the primary winding is first fixed and a controlled arrangement of the secondary winding is then achieved based on the position or arrangement of the fixed primary winding. Controlling the arrangement of the secondary winding includes controlling the spacing between one or more turns of the secondary winding and/or controlling the spacing between the primary and secondary windings. The primary and secondary windings are then configured to have a specific weak mutual coupling k that is determined by selecting the different spacings.

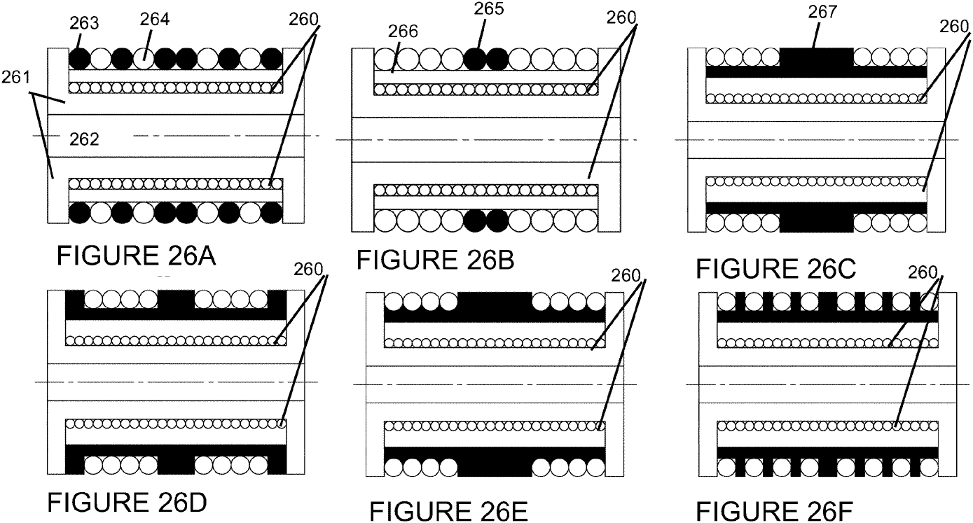

Examples are shown in FIGS. 26A to 26F, each comprising a primary winding 260 arranged around a coil former 261. The central leg of a magnetic core is then inserted inside the opening 262 of the coil former.

A dummy wire winding 263 made of conductive or non-conductive material may be placed between the two secondary windings, as shown in FIG. 26A.

A dummy wire winding 265 may also be placed between each turn of the primary and/ or secondary winding, as shown in FIG. 26B in order to obtain a desired value of the distance between the wires placed in different layers and/or within the same layer.

An insulated tape 266 may be used, as shown in FIG. 26B, in order to provide a controlled separation distance between primary and secondary windings.

Alternatively, insulated wires composed of one or more copper strands covered by a calibrated insulating layer exceeding the minimum thickness required by safety regulations may also be used, such that the distances between conductive wires are set by the thickness of the insulating layer.

A coil former shell placed all around the primary layer (or layers) may be used in order to define the position for the secondary layers. The coil former may present physical barriers that define the bobbing window for these windings such as but not limited to one or more plastic teeth which separates the windings with or without more precise seats for the wires. Some possible solutions are shown in FIG. 26. The proposed configurations are able to provide a very accurate separation distance between multiple secondary windings and their separation distance from the primary windings.

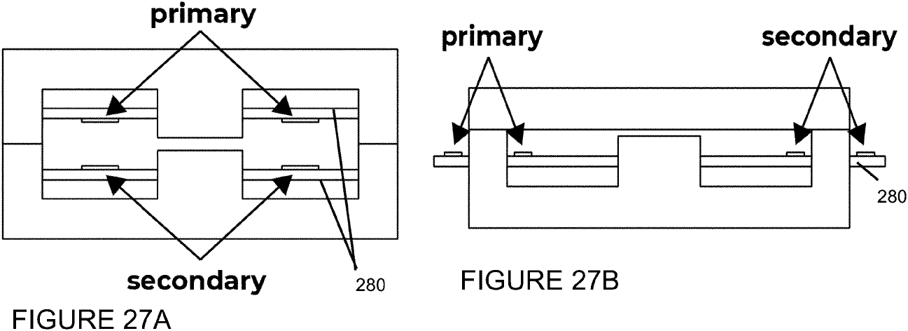

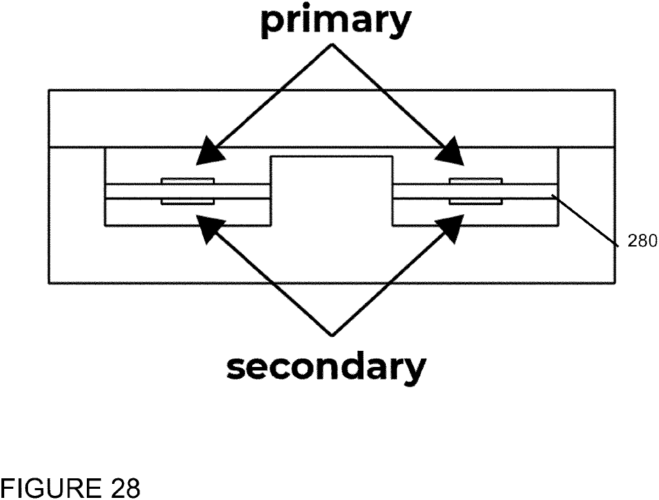

A coil former may also be used to provide an accurate spacing between one or more PCBs and/or one or more wire windings. The coupling factor among the windings in the planar transformer may be controlled by designing different windings on different PCBs 280 and separating them by a calibrated gap thanks to a spacer made of plastic or other materials (FIG. 27A). The windings may be also realized on the same PCB, calibrating the coupling factor thanks to both the PCB 280 stack-up and the 2D shape of the windings (FIG. 27B and FIG. 28).

Alternatively, a hybrid planar and wire-wound transformer may also be used. A great advantage for this solution is the chance to realize all the primary (or secondary) windings in the inner layers of a PCB, and to wire-wind the remaining windings without the need for using insulated wire or tape, because the insulation may be ensured by the insulating outer layers of the PCB (including but not limiting to fiberglass). For simplicity, examples of transformers realized with single or double-layer PCBs are provided, but the same concepts may be extended to multi-layer PCBs. Also, copper trace on the outer layers may also be covered by an additional insulating PCB layer.

### Methods of Increasing the Timer Resolution of the LLC Converter

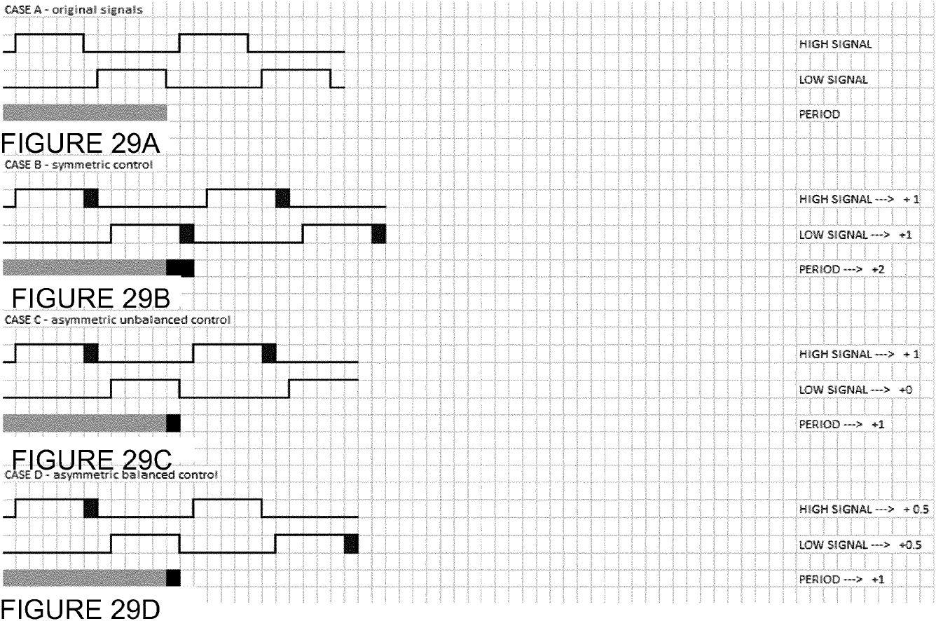

Standard LLC control techniques are based on symmetric and complementary signals driving the high and the low FETs, this means that the two signals have a duty cycle equal to 50% minus the value of the dead time, and they are generated with a 180° phase shift, as shown in FIG. 29A, in which the control signal of the high MOSFET, the control signal of the low MOSFET and the resulting period are provided.

The control of the power is then obtained by changing the frequency (or the period) of the signals, and not their duty cycle (in contrast with other traditional DC/DCs like the buck and the boost).

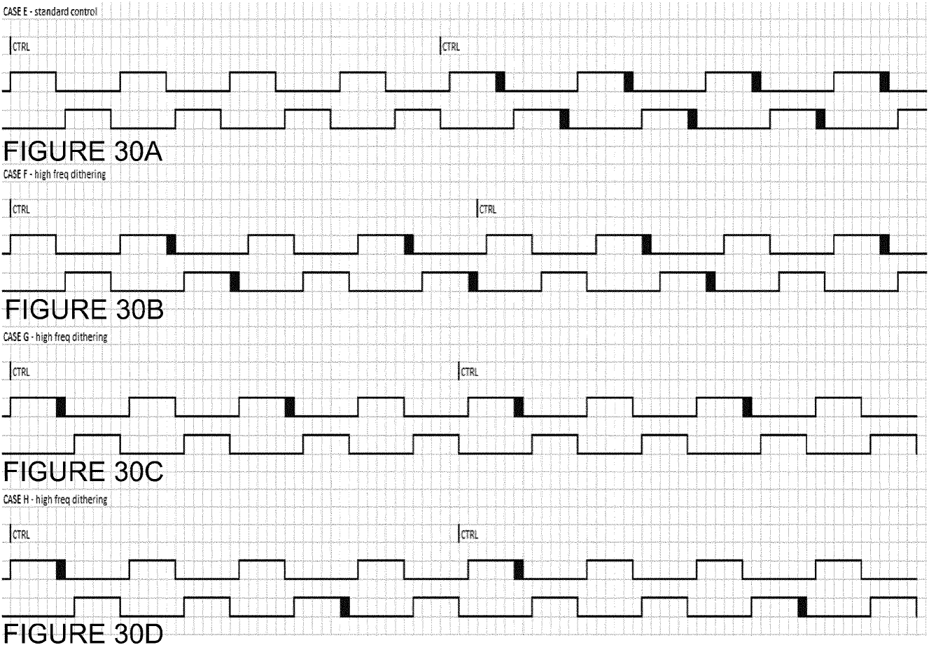

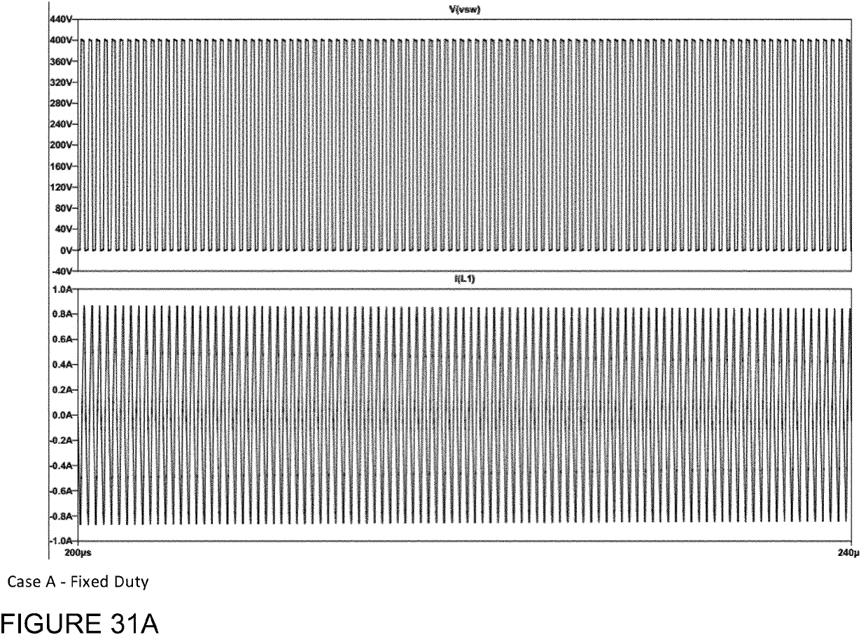

When controlling an LLC with a timer clocked with a fixed frequency (for example using a timer embedded in a microcontroller), the resolution on the driving signals is limited by the clock resolution (T), so a 32 MHz frequency clocked timer will generate signals with a resolution T = 1/f = 1/32 MHz = 32.25 ns. In case of two symmetric signals, the resolution of the overall waveform is equal to 2T (FIGS. 29A, 29B, 30A and 30B).

From one side, lowering the clock frequency of the timer allows the use of cheaper controllers and helps to reduce the controller’s power consumption, but from the other side the frequency regulation will be coarser, which leads to poor regulation of the output voltage.

Two techniques for increasing the timer resolution are now listed.

### 1) Asymmetric Signals

As shown in FIG. 29B, standard control often increases or decreases by a multiple of T both the “ON” and “OFF” lengths of the two signals, with an overall 2T resolution.

The resolution may also be halved by generating (for example by firmware) two asymmetrical signals, as shown in FIG. 29C, increasing or decreasing just the “ON” length of one signal and the “OFF” length of the complementary one.

In a single period, the two signals will have slightly different duty cycles, but an equal average duty cycle may be obtained swapping the two asymmetric signals after each cycle or after a finite number of cycles (FIG. 29D).

### 2) Control Dithering

In case the timer resolution is too coarse, it may not be possible to generate the ideal signals capable of providing a zero-error regulation. Hence, a standard control algorithm will therefore bounce between the couple of signals providing too much power (error < 0) or too little power (error > 0). This may happen each time the control routine is executed, thus generating a significant output ripple, as shown in FIG. 30A.

The proposed control dithering technique may be applied to any LLC power converter and more generally to any other power converter topology.

A brute force way to reduce this ripple consists in increasing the control frequency in order to bounce between the two working points more often.

A “non-brute force” accurate regulation is obtained generating a pattern of signals in order to let the device work around the ideal working point at a frequency higher than the control routine frequency (FIGS. 30B to 30D).

The control system may be composed of a digital timer used for generating the FETs′ control signals and a digital controller responsible for configuring the digital timer’s period, duty cycles, etc. In this case, the controller generates a pattern of signals composed by a sequence of timer configurations, so that after each switching cycle the timer can fetch the configuration for the next cycle. Alternatively, starting from a given configuration, the timer may internally generate the signal pattern by slightly modifying the configuration cycle-by-cycle, i.e. adding or subtracting a given value from the signals’ period and/or duty cycle.

### Soft Start Techniques

As mentioned above, LLCs are commonly controlled generating a couple of signals for each of the two primary side FETs with an (almost) fixed 50% duty cycle, and variable frequency/period shared by both signals, and a 180° phase shift between the two signals. The signals’ frequency is lower (higher) at higher (lower) output loads.

A traditional soft start management would be to start from a high frequency and to lower it until the soft start is over and the steady state is reached.

Due to hardware, firmware or other kinds of limitations, it may be impossible to generate the output signals at the desired high frequency (i.e. if the converter works at high frequency at full load, then the soft start higher frequency may be too high for a low cost controller), so a different approach is proposed.

Starting from a fully turned-off hardware (no electric and/or magnetic energy stored in any capacitor and/or inductor and/or transformer), the high side FET is responsible for energizing the whole system starting from the input voltage.

### Unbalanced Signal (Soft Start and Light Load Conditions)

During a soft start, the two FETs are driven with unbalanced signals, with a (very) high duty cycle for the low side FET and a (very) low duty cycle for the high side FET.

The high side FET’s duty cycle then is increased progressively while the low side duty is decreased, until the two duty cycles match. This may be done at a fixed frequency, or at a fixed low side FET’s conduction time (increasing the high side FET conduction time), or with other techniques.

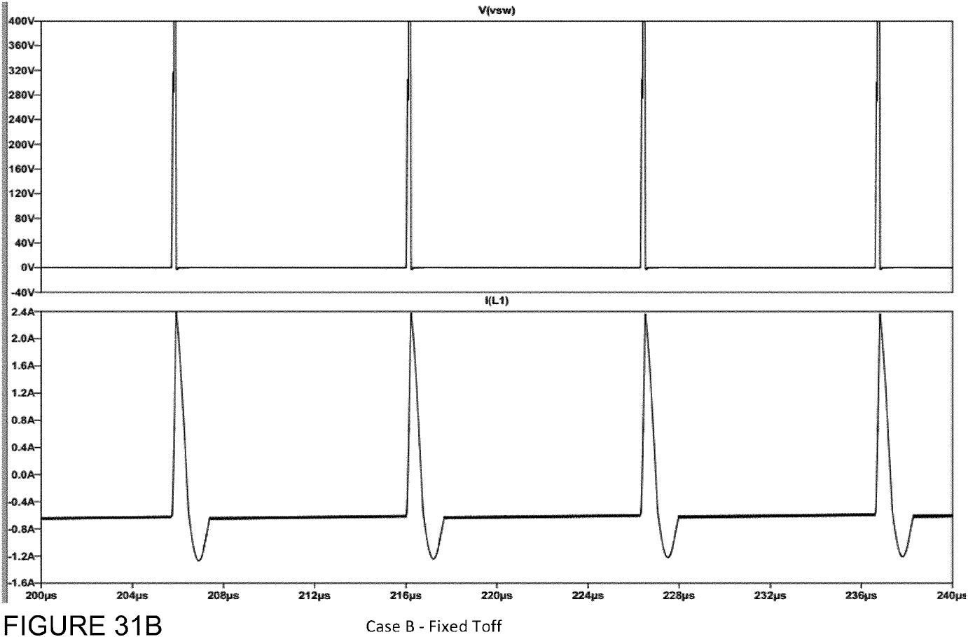

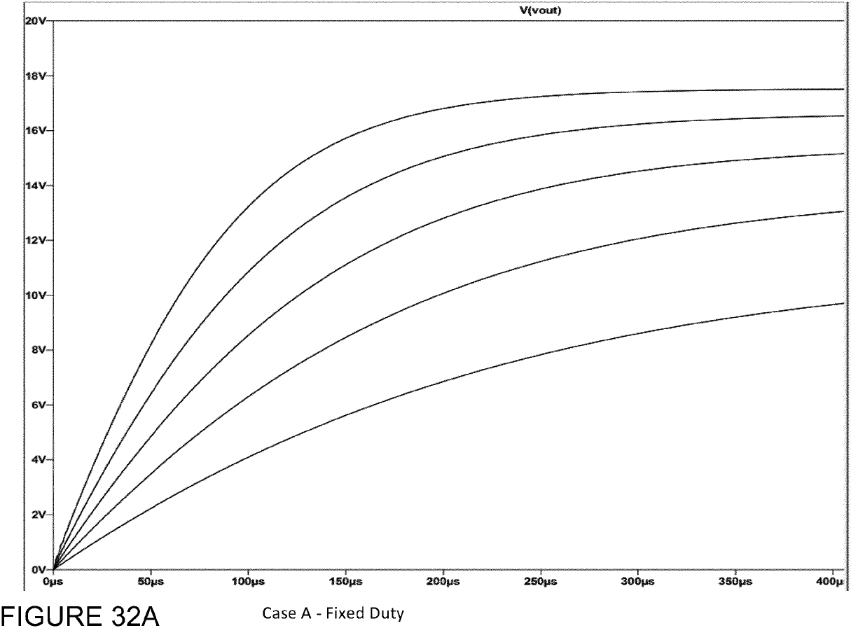

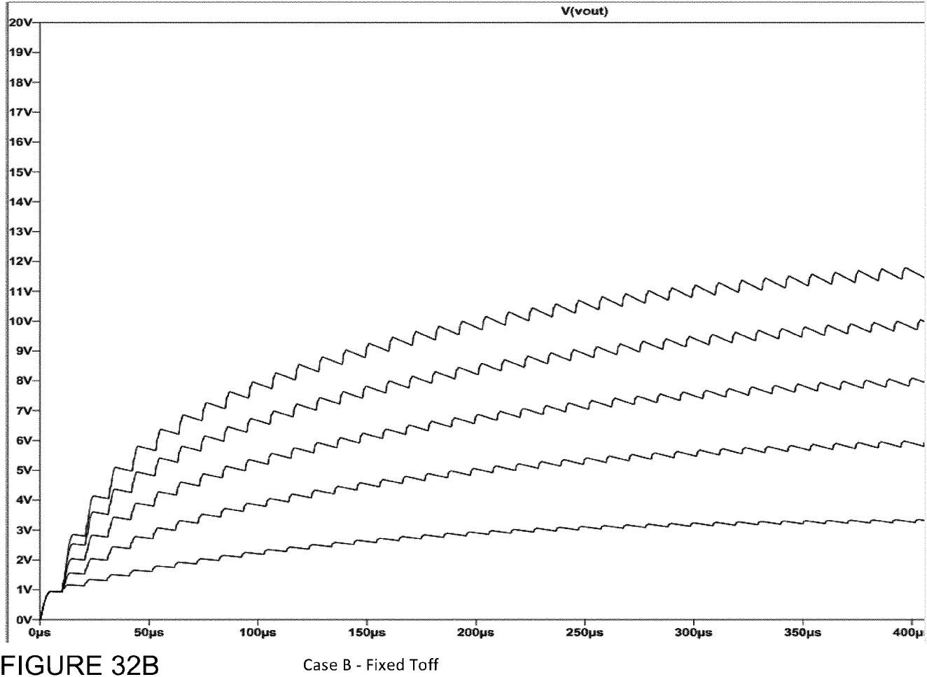

Referring to the LLC in FIG. 22, FIG. 31 and FIG. 32 show a standard start-up routine (FIG. 31A and FIG. 32A), where starting at high frequency with 50% duty cycle, and where ton and toff are slowly increased simultaneously in order to increase the power, and an unbalance low-duty cycle approach (FIG. 31B and FIG. 32B), where the toff starts with a higher value and the ton is slowly increased.

Each curve represents a fixed ton and toff configuration. In case A, each curve is obtained increasing both ton and toff by 100 ns (from 100 ns to 500 ns). In case B, the toff is fixed, and the ton is increased by 100 ns steps (from 100 ns to 500 ns).

This example helps to understand that the approach used in case B can be used to achieve a smoother and more accurate soft start when using a low-resolution timer (in this example the resolution is 100 ns).

Due to the need for driving the FETs with high frequency driving signals, LLC’s efficiency is not good enough in light load. By contrast, the proposed unbalanced duty cycle FET driving technique is also used to maximize the converter efficiency in light load, because of the reduced working frequency of the converter and reduced amount of reactive currents in light load conditions.

Then, when the high and low duty cycles match, the conventional frequency control technique can be used.

### Secondary Side Driving Techniques

In many applications, FETs controlled by ideal diode controllers are often good options for the rectifying stage of the power converter. In the case of a primary-side controlled converter, the advantage of this solution is that a synchronous rectification is achieved without the need of generating signals on the primary side and sending to the secondary side through the isolation barrier.

Due to the need for ensuring immunity toward noise and avoiding spurious switching pulses, ideal diodes are often configured with minimum and maximum conduction times. This may be incompatible with very high frequency and/or low conduction time algorithms used during the soft start up.

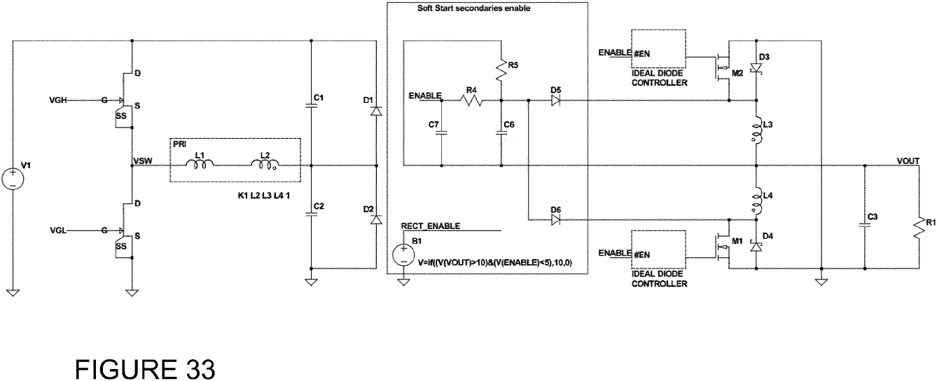

A safe soft start routine is therefore proposed, able to keep the controller(s) of the rectifiers in idle until the soft start up is over. The circuit in FIG. 33 is an example of a circuit capable of generating an active-low enable signal for the ideal diode controllers. In order to command M1 and M2 as ideal diodes, two conditions are needed: the output voltage must be higher than a threshold (in order to correctly supply the controllers), and the enable signal must be lower than a threshold (it is an active-low signal). At the circuit start up, C7 is initially not charged, so the enable signal is initially equal to the output voltage: the ideal diodes do not turn on the FETs because the output voltage is too low to supply the controllers. During this phase, D3 and D4 are able to rectify the secondary winding voltage, so the output voltage slowly increases toward the output nominal voltage. D3 and D4 may be the body diodes embedded on M2 and M1, or may be external diodes used during the soft start only. During D4 (D3) on time, D6 (D5) is turned on, providing a path to slowly charge C7 and to pull the enable voltage towards 0 V. After a certain amount of time (typically longer than the soft start duration), the output voltage is significantly high, and the active-low enable voltage is significantly low: the ideal diodes will start to operate normally.

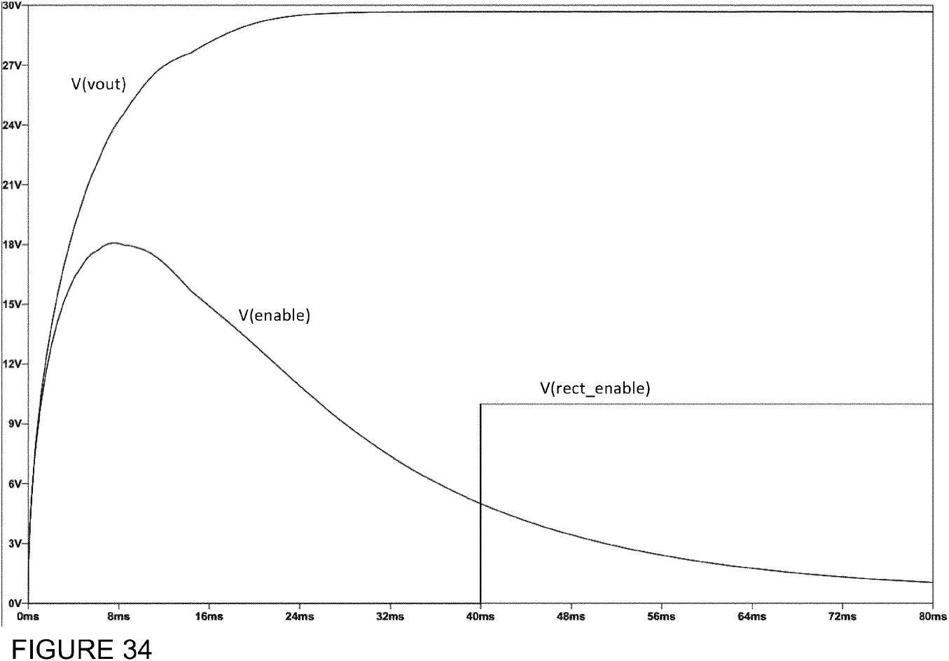

In FIG. 34 the analog active-low “enable” signal is shown. For a better understanding, the “rect_ enable” logic active-high signal is shown as well, this signal is high when “enable” is lower than a certain threshold and the output voltage is greater than another threshold value.

### Section III. Wireless Charging

### 3.1 Background on Wireless Charging

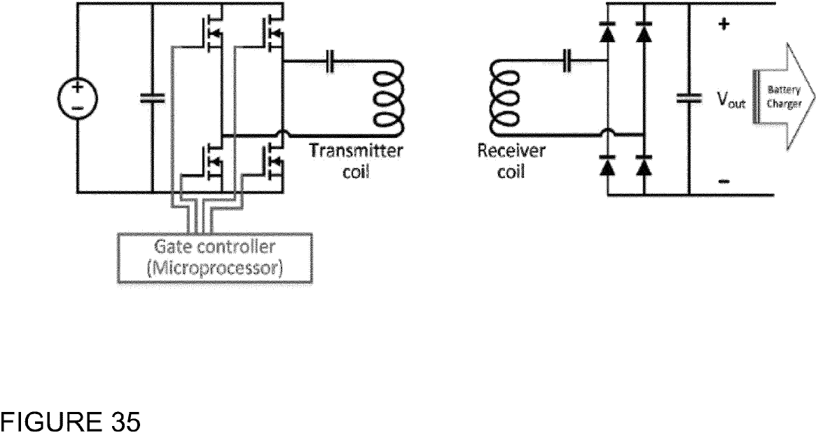

With reference to FIG. 35, a conventional wireless charging circuit is provided, in which power is transferred from a wireless charger to a receiver device by inductive coupling. The wireless charger often includes:
AC/DC isolated adapter (Input 110 V-240 V, Output DC up to 48 V);
DC/DC power conversion (optional);
DC/AC power amplifier for coil driving.

Fundamental degrees of freedom of wireless power systems are:
the switching frequency (fsw) of the DC/AC power amplifier;
the input voltage DC of the DC/AC power amplifier
the coupling factor (k) between the transmitting coil and the receiving coil.

The power delivered to the receiver device may be controlled by:
Fixed frequency: the DC/AC stage of the transmitter switches at a fixed frequency that is higher than the natural frequency of a LC tank. The control is done changing the input voltage of the DC/AC stage, using a DC/DC converter. This is often the method preferred in the automotive field (in order to reduce issues with EMI and to simplify the certification of the device) and when one of the Apple proprietary fast charging algorithms is needed (one of the Apple Fast Charge algorithms is based on around 127 kHz switching frequency).
Variable frequency: in this case there is no need for a DC/DC converter as any DC constant input voltage can be used. The control is done by regulating the switching frequency of the DC/AC stage. In particular the switching frequency is increased in order to reduce the power transmitted to the load (the distance between the natural resonance of the LC tank and the switching frequency is increased), and the switching frequency is reduced in order to increase the output power (in that case the switching frequency is closer to the natural resonance of the LC tank).

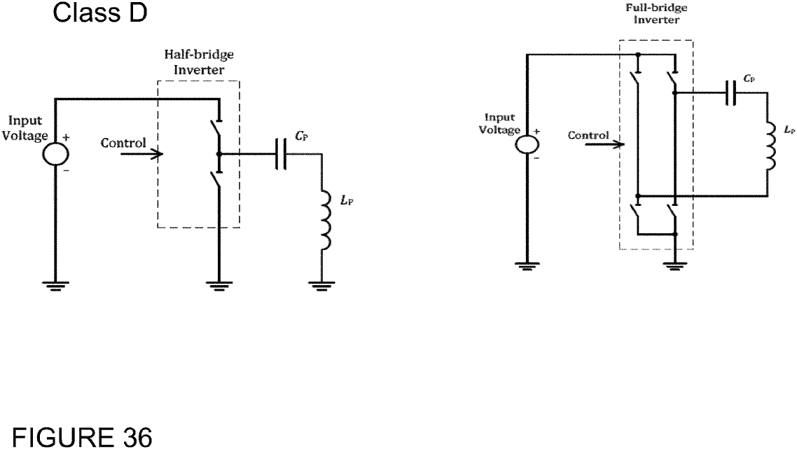

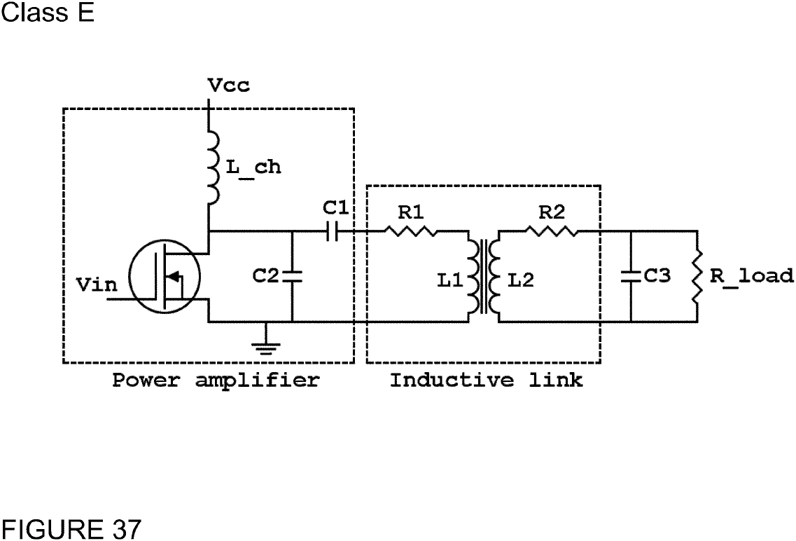

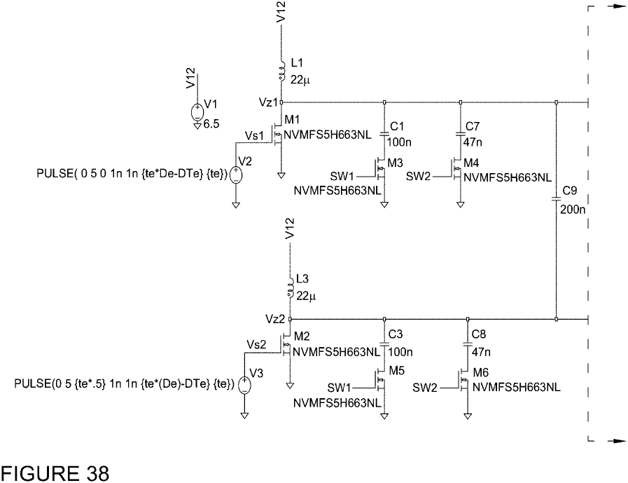

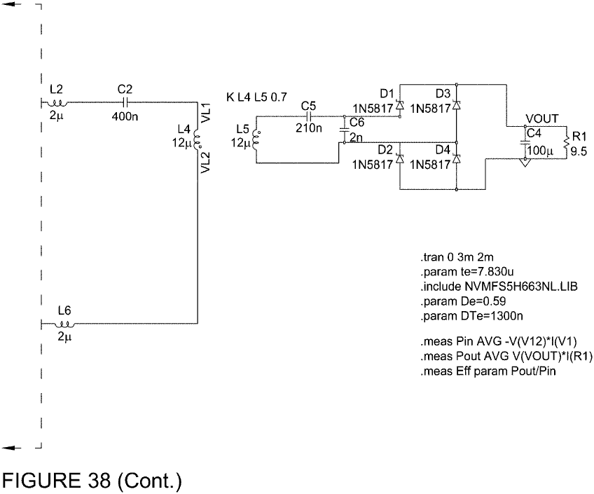

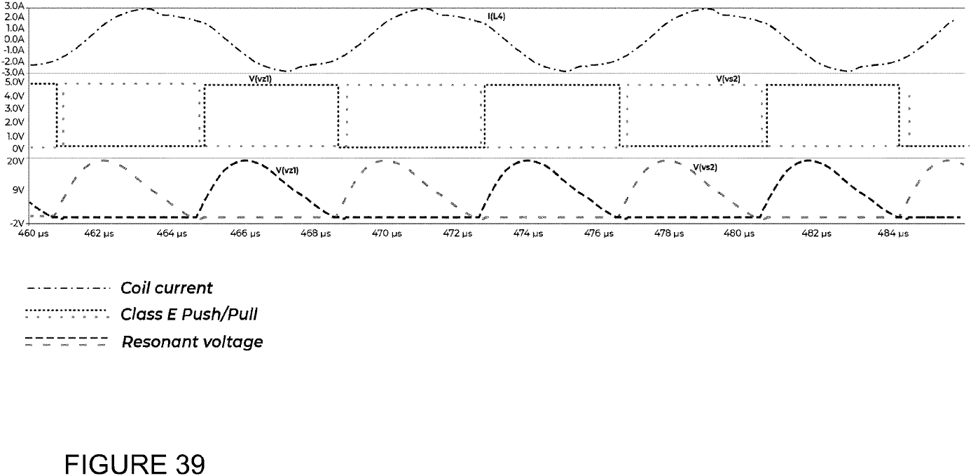

The wireless power transmitter may be configured using a number of topologies, such as:
Class D topology: as shown in FIG. 36, this is mostly adopted to control the resonant tank in half and full bridge configuration. The main drawback includes radiation emissions (EMI) which can partially be solved by using an LC filtering stage. Furthermore, this architecture requires high side driving achievable by bootstrap circuitry or similar. Also, Zero Voltage Switching can be achieved only for a narrow range of loads.
Class E topology: as shown in FIG. 37, this is a well adopted topology for wireless power transfer with usually high frequency applications and low k (k<0.5), such as Airfuel standard at 6.78 MHz. Advantages of the Class E topology includes low radiation emissions, only one low side MOSFET, extremely high efficiency at full load thanks to the ability to achieve ZVS operation. However, it usually requires fixed input, output and driving operation as otherwise ZVS is difficult to achieve. Further there is a high peak voltage on the drain and any load variations make it difficult or impossible to achieve ZVS operations.
Push-pull class E topology (see FIG. 38 & FIG. 39). However the architecture includes a large number of capacitors in parallel with the main capacitor and in turns use a large number of MOSFETs which are used to regulate the reactive load of a large number of capacitors located in parallel with the main capacitor. The resonant tank C2/L4 (FIG. 38) is tuned at the natural frequency of 100 kHz. Frequency transfer is at 127.7 kHz. As noted above for the standard class-E amplifier, one significant drawback of this implementation is that the ZVS is lost easily as a function of the load variations. Thus, the tank capacitance (such as C1-C3-C7-C8 in FIG. 38) must be switched dynamically in order to remain in ZVS conditions.

### 3.2 Integrated Non-Insulated AC/DC and Wireless Charging (Insulated)

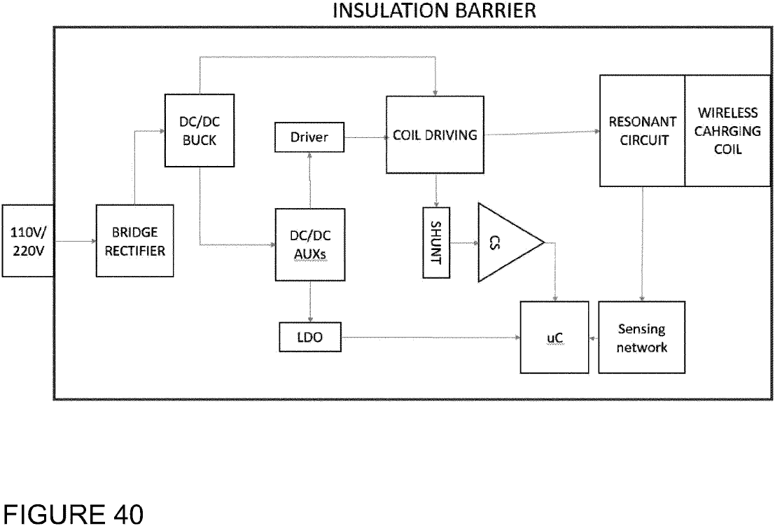

With reference to FIG. 40, a single isolated device that integrates an AC/DC converter and wireless charger is provided.

The wireless charger includes a single insulated nonconductive (i.e. plastic) enclosure that houses the AC/DC converter and wireless transmitter circuit. Therefore, there is no need for an insulated AC/DC adapter, which is usually provided in an additional insulated enclosure. And because the AC/DC conversion functionality is integrated into the transmitter coil circuit housing, the AC/DC converter can therefore be non-insulated.

Further, the need for a high loss DC cable between a conventional AC/DC isolated adapter and the wireless transmitter enclosure is also removed. Instead the proposed design includes an insulated housing that is able to support an interface to directly receive an AC input voltage.

A non-insulated AC/DC converter is also smaller and more efficient than an insulated one, because the safety transformer is not needed. Thus, there’s no need for converting electric energy into magnetic energy and vice-versa.

Removing the AC/DC adapter also removes the need for a low voltage high current (thus, high loss) cable between the adapter and the wireless power transmitter, hence further reducing losses and allowing the use of longer cables.

As an example, the flyback Stage may become a non-insulated buck step-down converter, increasing efficiency thanks to the absence of a transformer that leads to higher losses than a standard inductor. The AC/DC module comprises both the input stage filters and the diode bridge, whereas the “DC/DC BUCK” is a synchronous buck converter which is made to work in forced conduction mode, so as to achieve ZVS and reduce the losses in the active devices.

The second advantage is in the freedom of driving the coil with higher voltage than usual, without the DC limitation of standard AC/DC adapters of 50 V given by low voltage operations due to safety rules.

The topology is particularly suitable for long-range (k<0.5) wireless charging solutions, where high distance requires high input voltage but also for short range transmitter (k>0.5) where the DC/AC Converter can be a standard one such as Class D or Class E.

In comparison with existing architectures, there are less stages in series, less components, more efficiency, more output power.

### 3.3 Integrated AC/DC and Wireless Charger in Single Stage

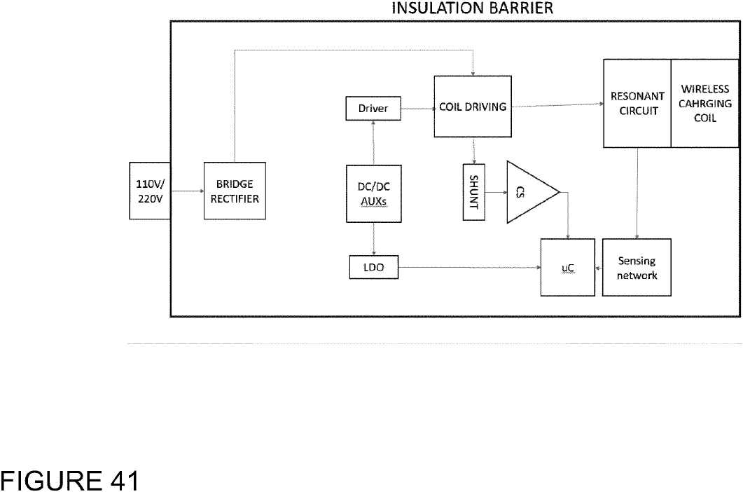

With reference to FIG. 41, the integrated AC/DC converter and wireless power transmitter is provided as a single stage. As illustrated, the bridge rectifier directly connects the coil driving circuit, thus removing the need of a DC/DC buck converter.

The architecture is particularly suitable for long-range (k<0.5) wireless charging solutions where high distance requires high input voltage but also for short range transmitter (k>0.5). For example, the Coil Driving Circuit can be a standard one such as Class D or Class E, or other converters able to be supplied directly with the AC voltage and to excite the transmission coil properly.

The Coil driving circuit adjust the coil voltage and the power transfer with 2 methods:
Changing the frequency of the driving circuit
Changing the duty cycle of the driving circuit

### 3.4 Coil Driving Topology for Short Range (k>0.5)

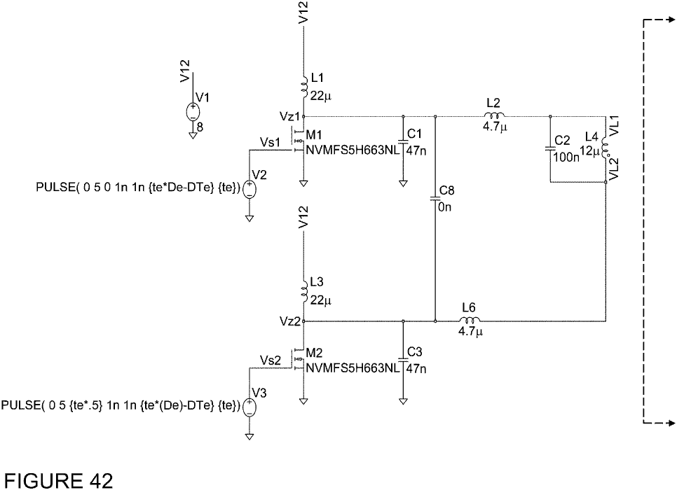

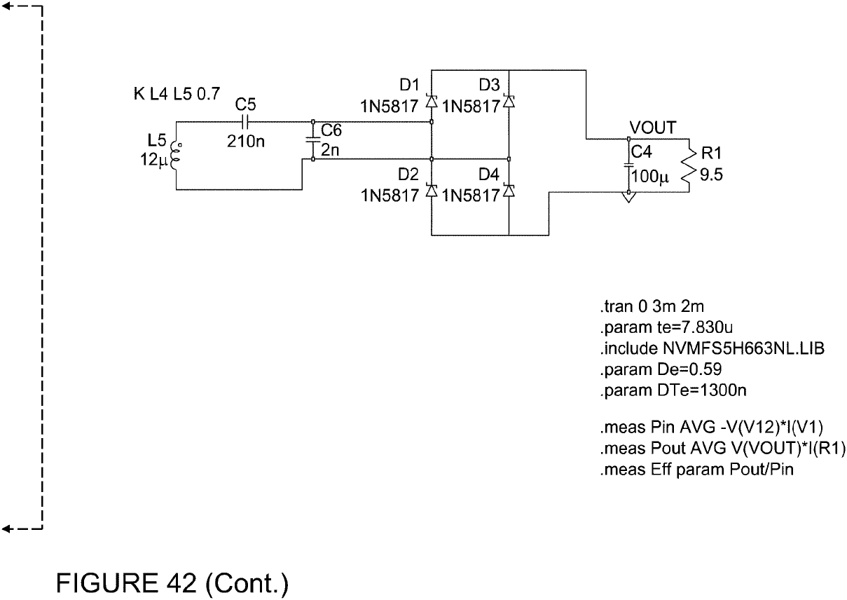

The proposed short-range topology is provided in FIG. 42.

In comparison with a class-E coil driving circuit, the proposed architecture removed the LC series resonance replacing that with a parallel and series resonant circuit, where all the inductive elements L1, L3, L2, L6, and the coil L4 resonate.

Rather than a resonant capacitor in series with the coil of the standard class E topology, a multi-resonant system is not proposed:
L1 and L3 can be sized big enough to act as a choke inductor (which means as a constant current source, where the current ripple is low in comparison with the average current on the inductor). For wireless power transfer applications compatible with Qi standard, where the working frequency is 100 kHz - 300 kHz, this means that L1 and L3 should be more than 100 uH.
L2 and L6 are calculated to resonate together with the capacitors and with the transmitting coil.
Another possibility is to reduce the size of L1 and L3 and let L1 and L3 resonate together with L2 and L6.
Finally, another possibility is to remove L2 and L6 and let L1 and act both as current source and inductive resonators.
In any case, in comparison with a standard Qi transmitter, the series capacitor can be removed
By contrast, a capacitor in parallel with the coil is added, in order to let the circuit have a resonant current path whatever the load is, in order to be able to keep Zero Voltage Switching for every load conditions and to reduce dramatically the dependency of ZVS from the load

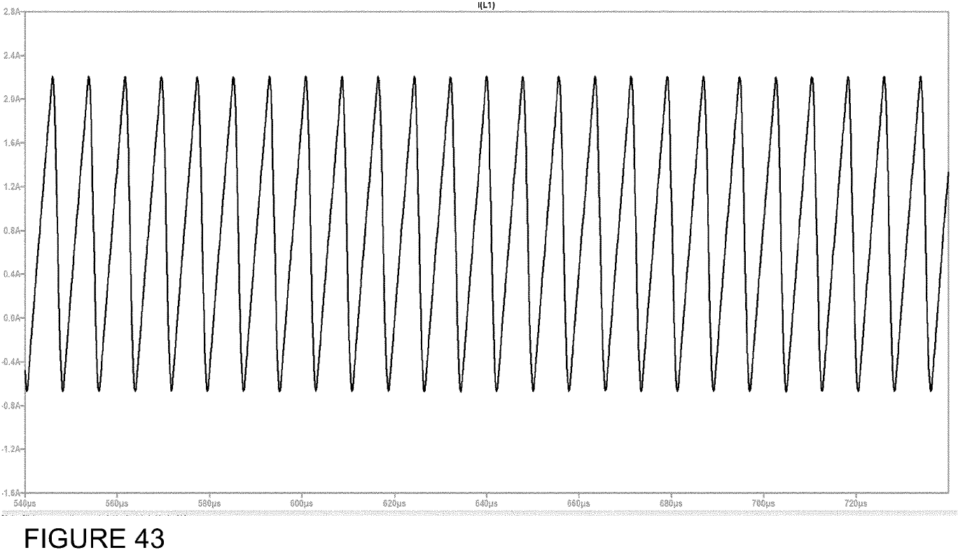

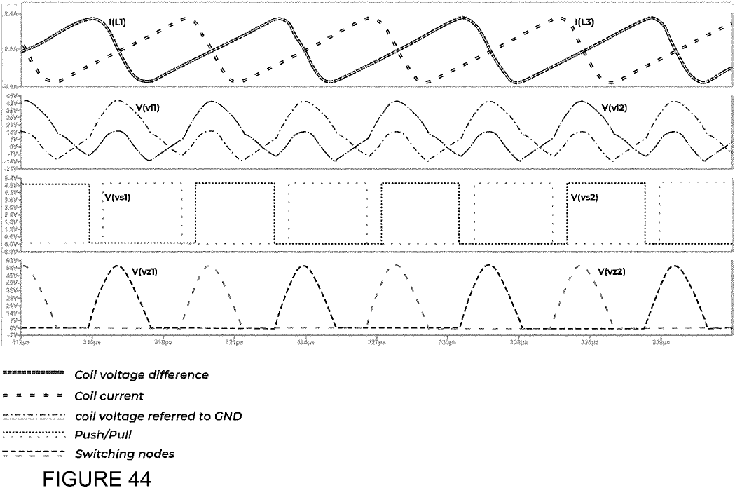

As an example, a specific implementation of the wireless charger, compatible with the Qi wireless charging standard, includes the following components:
L2 is 12 uH wireless charging coil and transfer energy to the output according to the coupling factor and the output impedance
L4, L6, C2 create a series resonance, tuned at the slightly above the switching frequency which led the system to be in tuning at different load
C2, L2 resonates in parallel also according to the leakage inductance given by the load
L1 L3 in this example are selected to be high enough (>=22 uH) to avoid the negative current going back to the source. They will have a DC current (real power) and current ripple. The selection is a trade off between DC losses and AC losses.
Negative currents in L1 and L3 are also possible (and because of the push pull implementation these currents virtually cancel each other out), as depicted in FIG. 43. In this case, L1 and L3 are acting both as a current generator and as a resonator
Switching frequency in this example is 127.7 kHz

FIG. 44 shows, from top to bottom, the line tendencies for the Push-Pull, Switching nodes, coil voltage and coil current.

The advantages of the architecture are several:
Sinusoidal wave shapes, leading to a very low radiated and conducted EMI;
Tuning of the circuit is robust to significant load and coil coupling variations thanks to the negative derivative of the MOSFETs drain voltage at Zero Voltage Cross, which is created both adding a resonant current path in parallel to the coil (the capacitor C2) and sizing the circuit in order not to compensate the power absorbed by the resonant network with the power absorbed from the current source in the Zero Voltage Cross instant: having more power absorbed by the resonant network in this instant lead to reverse conduction of the MOSFET (negative current from source to drain) so that a change in the load simply move the Zero Current Instant back and forth during the Ton, not affecting the Zero Voltage condition.
The capacitor C2 is big enough to ensure this negative derivative / negative current even in light load conditions, so that ZVS is always ensured.
In comparison with standard class-E architectures, which are zero-derivative Zero Voltage Cross, this leads to a small increase in reactive currents, and more robustness to load variations and coil coupling. Thus, there is no need for adjusting the natural frequency of the system using switched capacitors in parallel with the FETs, with a significant reduction of cost and increase of performance.
The peak voltage at the drain can be reduced significantly in comparison with standard class-E as a function of the proposed multi-resonant network. In particular, the lower the inductors L1 and L3, the lower the peak voltage (and the higher the reactive currents in the circuit). Thus, this degree of freedom can be used to select the best compromise between ensuring Zero Voltage Switching in every load condition, and lower currents at the turn-off instant of the MOSFETs.
A standard class-E amplifier works with a fixed 50% duty cycle and needs a variable input voltage to control the power transferred to the load. By contrast, in the proposed solution, when variable frequency is allowed, the following technique can be adopted:
   Toff of the circuit depends on the detection of the Zero Voltage Cross. When Zero Voltage is detected, the MOS is turned on
   Ton is calculated in order to keep minimum the reactive energy in the system, in order to minimize the drawback coming from the negative derivative at Zero Voltage Cross. Possible ways to control Ton in order to keep reactive energy at minimum are
      close a feedback loop on the output power required by the load. If the load requires less power, Ton is reduced. If the load requires more power, Ton is increased.
      close a feedback loop on the peak voltage on the drain of the MOSFET. As the peak voltage is correlated to the energy stored into the system, if the load needs less power then the peak voltage increases and Ton can be reduced accordingly.

The current in L2 and L6 is the same with opposite signs of the AC component, as well as L1 and L3. Thus, these inductors can be wound on the same core as weakly coupled inductors or independent inductors on the same core (as described in ‘Section I. Improved performance of converters’).

Alternative implementation may include one or more of the following:
Remove C2 and re-tune the system. This reduces the reactive currents, but also makes the system less robust to load variations;
Substitute C2 with C1 and C3 only
Substitute C1 and C3 with C8 only, having half the size of C1 and C3. This substitution is possible because C1 and C3 can be modelled as two capacitors in series connecting the two drains of the MOSFETs, with the node between the capacitors connected to ground voltage. Thus, C8 is the equivalent single capacitor (having half the size of C1 and C3 in series) that connects the two drains of the MOSFETs.

### 3.5 Coil Driving Topology for Long Range (k<0.5)

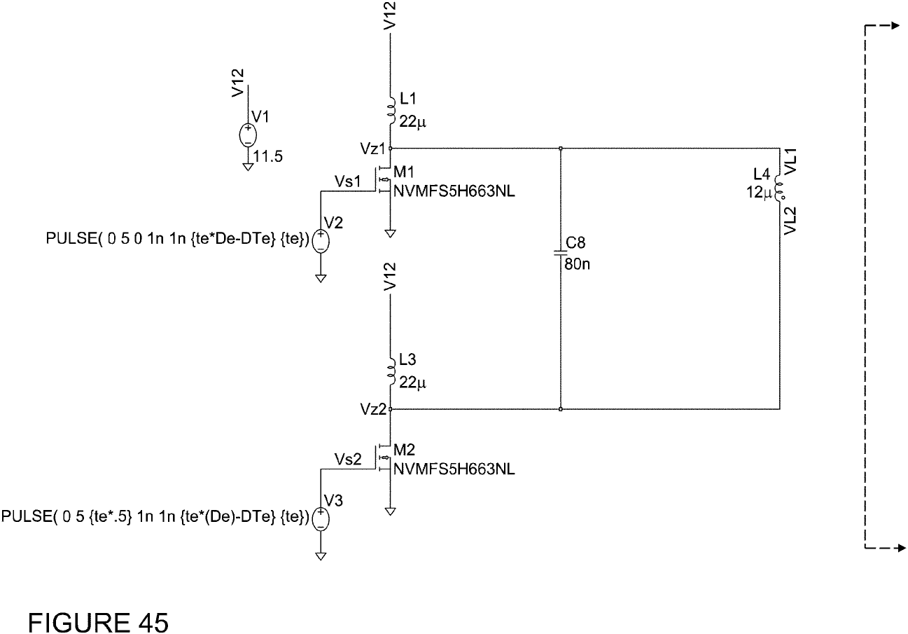

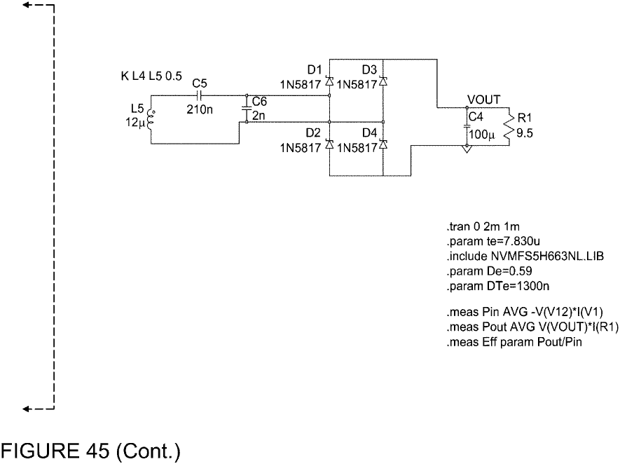

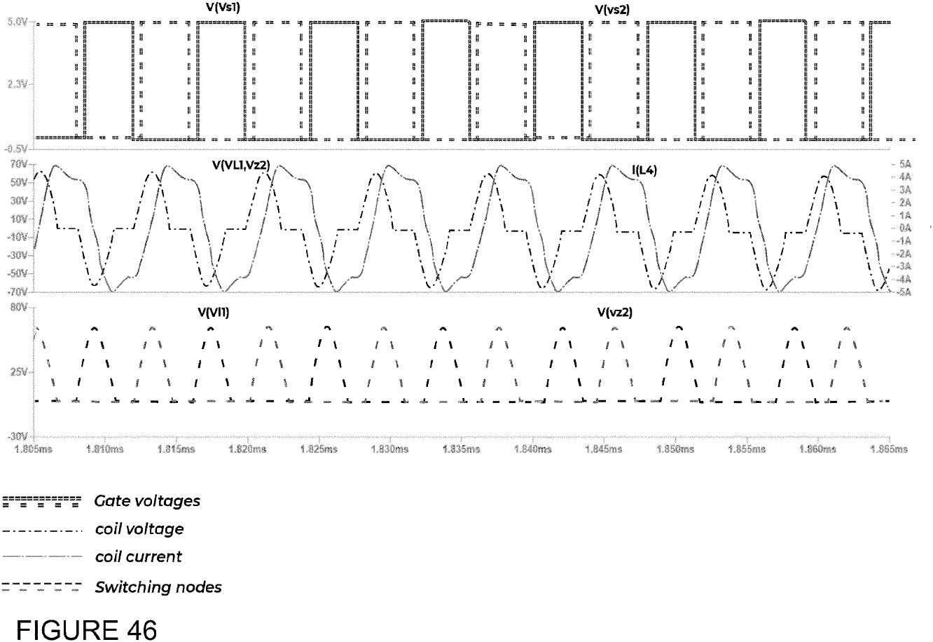

A proposed architecture for long range application is shown in FIG. 45. The circuit replaces the series capacitance seen in the standard class E topology with a parallel coil capacitor leading to a multi resonant system. L1, L3 with C1 resonates almost independently from L4, thus the circuit is very robust to load variations or coupling variations.

In this implementation, the switching frequency may be around 128 kHz, with L4 equal to about 12 uH.

FIG. 46 shows, from top to bottom, the line tendencies for the Push-Pull, switching nodes, coil voltage difference and coil current.

Alternatively, C1 may also be replaced with a pair of capacitors connected between switching nodes and GND.

### 3.6 Alternative Topology for Wireless Power

The main idea is to combine the ideas described above with the insulated forward AC/DC converter described in more detail in ‘Section IV. Insulated converter’ below. The insulated forward AC/DC converter comprises a weakly coupled transformer with primary winding and a secondary winding arranged in a forward configuration.

Since the transmitter and receiver coils used in wireless power systems are characterized by a coupling coefficient k significantly lower than 1, they can also be considered to form a weakly coupled transformer. This topology is particularly convenient for wireless charging of vehicles because the primary side inductance can be high enough to avoid high current considering the AC grid voltage.

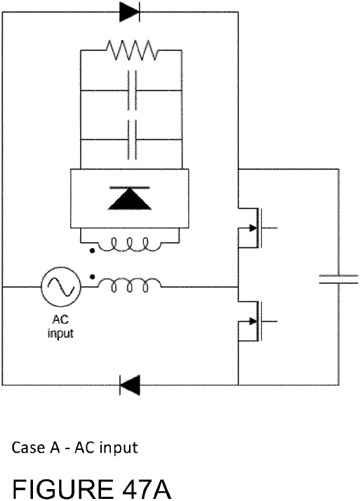

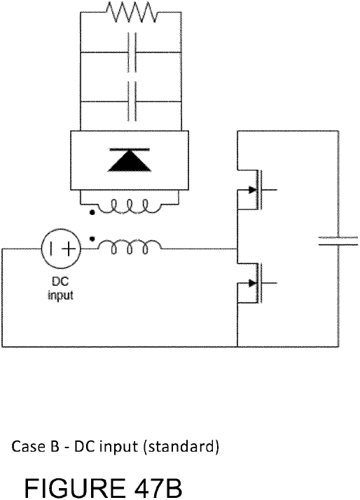

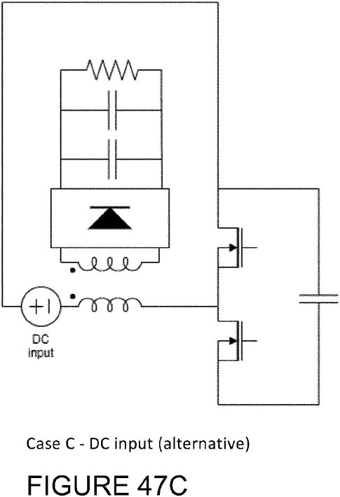

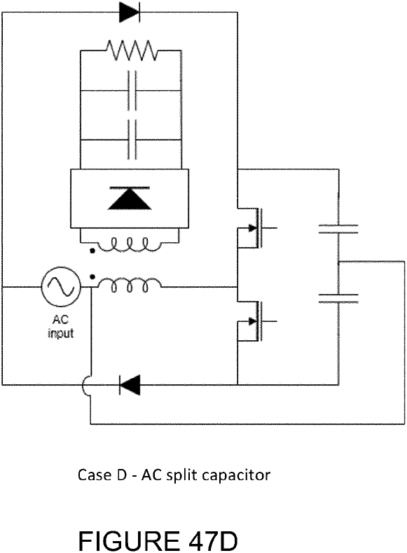

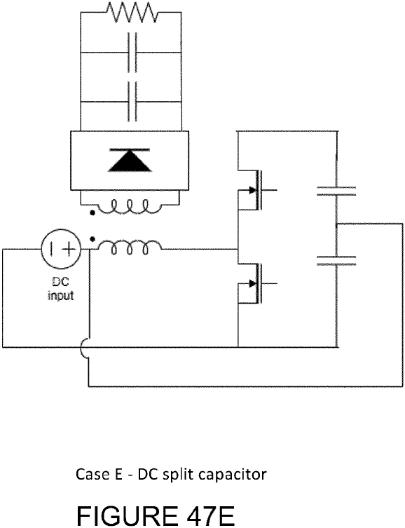

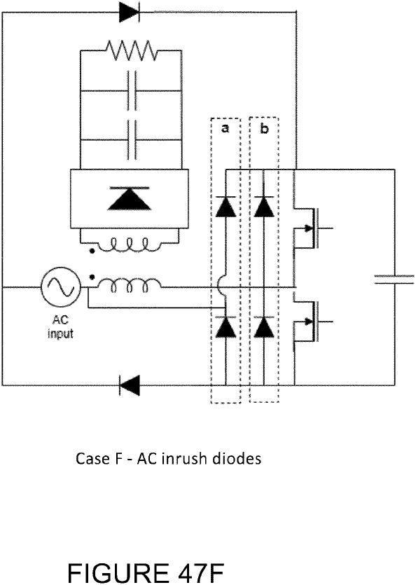

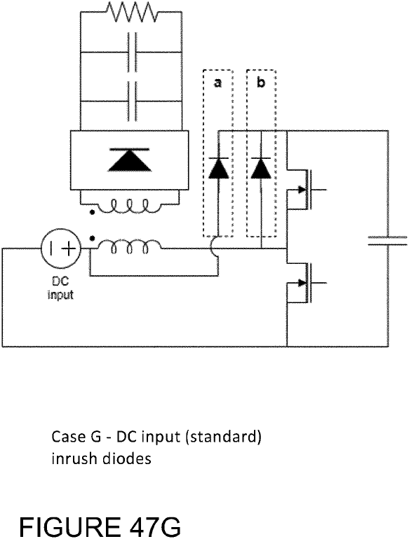

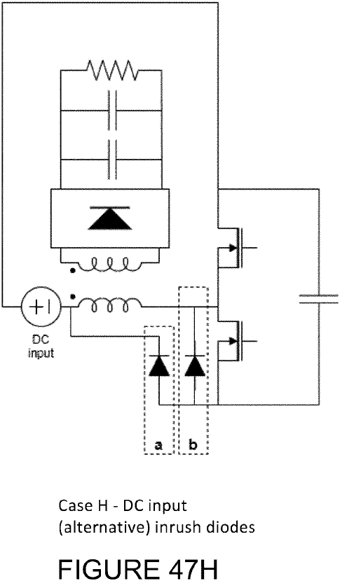

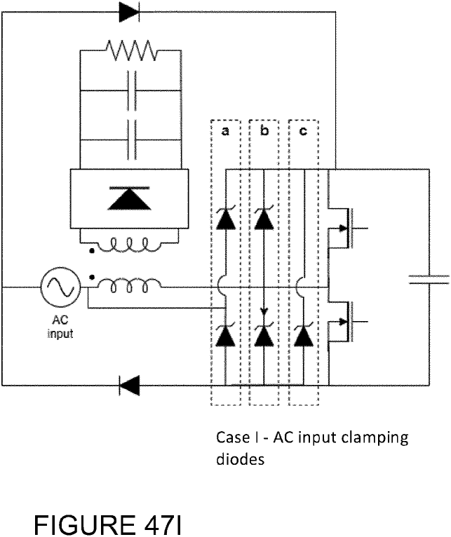

Various resulting architectures are shown in FIG. 47. FIG. 47A including an AC input, while FIGS. 47B and 47C include a DC input. The rectifier stage can be implemented with a number of topologies, such as: full bridge, voltage doubler, or push pull.

FIGS. 47D and 47E show different configurations, where the capacitor may be split into two series capacitors and referenced to the node between the input voltage and the primary winding of the transformer.

A single higher voltage capacitor may be used to achieve higher energy density, such as if the capacitor is intended to work as an energy storage.

Alternatively, two lower voltage capacitors may also be used to provide lower power density. The solution will then be cheaper with a lower equivalent series resistance (ESR), so this would be a good choice in case that a big energy storage on the primary side is not needed, especially if the capacitors’ voltages are supposed to resonate or to handle high ripple currents.

The circuit operating mode is explained in detail in ‘Section IV. Insulated converter’, together with the addition of the circuit protections shown in FIGS. 47F to 47I. They refer, respectively, to AC supply with inrush diodes (FIG. 47F), standardly arranged DC supply with inrush diodes (FIG. 47G), alternatively arranged DC supply with inrush diodes (FIG. 47H), and AC supply with clamping diodes (FIG. 47I).

### 3.6 Cap-Less Architecture

Referring to the topology mentioned above, in the case of AC supply, the idea is to remove the input capacitor used in traditional topologies, since it is not needed for the architecture shown in FIG. 47.

Thus, the storage of energy is done on the secondary side. This provides an advantage if a Power Factor Correction is needed (i.e. wireless power transmitters where input power is higher than 75 W), as an inductive input is helpful to let the architecture be controlled as a PFC.

Similarly to wireless converters, the secondary side is usually a battery powered device (i.e. a smartphone, a tablet, a phone, a laptop, an electric car, a vacuum cleaner, and so on) and the battery of the device may therefore be used as energy storage. Thus, the output of the receiver can be configured as a battery charger (i.e. usual CC-CV algorithms or other battery charging algorithms), removing completely the need of bulky capacitors in the converter and as a result reducing dramatically the size of the wireless power charger.

### 3.7 Single Stage Bridgeless & Capless Wireless Power Transfer

In addition to the topology shown in FIG. 47, A single-stage bridgeless and capless primary side is also implemented, with storage on the secondary side, exploiting the same architecture as the bridgeless forward AC/DC converter of ‘Section IV. Insulated converter’.

Bridge removal is particularly convenient for efficiency rise in the case of transmitted power larger than 200 W.

### 3.8 Communication Between Secondary Side and Primary Side

In order to ensure the best performance of the controller and to avoid bulky passive components, a low latency communication between secondary side and primary side is preferred.

Standard communication protocols may be used (like in standard Qi, based on a change of impedance of the secondary side or based on frequency modulation). However, a communication channel based on proximity coupling may also ensure lower latency, down to 10 ns. The following may be used:
Capacitive communication (See for example PCT/IB2019/054668).
Both using capacitive pads or using the parasitic capacitance between the transmitting coil and the receiving coil as a capacitive data coupling.
Proximity antenna.
Inductive data coupling.

As an effect of high-bandwidth low-latency communication, the control regulation may also be performed in a synchronous way, meaning that the turn-on signals sent to the primary side provide proper real-time rectification.

### 3.9 Long Range Packet Demodulation

Using a long-range distance (i.e. 10 mm to 50 mm) leads to a very high resonant voltage on the coil driving part. In the wireless power consortium standard the Qi packets are modulated by the receiver to the transmitter over a power channel. The modulation is called ASK (Amplitude Shift Key) and the receiver changes its own impedance, with an effect on coil voltage reflected to the transmitter. Every transition is read as “0” or “1” according to the time length.

The higher the transmitter coil voltage is, the harder it is for the microcontroller to detect the data packets because they are compressed together with the rest of the waveform. The issue has been tackled with the addition of a simple analogue circuit, which “cuts” the part of the waveform we are not interested in, allowing us to greatly reduce the scaling factor as shown below applied to a Full bridge topology.

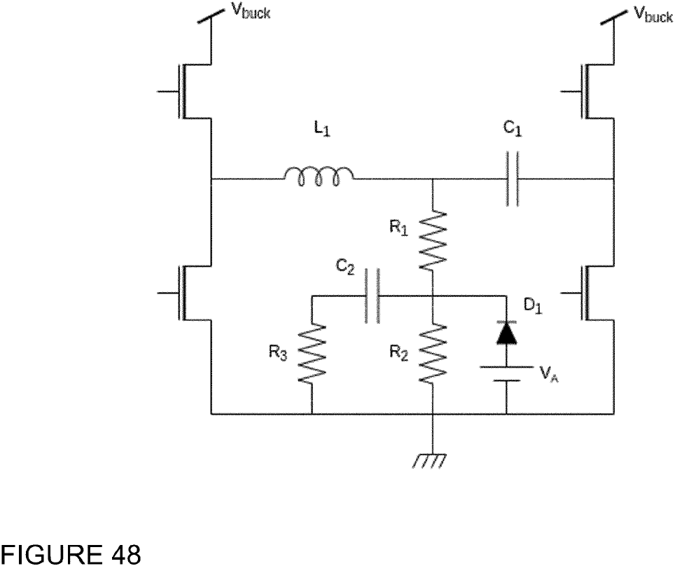

With reference to FIG. 48, a circuit is shown comprising a resonant class D inverter with the addition of the sensing network. Alternatively, other transmission circuits may be used to drive the transmitter coil L1, such as but not limited to class-E topology or any other topology.

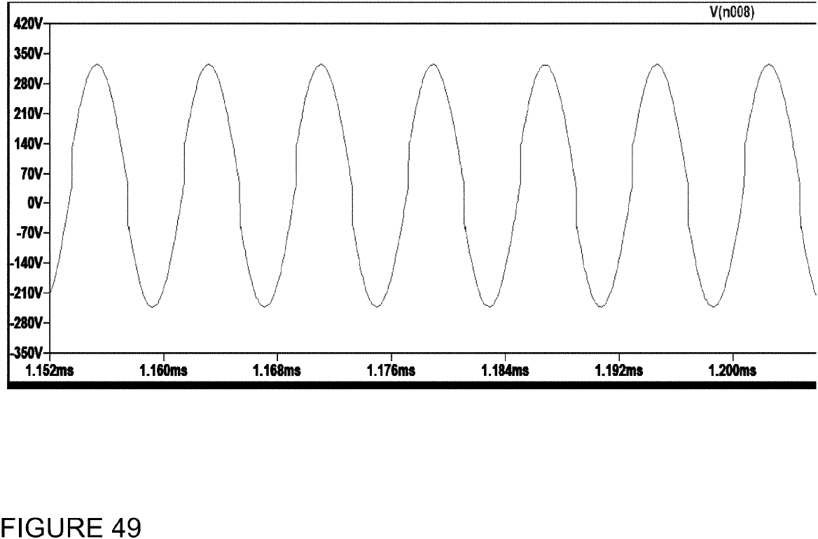

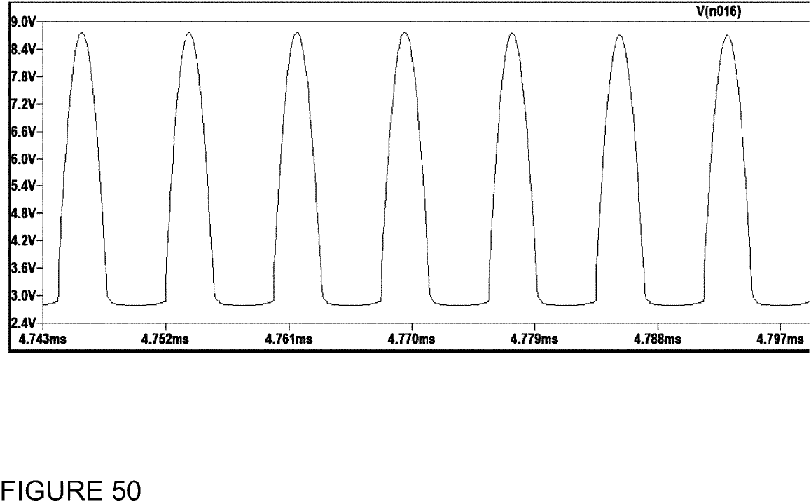

The sensing network is configured to discriminate very small voltage signals modulated over very large voltage waveforms, such as few Volts over hundreds of Volts. The sensing network includes a voltage divider that is configured to be tuned to be able to read a desired voltage value. The sensing network comprises a clipping circuit and is configured to accurately extract small amplitude variations of voltage from very high voltage signals (as shown in FIG. 49 providing a plot of the measured voltage at the resonant node, between L1 and C1 of FIG. 48) and to clip the output voltage when it is high (as shown in FIG. 50 providing a plot of the measured output of the voltage divider made of R1 and R2 of FIG. 48). FIG. 51 shows the final voltage, collected between C2 and R3, after being cut by the internal diode of the connected microcontroller.

The sensing network is positioned at a node located between L1 and C1. Resistors R1 and R2 compose the voltage divider. The diode D1, together with voltage source Va, clips the scaled voltage. The series of C2 and R3 filters the DC component of the resulting waveform, and the ADC input pin of the microcontroller is connected between C2 and R3. Finally, the internal clamping diode of the microcontroller cuts out the negative part of the signal.

The original waveform’s voltage was 540 Vpp. Using only the resistor divider (R1 = 36 kOhm and R2 = 1 kOhm), we would have got more than 14 Vpp. With this method, instead, the voltage at the end of the circuit is less than 6 V (the values listed do not reflect the ones used in the circuit).

At the same time, since the relevant part of the waveform for the demodulation is that close to the peak, it hasn’t lost any information. Besides, Va can be a variable voltage source, obtained for example with a digital output of the microcontroller and a simple RC circuit. This way we can adjust the clipping voltage based on the amplitude of the coil waveform, ensuring that we get the best performance out of the demodulation network.

### 3.10 Distance Recognition for Long Range System Calibration

The charging of a device at variable distance (such as between 10 and 30 mm) requires selecting the power level for the ping signal used to start the communication between the transmitter and the receiver. Using a weak signal may result in failure to recognize the device at long range, while using a stronger signal may damage the receiver when this is close.

Several solutions have been investigated, such as sweeping the ping voltage from low to high until the phone is detected. This solution, however, is not completely safe because the user may place the phone right on the receiver when this is sweeping to a high voltage ping, thus potentially damaging their device.

A proposed calibration system exploits the variation of the quality factor of the system when a metallic object is placed above the coil.

The calibration may be performed by the end user after the wireless charging system has been fixed underneath or in relation to furniture such as a table. At this point he must place a wide metal sheet (provided together with the charger) above the table and the tx device.

The sheet is large enough that even if it is not perfectly aligned with the Transmitter device, this will not impact the calibration process. At this point, by starting the tuning procedure (i.e. holding a pushbutton for a certain amount of time - 3 seconds) the user starts the measure of the Q factor, which is then compared with some known values to determine the thickness of the table. The Q factor is reduced by the metal sheet, thus the thickness of the surface can be determined quickly and automatically. At this point different configurations can be automatically selected, allowing safe charging.

Finally, an anti-manumission system (i.e. a button kept pushed by the surface) ensures that when the charger is removed from under the table the calibration is automatically lost, and the charging is blocked until the next calibration.

This can be done by storing a minimum amount of energy (a small battery, supercapacitor, bistable electromechanical devices ...) lets the system keep the calibration once a blackout happens.

### Methods for Calibration the Distance of the Wireless Charger

On the receiver, or close to the receiver, a known reactive element (i.e. a coil, a ferrite, or a reactive network made of capacitors and inductors) can be used to measure the distance.

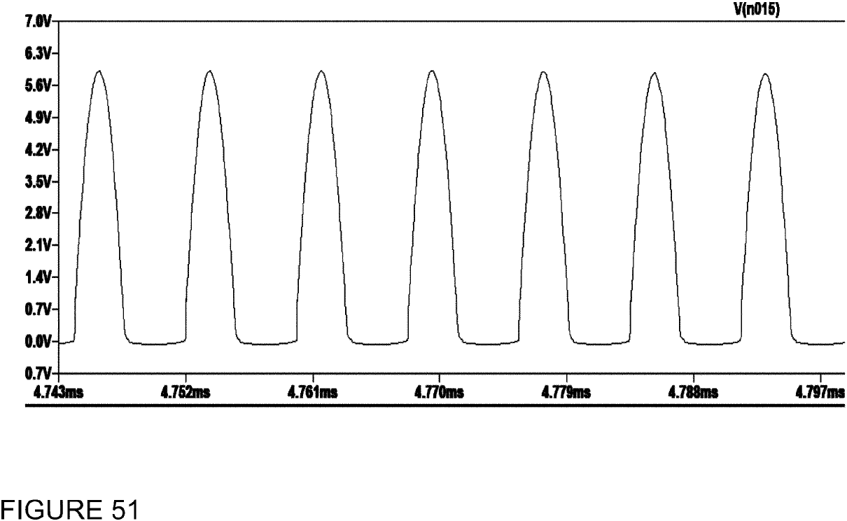

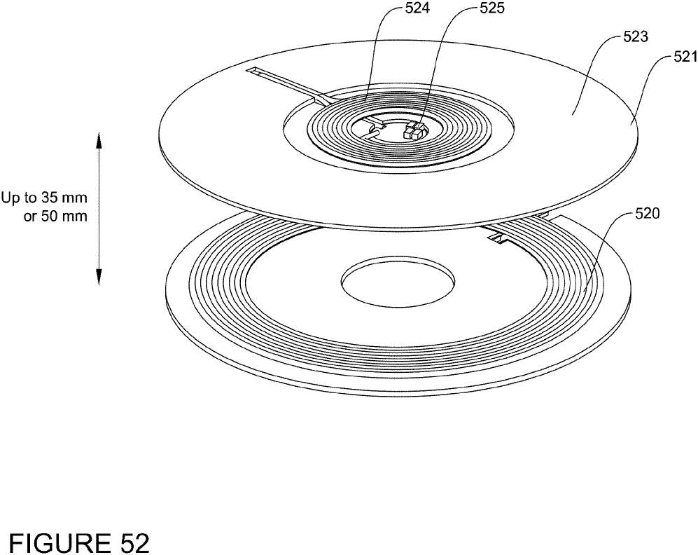

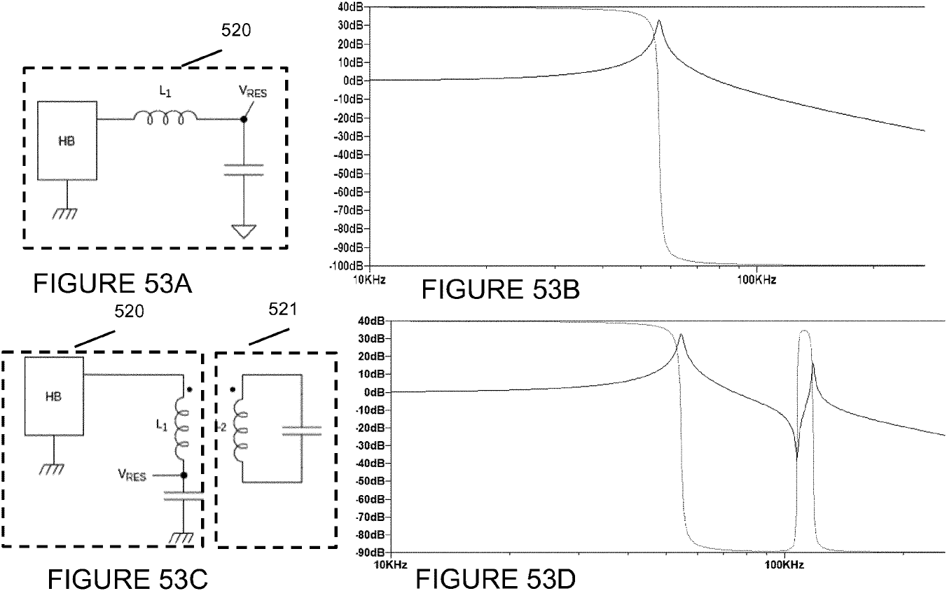

The measure is based on the change of natural resonance frequency of the transmitting resonant network due to the presence of another known reactive element. The closer the reactive element, the higher the change in the resonance behaviour of the transmitting reactive network. The distance calibration setup is shown in FIG. 52, while the working principle is reported in FIG. 53.

As shown in FIGS. 52 and 53, the wireless charger includes a transmitter coil 520 that is positioned at a fixed distance from a wireless repeater 521.

The wireless charger is configured to measure the separation distance between the transmitter coil 520 and the wireless repeater 521. The wireless repeater 521 is then configured to optimise the power delivered to a receiving coil (not shown).

The wireless repeater 521 includes a first inductor 523 (not visible) that is shaped substantially similar to the transmitter coil 520, a second inductor 524 in series with the first inductor 523, and a series resonant capacitor 525. The second inductor 524 is shaped in order to re-shape the magnetic field to deliver the maximum power to a receiving coil (not shown).

The first inductor 523 and second inductor 524 of the wireless repeater are represented as the inductor L2 in FIG. 53C.

In order to calibrate the wireless charger, the resonant frequency of the wireless charger is determined by measuring the impedance value, at the node Vres, as a function of the frequency, with and without the presence of the wireless charger (as shown in FIG. 53B and FIG. 53D).

This method has the advantage of simplicity while avoiding the need for a receiver to sense the distance between the transmitter coil and receiver coil. Also, no energy storage elements are needed to memorize the data, as the distance can be measured continuously. Finally, the L-C network can have a dual: known element to sense the distance, and a matching element between the transmitter and the receiver to improve the performance of the wireless power transmission.

### Section IV. Insulated Converter

Bridgeless converters and forward converters have already been used. However, they are uncommon, as they need a lot of extra components and increase stress on the active components in comparison with flyback converters.

### 4.1 Insulated Converter Topology

An insulated converter comprising a weakly coupled transformer including a primary winding and a secondary winding arranged in a forward configuration is now described.

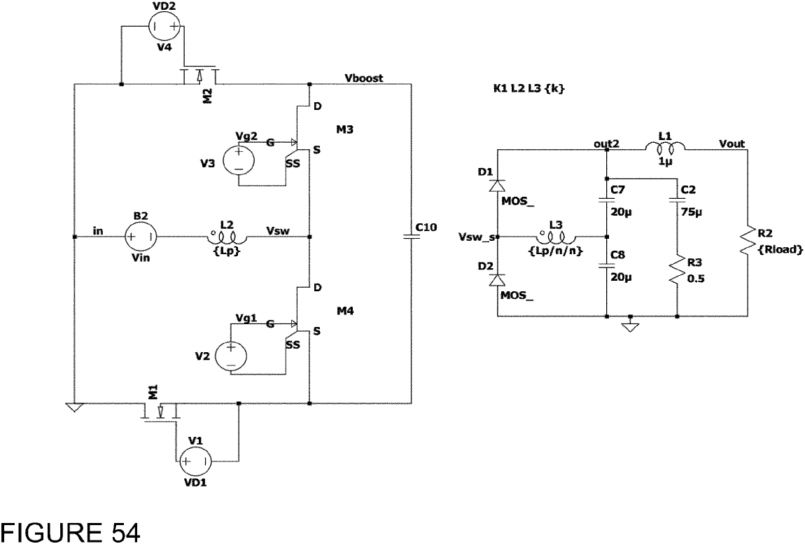

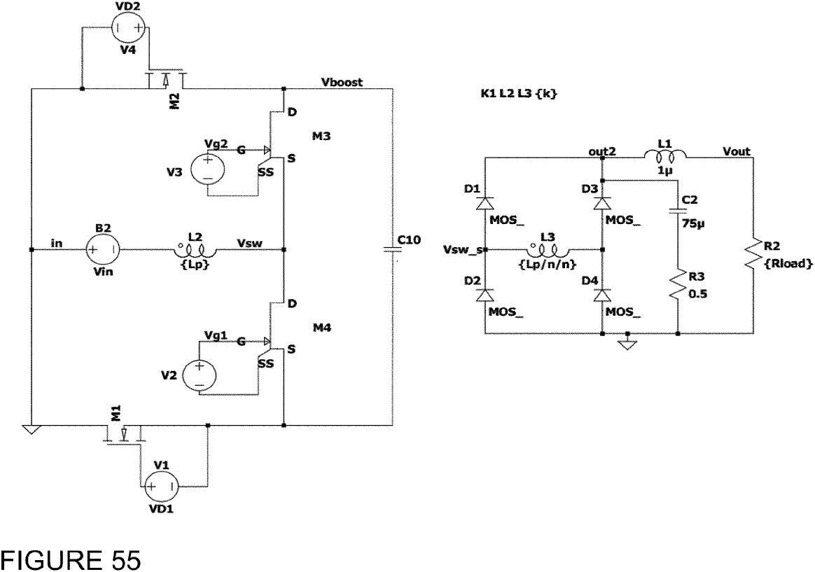

The proposed improved architecture is shown in FIG. 54 and FIG. 55, which relates to an isolated Converter (including PFC functionality and insulated regulator, or just the insulated regulator, or insulated PFC) with a storage element C2 located on a secondary side circuit and a storage element C10 on primary side. The transformer includes a primary winding L2 and secondary winding L3 arranged in a forward configuration.

It can be used as the following, but not limited to:
an isolated PFC.
insulated converter with single or multiple outputs with or without PFC.
storage on the secondary side using a battery, storage at high voltage on the primary side.

The primary side circuit is a bridgeless circuit with M1 and M2 acting as diodes (at 50 Hz). By removing two diodes as compared to standard circuits including a bridge, the power loss is halved (as two diodes are needed as compared to four). Of course, M1 and M2 can be substituted by standard diodes. Also, a standard bridge of diodes can be used for low current converters where the difference in performance is low in comparison with a bridgeless solution.

The architecture is bridgeless in order to increase the power efficiency and reduce the Bill of Material. Thus:
The drain of the upper switch (i.e. the drain of the upper MOSFET) is connected to the 2^{nd} terminal of the input source through a diode, with the anode of the diode connected to the drain of the upper MOSFET.
The source of the lower switch (i.e. the source of the lower MOSFET) is connected to the 2^{nd} terminal of the input voltage source through a diode, with the cathode of the diode connected to the source of the switch
MOSFETs driven as ideal diodes may also be used to substitute the diodes and increase the efficiency further.

The secondary side rectifying circuit can be configured as a voltage doubler circuit as shown in FIG. 54 or a full bridge circuit as shown in FIG. 55.

On the primary side, M3 and M4 are fast switching MOSFETs with high switching frequency (such as 1 MHz or 500 KHz). A capacitor C10 on the primary side circuit is located in parallel with the switching branch including M3 and M4.

The two inductors L2 and L3 are arranged on the same core and have a mutual coupling k less than 1. In the example provided in the following slides, k is chosen to be equal to around 0.8 to 0.95. Hence the transformer including primary side winding L2 and secondary side winding L3 is not an ideal transformer deliberately. The two inductors L2 and L3 are also arranged in a forward configuration, so that the current flowing in L2 has the same direction.

The presented isolated converter provides a number of important advantages, such as, but not limited to:
The forward configuration of the transformer minimises the amount of magnetic energy that needs to be stored, reducing the physical size of the transformer. In comparison with a standard forward converter, the proposed architecture does not need an auxiliary reset winding nor a reset diode, reducing the number of components and simplifying the architecture. Also, in comparison with a standard forward converter, the architecture is Zero Voltage Switching, increasing dramatically the efficiency of the converter.
L2 and L3 are weakly coupled. Hence although most of the energy is transferred to the load (similar to a standard forward converter), because of the k<1 a small amount of energy is stored in L2. This energy is used to ensure Zero Voltage Switching transitions in the primary side MOSFETs.

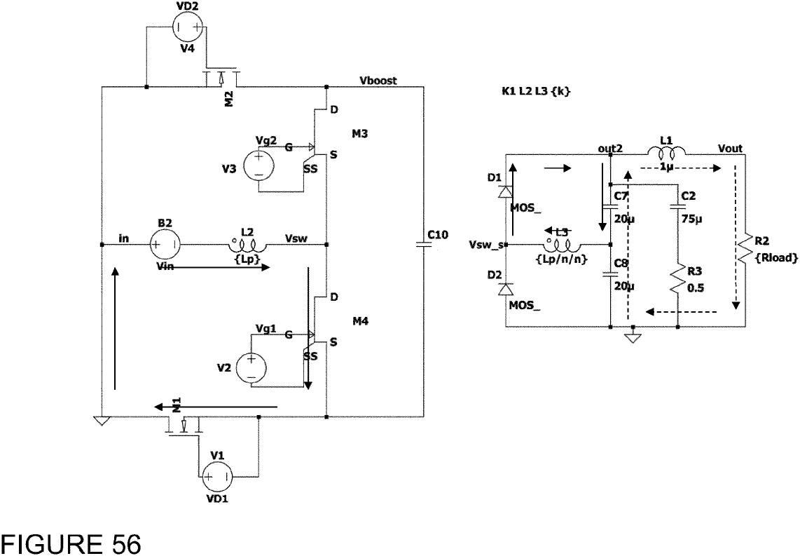

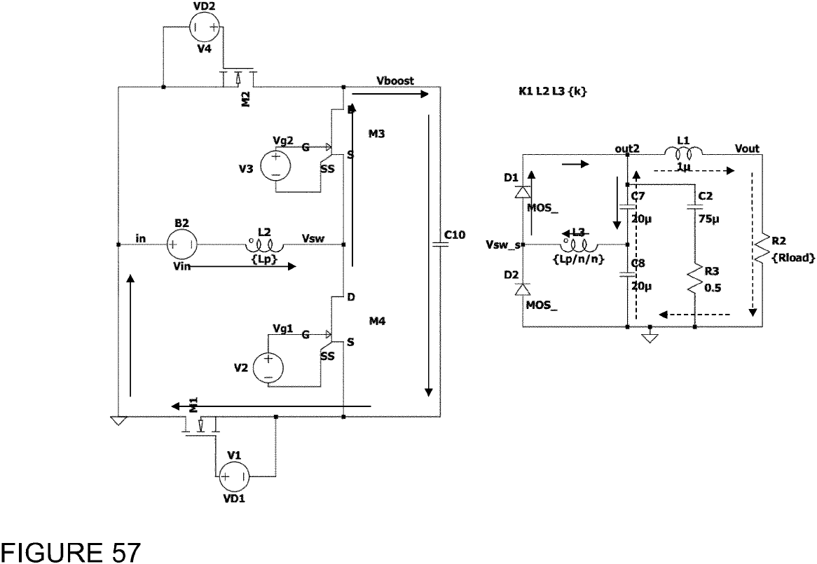

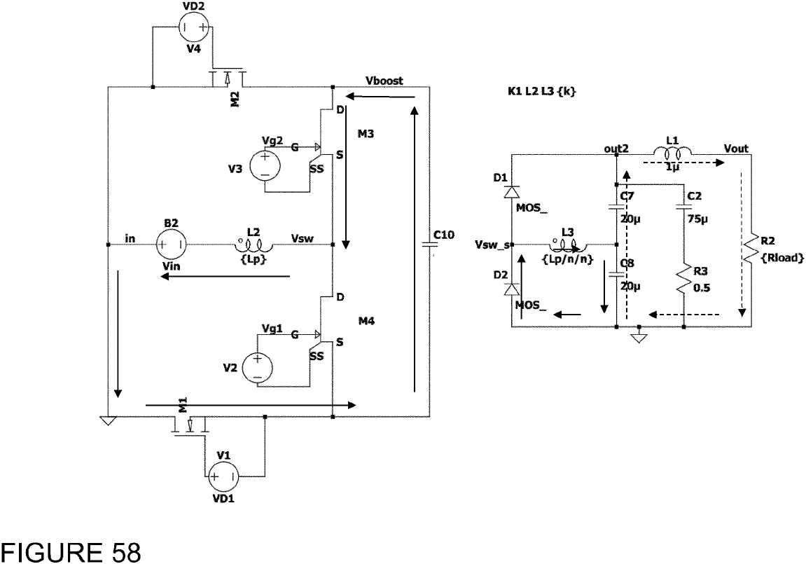

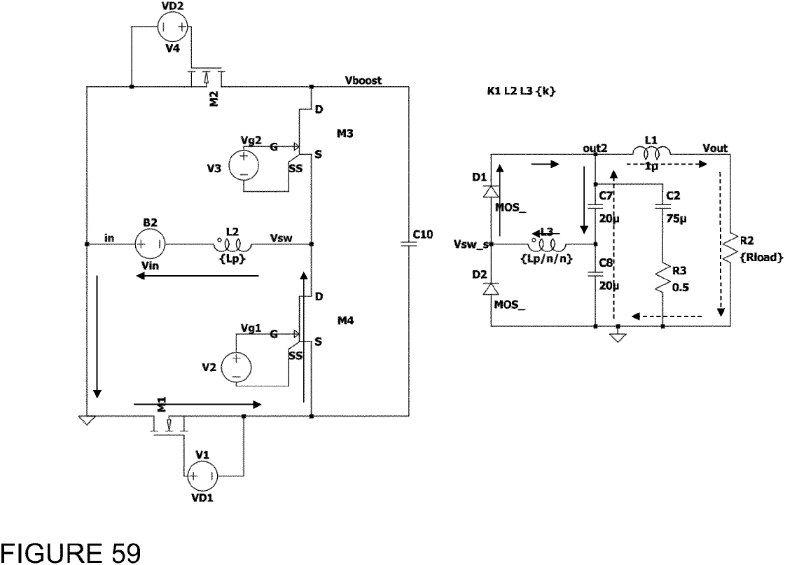

In the following description, a positive half wave of the sinusoidal AC input from the grid (50-60 Hz 90-260 V AC) is considered. During this half wave, M1 is turned ON and M2 is turned on.
During Phase 1 (FIG. 56), the primary side switch M4 is turned on. As L2 and L3 have the same polarity windings (forward-mode), energy is transferred to the secondary side and rectified by D1 (in case of a full bridge rectifier, it is rectified by D1 and D4). At the same time, because coupling between L2 and L3 is lower than 1, a small amount of energy is stored in L2 (similarly to the charging phase of a boost converter). The longer the time Ton during which the switch is turned on, the more the energy transferred to the load and the energy stored in L2.
When the switch M4 is turned off (FIG. 57), L2 acts as a current generator (because of the small amount of energy stored in L2). In this phase, the primary side circuit acts as a Boost converter discharging L2 and charging C10 through the switch M3, which is driven as a diode (similar to the diode of the boost converter). The voltage on C10 therefore rises to a voltage that is higher than the grid voltage, and the current in L2 drops progressively down to 0 A. Additionally and simultaneously, in Phase 2, energy is also still being transferred to the secondary side because of the coupling between L2 and L3, while D1 is still conducting.
The voltage at C10 can be determined or chosen based on the mutual coupling of the inductors. The lower the coupling is, the higher the voltage on C10 will be because more energy is stored in L2 during Phase 1 (FIG. 57). Also, the converter can be designed to ensure that after the initial transient the voltage at C10 is almost constant and higher than the grid, acting as a storage element, or the voltage at C10 can be highly variable, oscillating from a minimum value to a maximum value.
When L2 is fully discharged, the switch M3 is kept turned on (FIG. 58) (this is a difference between the proposed converter and a boost converter). Thus, the current is reversed in L3 (Phase 3). Hence no reset diode is needed as noted above. In this phase, energy is still transferred to the load through the diode D2 (in case of a full bridge rectifier, through D2 and D3, in FIG. 55).
When the switch M3 is turned off. The current in L2 is still not zero and flowing to the grid through M4 (FIG. 59). Thus, the parasitic capacitance of M4 is fully discharged and the voltage on the drain of M4 drops down to 0 V, ensuring Zero Voltage Switching operations.
When the voltage on M4 is 0 V, a new switching cycle can start.

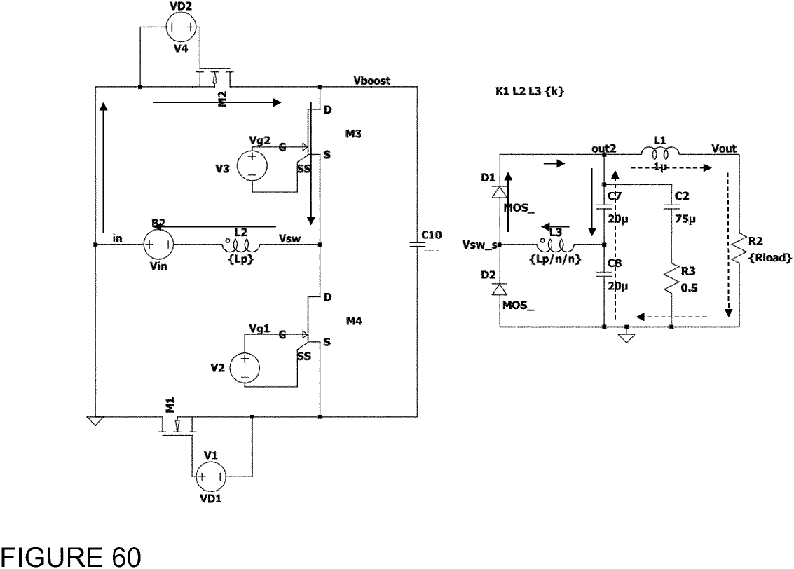

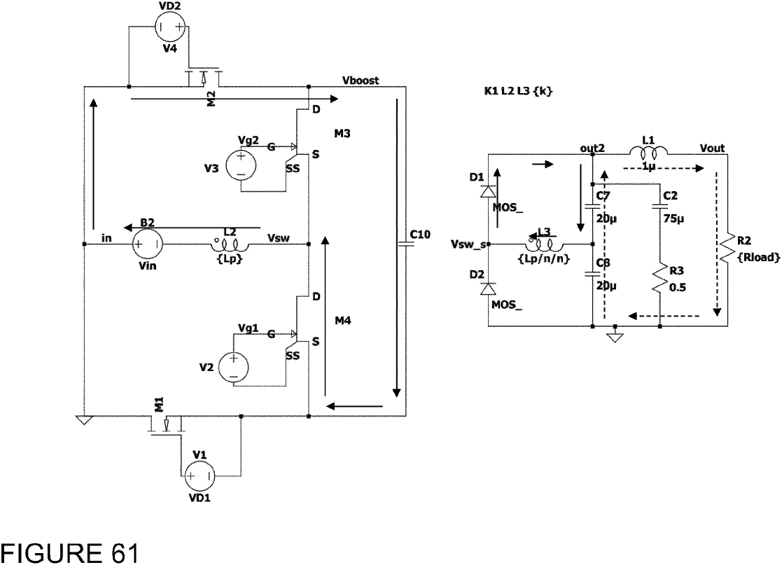

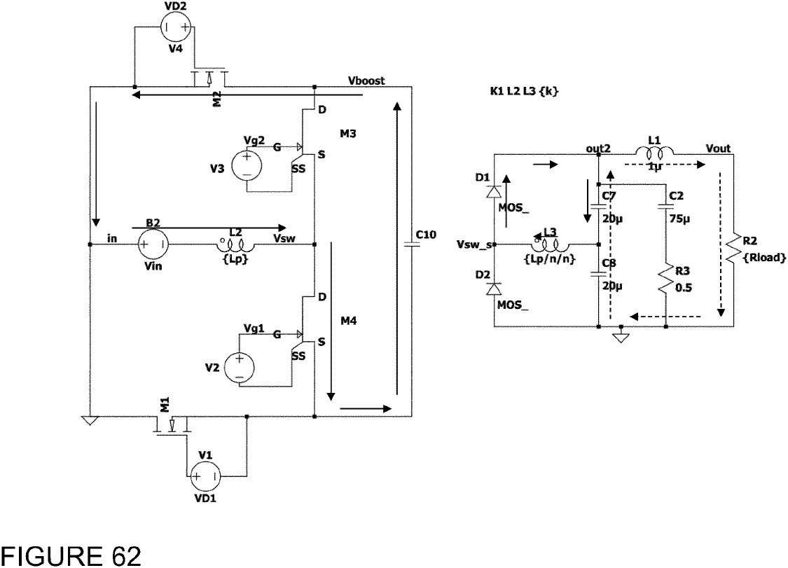

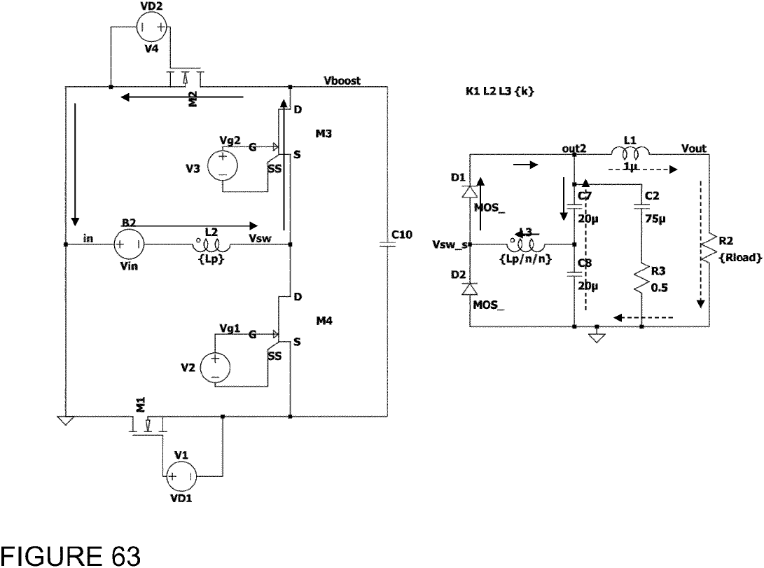

When the AC input is reversed (negative input half wave), the same cycle takes place with M2 substituting M1, and with M3 and M4 driven in the complementary way than the description above (FIGS. 60-63).

### 4.2 Bridgeless Isolated Converter Used as an Insulated PFC

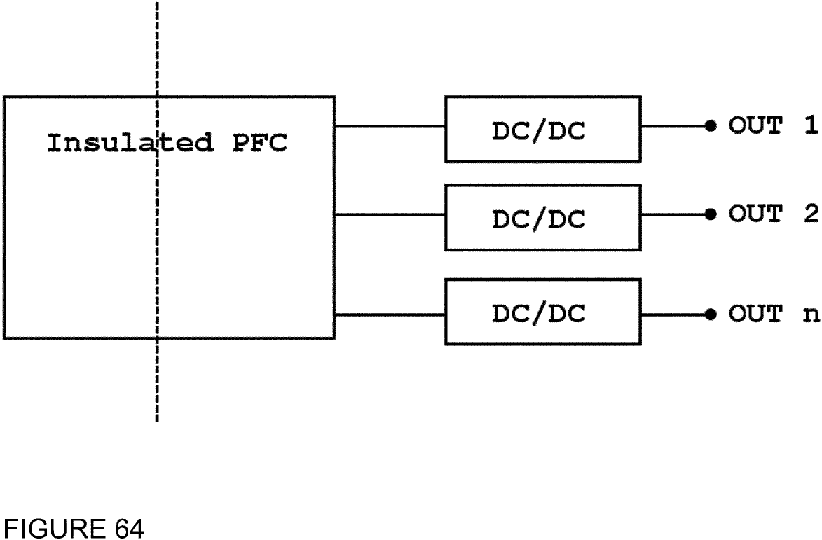

The proposed converter can be used as an isolated PFC, as shown in FIG. 64.

Energy may be stored on the secondary side:
At the output capacitor of the secondary side rectifier
At a battery or supercapacitor which is the output of the secondary side rectifier.

Energy may be stored at high voltage on the primary side on C10 high voltage capacitor. The lower the coupling between L2 and L3, the higher the energy stored on C10. If the converter is used as a PFC, then another DC/DC converter in series may be needed (or multiple DC/DC converters) to supply each load in order to achieve both PFC and output load regulations easily. However, a single stage solution can be also implemented, using one degree of freedom (i.e. the Ton of M4) to control the input current in order to achieve Power Factor Correction, and another degree of freedom (i.e. the Toff of M3) to control the output voltage

Additional degrees of freedom may also be added without increasing the number of active devices. In particular, a delay in the turn-off instant of the secondary side FETs D1 and D2 can be used to reduce the ratio between active energy delivered to the load and reactive energy in the converter, regulating the output voltage very quickly and effectively, avoiding additional converters in series.

### 4.3 Bridgeless Insulated Converter Used as a Converter Without PFC

In case that no PFC is needed, the degrees of freedom of the converter in FIG. 55 may for example be used to ensure the output voltage / current regulation without the need of additional DC/DC converter in series. Of course, in this case the input current is not in phase with the input voltage.

In both configurations (with or without PFC), the converter has several advantages, such as one or more of the following:
In comparison with standard high-power converters with PFC (usually done with PFC + LLC + DC/DC converter or PFC + flyback converter), there are just 1 or 2 stages in series, increasing the efficiency.
The circuit has better performance at light load than standard LLC based circuits
The size of the main magnetic component is much smaller than flyback converters (similarly to standard forward converters).
The circuit has a lower number of components in comparison with standard forward converters.
The circuit has a lower number of components in comparison with other bridgeless architectures.
The circuit is Zero Voltage Switching, leading to very high efficiency.
The circuit is not resonating like an LLC or class E converter, thus the light load efficiency is much higher.

### 4.4 Battery or Supercapacitor as Storage Element

When a battery or a supercapacitor is used as storage element on the secondary side, there are some significant advantages in comparison with standard capacitors:
Energy density (J/cm^3) is much higher in a battery than a standard capacitor. This means that the same amount of energy can be stored in a much smaller size, reducing dramatically the size of the converter.
If the size of the battery is high enough (i.e. considering a 3.7 V lithium battery, more than some thousands mah -i.e. 10.000 mah), then the converter will act at the same time as an AC/DC converter and as a power bank, creating a hybrid device that saves volume and cost in comparison with 2 separated accessories (an AC/DC adapter + a power bank) or in comparison with an accessory that integrates a standard AC/DC circuit + a standard power bank circuit inside.

### 4.5 Primary Side C10 Capacitor Used as Storage Element

Thus, by decreasing the mutual coupling, such as for example with a mutual coupling k of about 0.5, less energy would be stored on the secondary side and in turns more voltage would be stored on the storage element C10 of the primary side. In this case, there are some advantages in comparison with storing energy on the secondary side:
This approach has the advantage of high voltage energy store (thus, reducing the storage capacitance because energy follows E=½*C*V^2 rule). This leads to reduction of size of the storage capacitors in comparison with secondary side storage.
Another advantage of this storage is the fact that - in comparison with conventional adapters without PFC - the same high voltage C10 capacitor may be used to store energy at high voltage, whatever the input AC voltage is. By contrast, in a standard adapter the input capacitor is pretty inefficient as it must resist to the high voltage of the EU grid (thus less efficient in terms of F/cm^3), and at the same time must have big capacitance and low resistance to store energy at low voltage and higher current when the US grid is connected (thus, the input capacitor is very bulky). By contrast, using C10 as storage element means that it will be regulated as the output of a standard boost converter, so storing energy in a very efficient way at high voltage whatever the input voltage is (like in a standard boost PFC - but with only 1 or 2 stages in series rather than 3).

### 4.6 Light Load Conditions

When the load increases, the duty cycle increases. By contrast, the duty cycle decreases for light load conditions.

When light load occurs, there may be a problem in reducing the duty cycle of M1 too much. Often controlling the duty cycle for light load conditions is very complicated or very expensive as it requires the use of expensive timers.

A proposed solution for reducing the duty cycle is to turn off the high side MOSFET M2 located on the primary side when the current in the transmitting coil is 0A and the voltage in the capacitor is at its maximum (an instant before the current reverses from the capacitor to the input source).

Then the system can remain turned off for a long time, and then restarted in ZVS conditions when a new cycle is needed.

Advantages of this solution includes:
high efficiency is achieved.
ZVS is achieved even in light load conditions. As a comparison, this is not possible with standard burst-mode controllers.
Zero current condition is also achieved.
The turn off time can be changed in a continuous way.

Alternatively, this may also be applied to other non-isolated topology with a load directly coupled to C10 in parallel.

### 4.7 Inrush Diodes

Depending on the technology used to realize an electronic switch, the topology may embed a body diode (such as silicon FETs) or any other mechanisms that allow the current to flow from source to drain even with a low driving signal (ie. gallium nitride FETs).

When the DC or AC voltage is first applied to the input of the circuit, body diodes may provide a current path from the input voltage to the initially discharged capacitor. The capacitor may then start quickly charging with a very high current, which in turn may overstress the switch. In order to protect the switch, inrush diodes are added to the circuit in order to carry the inrush current that may otherwise damage the switches.

Several solutions are presented: in case of an AC input, both FETs must be protected, while in case of a DC input, just one switch must be protected because the other one does not provide a capacitor charging current path.

In order to protect the low-side FET, the diode’s anode must be connected to the FET’s source, and the cathode can be connected to one of the two terminals of the primary side winding (FIG. 47F and FIG. 47H).

In order to protect the high-side or upper MOSFET, the diode’s cathode must be connected to the FET’s drain, and the anode can be connected to one of the two terminals of the primary side winding (FIG. 47F and FIG. 47G).

### 4.8 Clamping Diodes

During start up, light load conditions, reversible and not reversible fault conditions or for other reasons, the high frequency switching FETs may both be turned off for an undefined time (up to some seconds). Additionally, if the FETs present an embedded body diode or a similar behaviour, the body diodes then behave like a voltage doubler rectifier for the AC input voltage. In this condition, the voltage on the capacitor would be equal to the double of the input voltage.

In many countries, the upper tolerance of the 230 VAC nominal mains is about 265 VAC, that means a peak voltage of 373 V, and the double of the peak would be 747 V.

If the FETs and the output capacitor can all individually sustain this voltage, no additional protections are needed. If it is not the case, some voltage clamps (such as zener diodes, Transient Voltage Suppressors or MOVs.) may be needed.

A single clamping diode may be connected in parallel with the half bridge (FIG. 47I, option “c”), or two clamping diodes may clamp each FET’s voltage, with the same options described for the inrush current limiting diodes (FIG. 47I, options “a” and “b”).

### Appendix - Key Features

In this section, we disclose the various concepts and features into the following categories or core technology:
SECTION I. Improved performance of converter
SECTION II. Improved LLC Converter
SECTION III. Wireless charging
SECTION IV. Bridgeless isolated converter

Note that different concepts or approaches and features may be combined with one another. For simplicity, we have organised features relating to a specific higher-level feature or concept; however, this is generally a preferred implementation only and the skilled implementer will appreciate that features should not be interpreted as being limited to the specific context in which they are introduced but may be independently deployed.

### Section I: Improved Performance of Converters

### 1.1 Multiple Independent Inductors on a Single Core With K Less Than 0.4

### Concept A - Multiple Independent Inductors With Windings Arranged on a Single Core

An electromagnetic device comprising multiple inductors, each inductor having windings arranged near or on a single core, in which the device is configured such that the multiple inductors are substantially independent or magnetically isolated from one another.

Optional features:
The magnetic flux path of an inductor is independent of the magnetic flux path of the remaining inductors arranged on the single core.
The device is configured such that the mutual coupling between multiple inductors k is zero.
The device is configured such that the multiple coupling k between the inductors is less than 0.1.
The device is configured such that the multiple coupling k between the inductors is less than 0.4.
Each inductor electromagnetically couples to the single core while avoiding a saturation of the core.
k = 0 to 0.4 for multiphase converters.
Windings of the inductors are wire windings.
Windings of the inductors are planar windings printed on a substrate.
Primary and secondary windings are planar windings printed on the same substrate.
Primary winding is printed on one side of the substrate, and the secondary winding is printed on the other side of the substrate.
Windings are printed on the inner layers of the substrate.
Windings of the inductors are a combination of wire windings and planar windings.
Advantages include, but are not limited to: reduced physical size as compared to standard applications for similar cost, ease of manufacturability, magnetic permeability of the core needed is reduced hence cheaper magnetic can be used, multiple inductors with multiple phases can be implemented on a single magnetic core, the inductors can each be driven in a random way.

### Concept B - Multiple Independent Inductors with Windings Arranged on a Single Core with Multiple Air Gaps

An electromagnetic device comprising multiple inductors having windings arranged near or on a single core, in which the device is configured such that the multiple inductors are substantially independent or magnetically isolated from one another, and in which the single core includes multiple air gaps, each associated with an inductor, such that the magnetic energy of the flux path of each inductor is substantially concentrated within the air gap it is associated with.

Optional features:
The inductors are wound on different parts of the single core in order to avoid wire-to-wire magnetic coupling.
Single core includes a central leg in which the central leg does not include an air gap.
Central leg effectively comprises zero or near zero magnetic field.
Central leg effectively comprises zero or near zero magnetic field no matter the excitation signal driving each inductor.
Excitation signals driving the multiple inductors are not symmetric.
The inductors excite the central leg with opposite magnetic fields, so that the resulting magnetic field is zero or close to zero.

### Concept C - Specific Structure of Two Independent Inductors on a Single Core

An electromagnetic device comprising:
(i) a single core having a central leg and two lateral legs connected to each other with end members, in which the lateral legs comprise an air gap,
(ii) a first and second inductors, each having a winding arranged around the end members;
and in which the first and second windings are independent or magnetically isolated from one another.

Optional features:
Magnetic energy of the flux path of the first inductor is substantially concentrated within the first lateral leg air gap and the magnetic energy of the flux path of the second inductor is substantially concentrated within the second opposite lateral leg air gap.
The first and second windings are wound in opposite directions.
Central leg of the core does not include an air gap.
Central leg effectively comprises zero or near zero magnetic field.
Central leg effectively comprises zero or near zero magnetic field no matter the excitation wave inputted in each leg.
The inductors excite the central leg with opposite magnetic fields, so that the resulting magnetic field is zero or close to zero.
The winding of the first inductor is arranged on a portion of the end member between the first lateral leg and the central leg, and the winding of the second inductor is arranged on a portion of the end member between the central leg and the second opposite lateral leg.
Magnetic flux path of the first inductor is independent of the magnetic flux path of the second inductor.

### Concept D - Specific Structure of Multiple Independent Inductors on a Single Core

An electromagnetic device comprising:
(i) a single core having a central leg and multiple lateral legs connected to each other with end members, in which the lateral legs comprise an air gap,
(ii) multiple inductors having windings arranged around the end members;
and in which the device is configured such that the multiple inductors are substantially independent or magnetically isolated from one another.

Optional features:
Central leg of the core does not include an air gap.
Central leg effectively comprises zero magnetic field.
Each inductor electromagnetically couples to the single core while avoiding a saturation of the core.
The multiple inductors are wound in the same direction on the single core and driven with the same input signal with a different phase (phase difference between subsequent windings is equal to 360/n degrees where n is the number of inductors).
Multiple inductors are wound in a random manner when the mutual coupling k between the multiple inductors is very low, such as less than 0.1.
Excitation signals driving the multiple inductors are random independent signals.
The inductors excite the central leg with opposite magnetic fields, so that the resulting magnetic field is zero or close to zero.

### Concept E - Converter Including Multiple Independent Inductors on a Single Core

A power converter comprising an electromagnetic device including multiple inductors having windings arranged near or on a single core, in which the device is configured such that the multiple inductors are substantially independent or magnetically isolated from one another.

Optional features:
Converter is a boost converter and the electromagnetic device corresponds to the input inductor.
Converter is a class-E or class-F converter and the electromagnetic device corresponds to the input inductor.
Converter is a PFC and the electromagnetic device corresponds to the input inductor.
Converter is a buck converter and the electromagnetic device corresponds to the output inductor.
Converter is any other converter, such as an LLC, LCC, Cuk or Sepic converter, forward converter or asymmetrical half-bridge flyback converter.
Converter is an interleaved power converter.
Converter is a multi-phase interleaved converter and the number of independent inductors on the single core corresponds to the number of phases of the converter.
Converter is a multi-phase interleaved converter with n different phases, where each phase is shifted by 360/n degrees in the driving signal.
Converter delivers up to 1 KWatts.
Converter delivers up to 500 Watts.
Converter delivers up to 300 Watts.
PFC application delivers about 200 Watts to 300 Watts.
PFC application has >75 W input (i.e. due to regulatory requirements)
Converter does not include any cooling elements.
Converter does not include a fan.
Converter does not include a heat sink.
The inductors may generate opposite magnetic fields on the central leg allowing to reduce the core size.
Cost reduction of the MOSFET and DIODES as compared to standard MOSFET as lower current values are needed.
Efficiency is improved by implementing multiple inductors with multiple phases with lower current values needed for each phase.
Magnetic permeability of the single core is less than 100, such as 40, for a power converter operating around hundreds of KHz (as compared to conventional solutions using a magnetic permeability of the single core of greater than 100 or even higher than 1000 for similar frequency range of operation).

### Concept F - Multi-Phase Power Converter Including Multiple Independent Inductors on a Single Core

Multi-phase power converter comprising an electromagnetic device including multiple inductors having windings arranged near or on a single core, in which the electromagnetic device is configured such that the multiple inductors are substantially independent or magnetically isolated from one another, and in which the multi-phase power converter is integrated on a single chip.

### Concept G - Method of Manufacturing an Electromagnetic Device Include Multiple Independent Inductors

Method of manufacturing an electromagnetic device comprising multiple inductors, each inductor having windings arranged near or on a single core, the method including winding the multiple inductors using conventional bobbins, and in which the electromagnetic device is configured such that the multiple inductors are substantially independent or magnetically isolated from one another.

Optional feature:
The multiple inductors are wound with opposite directions on the same conventional bobbin.

### 1.2. Weakly Coupled Transformer

Concept A - Specific structure of weakly coupled inductors Electromagnetic device comprising:
(i) a single core having a central leg and two lateral legs connected to each other with end members, in which the central leg and the two lateral legs each comprises an air gap, the air gap of the central gap being smaller than the lateral legs air gaps;
(ii) multiple inductors having windings arranged around the end members; and in which the multiple inductors are configured to have a weak mutual coupling k where k is determined by selecting the ratio between the central gap and the lateral gaps.

Optional features:
Central gap is smaller than the lateral gaps.
Reducing the central gap reduces the coupling between the multiple inductors.
Central gap is half as big as the lateral gaps (to achieve a k of about 0.5).
Central gap is four times smaller than the lateral gaps (to achieve a k of about 0.35).
k is less than 0.5.
k is less than 0.4.
k is more than 0.5 and less than 0.95
Primary side is driven in a resonant or quasi-resonant way.
Inductors are configured to operate in discontinuous current mode.
k depends on magnetic current or hard switching voltage condition.
k = 0.5 to 0.8 for resonant applications.
Windings of the inductors are wire windings.
Windings of the inductors are planar windings printed on a substrate.
Primary and secondary windings are planar windings printed on the same substrate.
Primary windings are printed on one side of the substrate, and the secondary windings are printed on the other side of the substrate.
Windings are printed on the inner layers of the substrate.
Windings of the inductors are a combination of wire windings and planar windings.

### Concept B - PFC Converter Comprising Weakly Coupled Inductors

PFC converter comprising an electromagnetic device, in which the electromagnetic device comprises multiple inductors having windings arranged near or on a single magnetic core, in which the electromagnetic device is configured such that the inductors have a weak mutual coupling k.

Optional features:
Inductors are configured such that the mutual coupling k is up to 0.35.
Inductors are configured such that the mutual coupling k is up to 0.5.
Value of mutual coupling is selected based on one or more of the following: parameters of the magnetic core, type of MOSFET, input voltage required, and output voltage required.
Current needed to drive the inductors is reduced by means of interleaved multi-phase operations, which in turns reduces the size of MOSFETs and DIODEs needed.
K is selected in order to minimize the global losses (mainly the optimum value that minimize the inductor losses, which means k->0 and the MOSFET losses, which means k>0, the higher the parasitic capacitance of the MOSFET and the input voltage, the higher the k needed).
The mechanism is the transfer of energy from one branch to the other by means of the weak coupling, thus reducing the voltage on the drain of the MOSFET before the turn on of the MOSFET. This increases the losses in the inductors because of higher RMS currents and this is the reason why a compromise is needed.
Weak coupling between the multiple inductors is determined to be able to discharge the drain of the active MOSFET used in the PFC converter.
MOSFET is selected based on its parasitic capacitance (In standard applications, the parasitic capacitance is often seen as limiting the operation of a PFC converter including its frequency of operation or switching speed. Here the parasitic capacitance of the MOSFET is used in order to improve the overall efficiency of the PFC converter while reducing the overall cost as cheaper MOSFETS can be used.)
PFC achieves 99% efficiency for a specific PFC converter application with the following parameters: k is around 0.35, EU grid (230 V AC rectified), output power of about 300 W.
Improved efficiency is achieved for high frequency of operation with a magnetic core having a smaller size and a lower cost as compared to standard magnetic core used for similar frequency of operation (as an example, a PFC converter delivering 300W of power is achieved using a standard magnetic core that is conventionally used in applications delivering about 30W of power, hence saving in terms of size and cost of the magnetic). In comparison with standard multi-branch interleave converters; the weak coupling between the inductors is able to increase the overall efficiency of the converter (lower turn-on voltage is needed).

Use case applications:
Power supply for TV, high powered laptops, home appliances.
Switch mode power supply.
USB powered delivery.

### Section II. Improved Llc Converter

### Concept A - LLC Resonant Converter with a Split Resonant Capacitor Configuration and a Weakly Coupled Transformer

LLC resonant converter comprising
(i) a first switch connected between a DC input and an half bridge node;
(ii) a second switch connected between the half bridge node and a ground input;
(iii) a resonant tank comprising:
   a resonant inductor connected to the half bridge node,
   a first resonant capacitor connected to a transformer and the positive terminal of the DC input,
   a second resonant capacitor connected to the transformer and to the negative terminal of the DC input;
   in which the transformer connects to the resonant inductor, and in which the transformer includes a primary winding and a secondary winding, the secondary winding being connected to a rectifying circuit for providing a rectified DC voltage to an output load, and in which the transformer is configured as a weakly coupled transformer.

Optional featurea:
Windings are wire windings.
Windings are planar windings printed on a substrate.
Primary and secondary windings are planar windings printed on the same substrate.
Primary windings are printed on one side of the substrate, and the secondary windings are printed on the other side of the substrate.
Windings are printed on the inner layers of the substrate.
Windings are a combination of wire windings and planar windings.

### Concept B - LLC Resonant Converter Further Including Two Clamping Diodes

LLC resonant converter as defined above that further comprises two clamping diodes.

Optional features:
Each clamping diode is connected in parallel to one of the resonant capacitors.
LLC resonant converter includes a plurality of resonant capacitors.
LLC resonant converter includes a plurality of clamping diodes.

### Concept C - Techniques for Increasing the Timer Resolution

A method of operating switching signals of an LLC power converter, in which the LLC power converter includes a first switch connected between a DC input voltage and an half bridge node, and a second switch connected between the half bridge node and a ground input;
the method including, at a control subsystem, generating a first switching signal and a second switching signal for controlling the first switch and the second switch of the LLC power converter,
in which the first and second switching signals are generated as asymmetrical signals by increasing or decreasing the on time of one of the switching signals by a specific time duration, and in which the time duration is substantially similar to the maximum resolution of the control subsystem.

Optional features:
The first and second switching signals are generated as asymmetrical signals, by increasing or decreasing the on time of one of the switching signals by a specific time duration.
At each cycle, the control subsystem generates the switching signals based on the previous cycle or cycles.
Control subsystem generates a pattern of switching signals such that the average duty cycle of the two switching signals is substantially similar.
At a cycle, the on time of one of the switching cycles is increased or decreased by the specific time duration and at a subsequent cycle, the on time of the other switching cycle is increased or decreased.
The control subsystem is able to change the manner in which each switching signal is generated at each cycle or after a specific number of cycles, such that the average duty cycle of the two switching signals is substantially similar.
Control subsystem is implemented as firmware by a digital signal processor.
Control subsystem includes a digital timer for generating the switching signals and a digital controller for configuring the parameters of the digital timer, such as the period or duty cycles.
The pattern of switching signals generated is pre-programmed at the control subsystem.
The pattern of switching signals is generated by the digital timer.
Defining “NMN” the on time of the nominal 50% duty cycle, and “INC” the asymmetrically increased on time, some possible examples of sequences for the HIGH-LOW signals on times would be:
   1. INC-NOM / repeating..
   2. INC-NOM / NOM-INC / repeating..
   3. NOM-NOM / INC-INC / NOM-NOM /INC-INC / repeating.
   4. INC-NOM / NOM-NOM / INC-NOM / NOM-NOM / repeating.
   5. INC-NOM / NOM-NOM / NOM-INC / NOM-NOM / repeating.

### Concept D - Method of Controlling the LLC Converter During a Soft Start Up

A method of controlling the switching signals of an LLC power converter, during a soft start up, in which the LLC power converter includes a first switch connected between a DC input voltage and a half bridge node, and a second switch connected between the half bridge node and a ground input;
the method including, at a control subsystem, generating a first switching signal and a second switching signal for controlling the first switch and the second switch of the LLC power converter,
and in which, during the soft start up, the first switching signal has a significantly lower duty cycle than the second switching signal.

Optional features:
The first and second switching signals are generated as asymmetrical signals.
Turn off time of the first switching signal is significantly higher than the turn on time of the first switching signal.
The first switch is configured to energize the LLC power converter starting from the DC input voltage.
Soft start up refers to the gradual turning on of the power converter to avoid stressing the components by a sudden current or voltage surge.

### Concept E - Secondary Side Controller Keeping the Rectifier in Idle Until the Soft Start Up is Over

A method of controlling the switching signals of an LLC power converter during a soft start up, in which the LLC power converter includes a first switch connected between a DC input voltage and a half bridge node, a second switch connected between the half bridge node and a ground input; and a transformer including a primary winding and a secondary winding, the secondary winding being connected to a rectifying circuit for providing a rectified DC voltage to an output load;
the method including, at a primary side control subsystem, generating a first switching signal and a second switching signal for controlling the first switch and the second switch of the LLC power converter during the soft start up,
and in which the method further includes the step of, at a secondary side control subsystem, keeping the secondary side rectifier in idle until the soft start up has ended.

Optional features:
The secondary side control subsystem is configured to keep the rectifying circuit turned off for a pre-determined duration.
the pre-determined duration corresponds to the duration of the soft start up.
The rectifying circuit includes switches or ideal diodes, and the secondary side control subsystem is configured to keep the switches or ideal diodes of the rectifying circuit turned off for a pre-determined duration during the soft start up.
While the rectifying switches or ideal diodes are turned off, they behave as simple diodes permitting the current to flow in one direction only.
Additional diodes are added in parallel to one or more rectifying switches in order to provide a path for the rectifier current while the switches are turned off.
Secondary side control circuit is implemented as firmware.
Secondary side control circuit is implemented as hardware.
Secondary side control subsystem is composed of a first (or big) capacitor connected to the output voltage and to an active-low enable signal.
The active-low enable signal is connected to a second (or small) capacitor with a resistor.
The anodes of two low-current diodes are connected to the small capacitor.
The cathodes are connected to the drains of the two FETs used as ideal diodes.
The big capacitor is initially not charged, so the enable signal is equal to the output voltage.
The ideal diode controllers need both high output voltage and low enable signal in order to command the FETs, so they initially are in idle condition.
When the rectifying FETs′ body diodes (or the external diodes) are turned on, forced by the secondary winding, the low-current diodes turn on and provide a current path capable of charging the capacitor and of pulling down the active-low enable signal.
After a certain period, ie. similar to the duration of the soft-start routine, the output voltage is significantly high and the active-low enable signal is significantly low: this makes the ideal diode controllers start commanding the FETs.

### Concept F - Method of Controlling the LLC Converter Under Light Load Conditions

A method of controlling the switching signals of an LLC power converter, in which the LLC power converter includes a first switch connected between a DC input voltage and a half bridge node, and a second switch connected between the half bridge node and a ground terminal;
the method including, at a control subsystem, generating a first switching signal and a second switching signal for controlling the first switch and the second switch of the LLC power converter,
in which, the first switching signal has a significantly lower duty cycle than the second switching signal,
and in which the duty cycle of the first switching signal is optimised for light load conditions at an output load of the LLC power converter.

Optional features:
Turn off time of the first switching signal is pre-configured such that low power is delivered at the output load of the LLC power converter.
Turn off time of the first switching signal is fixed.
Turn on time of the first switching cycle is increased in order to deliver more power at the output load.
Light load conditions refer to a load that is less than 10% of the peak load. The peak load refers to the highest load (in terms of power) that the power converter is configured to be able to deliver to a load.

We now describe a number of implementations in which the LLC converter includes a transformer configured as a weakly coupled transformer. The weakly coupled transformer may also be implemented using the features described in Section I above or by any of the following concepts G to J.

### Concept G - Weakly Coupled Transformer (an Example Is Shown in FIG. 23)

Weakly coupled transformer comprising:
(i) a single core having a central leg and two lateral legs connected to each other with end members, in which the central leg comprises an air gap,
(ii) two inductors having windings (wire-wound and/or planar) each arranged around one of the lateral leg;
and in the two inductors are configured to have a weak mutual coupling k where k is determined by selecting the central gap.

### Concept H - Weakly Coupled Transformer (an Example Is Shown in FIG. 24)

Weakly coupled transformer comprising:
(i) a single core having a central leg and two lateral legs connected to each other with end members, in which the central leg comprises an air gap,
(ii) two inductors having windings (wire-wound and/or planar) each arranged around near the air gap on one side of the central gap;
and in the two inductors are configured to have a weak mutual coupling k where k is determined by selecting the central gap.

### Concept I - Weakly Coupled Transformer (an Example Is Shown in FIG. 25)

Weakly coupled transformer comprising:
(i) a single core having a central leg and two lateral legs connected to each other with end members, in which the central leg comprises an air gap,
(ii) a central winding arranged on the central leg,
(iii) a first and second outer windings arranged on the lateral legs; and in which the first and second outer windings are configured to have a weak mutual coupling k where k is determined by selecting the central gap.

### Concept J - Coil Former for Weakly Coupled Transformer (examples Are Shown in FIG. 23)

Weakly coupled transformer comprising: a single core, a primary winding and a secondary winding arranged around the single core; and in which the spacing between one or more turns of the secondary winding is calibrated or controlled such that the primary and secondary winding have a specific weak mutual coupling k that is determined by selecting the different spacings.

Optional features:
Dummy wire winding is used to calibrate the different spacings.
Dummy wire is non-conductive.
Coil former is used to calibrate the different spacings
Spacing between the primary and secondary windings is also calibrated.
Coil former shell between the primary and secondary windings is used.
Insulating tape between the primary and secondary windings is used.
Windings are insulated wires.
Providing an accurate spacing between one or more PCBs and/or one or more wire windings.

### Section III. Wireless Charging

### Concept A - Wireless Charger Integrating AC/DC Converter (Insulated)

A device for wireless charging comprising an insulated housing that includes an AC/DC converter and a wireless charger.

Optional features:
The housing includes an interface to receive an AC input voltage (the wireless charger is directly supplied by the grid and does not include any input stage).
The wireless charger includes a transmitter coil that is optimised based on different wireless protocols.
The wireless charger is optimised by adjusting its operating frequency and/or duty cycle.
The wireless charger is optimised for long range wireless protocol with k less than 0.5.
The wireless charger is optimised for short range wireless protocols with k greater than 0.5.
The housing includes a flat top surface.
AC/DC converter includes a bridge rectifier to rectify the AC input voltage and a DC to DC converter.
AC/DC converter is implemented with a Class-D, Class E, half-bridge, full bridge or any other converter topology.
The wireless charger does not need an isolated AC/DC adapter to connect to the AC/DC converter.
The wireless charger is able to achieve ZVS.
The wireless charger is able to achieve ZVS for a variety of load conditions.
The housing includes a flat surface for power charging.
The wireless charger is configured to deliver wireless power to a receiver device.

### Concept B - Single Stage Circuit Including a Wireless Charger and AC/DC Converter (Insulated)

A device for wireless charging comprising an insulated housing that includes an AC/DC converter and a wireless charger, in which the AC/DC converter and wireless charger are integrated as a single stage circuit.

Optional features:
A bridge rectifier directly connects to the transmitter coil driving circuit.
A coil driving circuit optimises the wireless charger by adjusting its operating frequency and/or duty cycle.
The device is implemented using only one integrated circuit.

### Concept C - Wireless Charger

A wireless charger comprising a transmitter coil and a driving circuit that is configured to drive the transmitter coil, the driving circuit including an input or choke inductor and a capacitor put in parallel with the transmitting coil, and in which the driving circuit resonant frequency is tuned by adjusting the choke inductor and capacitor, and in which the driving circuit includes two branches implemented in a push pull configuration.

Optional features:
The driving circuit optimises the wireless charger by adjusting its operating frequency and/or duty cycle.
The driving circuit includes multiple branches implemented in a push pull configuration.
when the driving circuit only includes one branch, a DC block capacitor is added along the current path of the transmitter coil.
Each branch of the driving circuit only includes one switch or MOSFET.
Each switch can be made of several parallel MOSFETs driven with the same control signal
The switch is a BJT, MOSFET (Si or SiC) or a GaN HEMT.
One terminal of the inductor is connected to the input voltage, the other terminal of the inductor is connected to the drain of the MOSFET, the source of the MOSFET connected to GND, the drain of the MOSFET connected to the parallel made of the capacitor and the transmitting coil.
Wireless charger is configured to deliver up to 65 Watts to a load.
Wireless charger is configured to deliver power to a load over a distance of less than 10 mm.
Wireless charger is configured to operate at ZVS thanks to the resonance of the reactive components of the driving circuit.

### Concept E - Wireless Charger

A wireless charger comprising a transmitter coil and a driving circuit based on a half bridge topology, in which
the first node of the transmitter coil connects to an input source, such as AC or DC input, and the second node of the transmitter coil connects to two switches (such as upper and lower MOSFETS) via an half bridge node,
and in which a capacitor is connected between the drain terminal of the upper MOSFET and the source terminal of the lower MOSFET.

Optional features:
The primary side half bridge circuit is configured to provide a required switching frequency.
When the input source is an AC input, the drain terminal of the upper MOSFET connects to the input source through a diode and the source terminal of the upper MOSFET connects to the second node of the transmitting coil.
The source terminal of the lower MOSFET is connected to the input source through a diode; the drain terminal of the lower MOSFET connects to the second node of the transmitting coil.
The AC input is rectified by an input bridge rectifier followed by a big capacitor, such that the input source of the converter is quasi-DC.
The AC input is rectified by an input bridge rectifier followed by a small (or none) capacitor, such that the input source of the converter is a rectified sine.
When the input source is a DC input, its positive terminal is connected to the one node of the transmitting coil, and its negative terminal is connected to the source terminal of the lower MOSFET.
When the input source is a DC input, the negative terminal of the DC input is connected to one node of the transmitting coil, and its negative terminal is connected to the drain terminal of the upper MOSFET.
A capacitor is connected to the drain of the upper MOSFET and one terminal of the transmitting coil, another capacitor is connected to the source of the lower MOSFET and the same terminal of the transmitting coil.
The bridgeless isolated converter directly connects to an AC input voltage to provide a single stage wireless charger.
The wireless charger works at a frequency higher than an LC resonator resonant frequency and is able to achieve ZVS. The low MOSFET is always turned off when the transmitting coil current is flowing toward the half bridge node, so, during the dead time, the leakage inductance of the coil pushes current to the node increasing its voltage till the voltage across the high-side MOSFET is zero. The high-side MOSFET is then turned on in ZVS. The high-side FET turns off when the transmitting coil is drawing current from the half bridge node, so the node reaches zero volts and the low-side MOSFET is turned on in ZVS.
Receiving coil is connected to a rectifier, such as a voltage double circuit or a full bridge circuit or any other rectifier circuit.
One inrush current diode is placed between an input terminal and the source of the low-side MOSFET, in order to limit the MOFET stress due to the startup charge of the capacitor.
One inrush current diode is placed between an input terminal and the drain of the high-side MOSFET, in order to limit the MOFET stress due to the startup charge of the capacitor.
One inrush current diode is placed between the half bridge node and the source of the low-side MOSFET, in order to limit the MOFET stress due to the startup charge of the capacitor.
One inrush current diode is placed between the half bridge node and the drain of the high-side MOSFET, in order to limit the MOFET stress due to the startup charge of the capacitor.
One voltage clamping device (zener diode, Transient Voltage Suppressor, Metal Oxide Varistor or similar) is placed between an input terminal and the source of the low-side MOSFET.
One voltage clamping device (zener diode, Transient Voltage Suppressor, Metal Oxide Varistor or similar) is placed between an input terminal and the drain of the high-side MOSFET.
One voltage clamping device (zener diode, Transient Voltage Suppressor, Metal Oxide Varistor or similar) is placed between the half bridge and the source of the low-side MOSFET.
One voltage clamping device (zener diode, Transient Voltage Suppressor, Metal Oxide Varistor or similar) is placed between the half bridge node and the drain of the high-side MOSFET.
One or more diodes provide both inrush current protection and voltage clamping protection.

### Concept F - Communication Between Secondary and Primary Side

Any of the device or wireless charger as defined above, in which communication between secondary and primary side is based on one of the following: the parasitic capacitance between the transmitter and the receiver as a capacitive data coupling, a proximity antenna, or on coupled signal inductors.

Optional features:
The proximity antenna is an NFC (Near Field Communication) antenna.
Inductive data coupling based on weakly coupled signal coils.
High bandwidth (ie. 10 Mbps) low latency (ie. 10 ns)
Synchronous control of active switches on both receiver and transmitter sides.

### Concept G - Sensing Circuit for Reading Very Low Voltage

A sensing network configured to discriminate very small voltage signals modulated over very large voltage waveforms, in which the sensing network is connected at the resonant node of a LC wireless transmitter and comprises: (i) a voltage divider connected to the resonant node of the LC; (ii) a first diode and a variable voltage source connected in series to the output of the voltage divider, (iii) a high-pass RC filter connected to the output of the voltage divider, with resistor connected to ground (iV) a second diode connected to the output node of the high-pass RC filter.

Optional features:
The second diode is connected to the ADC pin of a microcontroller.
The variable voltage source is obtained with a digital output of the microcontroller and a RC circuit.
The variable voltage source is sized according to the amplitude of the voltage on the voltage divider, to set the clipping threshold.
The cathode of the first diode is connected to the output of the voltage divider.
The anode of the first diode is connected to the output of the voltage divider.
The second diode is integrated in the microcontroller.
The second diode is an external diode.

### Concept H - Distance Recognition for Long Range System Calibration

Method for calibrating the distance between a wireless charger and a receiver device, the wireless charger including a transmitter coil and the receiver device including a receiver coil, the method comprising:
placing the transmitter coil at a fixed position;
placing a calibration subsystem at a fixed distance from the fixed transmitter coil;
measuring a parameter at the transmitter coil and calibrating the wireless charger for the fixed distance;
and in which the calibration is automatically lost when the transmitter coil is moved.

Optional features:
Parameter includes quality factor, impedance value or resonant frequency.
The calibration subsystem includes a sheet of metal.
Wireless charger is configured to deliver up to 20 Watts to a load.
Wireless charger is configured to deliver power to a load over a distance of up to 35 mm or 50 mm.

### Concept I - Distance Recognition for Long Range System Calibration Including a Wireless Repeater

Method for calibrating the operable distance between a wireless charger and a receiver device, the wireless charger including a transmitter coil and the receiver device including a receiving coil, the method comprising:
placing the transmitting coil at a fixed position;
placing a wireless repeater at a fixed distance from the fixed transmitter coil;
measuring a parameter at the transmitter coil and calibrating the wireless charger for the fixed distance;
and in which the wireless repeater includes a first inductor that is optimised to receive power from the transmitter coil, and a second inductor that is optimised to transmit power to the receiving device.

Optional features:
The wireless repeater includes a series resonant capacitor.
The first inductor of the wireless repeater is shaped to substantially match the shape of the transmitter coil.
Second inductor of the wireless repeater is shaped to substantially match the shape of a receiving coil of the receiving device.
The parameter includes resonant frequency.
Parameter is first measured without the presence of the wireless repeater.

### Section IV. Insulated Converter

### Concept A - Insulated Converter

An insulated converter comprising: a transformer including a primary winding and a secondary winding arranged in a forward configuration;
in which a first node of the primary winding connects to an input source, such as AC or DC input, and a second node of the primary winding connects to an upper switch and a lower switch via an half bridge node or switching node;
and in which the primary winding and secondary winding are arranged on the same core and configured to have a weak mutual coupling k.

Optional features:
The transformer is a weakly coupled transformer as implemented by any of the features listed above.
Half bridge circuit is configured to provide a required switching frequency.
When the input source is an AC input, the drain terminal of the upper MOSFET connects to the input source through a diode and the source terminal of the upper MOSFET connects to the second node of the primary winding.
The source terminal of the lower MOSFET is connected to the input source through a diode; the drain terminal of the lower MOSFET connects to the second node of the primary winding.
The AC input is rectified by an input bridge rectifier followed by a big capacitor, so the input source of the converter is quasi-DC.
The AC input is rectified by an input bridge rectifier followed by a small (or none) capacitor, so the input source of the converter is a rectified sine.
When the input source is a DC input, its positive terminal is connected to one node of the primary winding, and its negative terminal is connected to the source terminal of the lower MOSFET.
When the input source is a DC input, its negative terminal is connected to one node of the primary winding, and its positive terminal is connected to the drain terminal of the upper MOSFET.
A capacitor is connected to the drain terminal of the upper MOSFET and the source terminal of the lower MOSFET.
A capacitor is connected to the drain terminal of the upper MOSFET and one terminal of the primary winding, another capacitor is connected to the same terminal of the primary winding and the source terminal of the lower MOSFET.
The bridgeless isolated converter directly connects to an AC input voltage to provide a single stage wireless charger.
The converter works in forced continuous conduction mode and is able to achieve ZVS. The low MOSFET is always turned off when the primary winding current is flowing toward the half-bridge switching node, so, during the dead time, the leakage inductance of the winding pushes current to the node increasing its voltage till the voltage across the high-side MOSFET is zero. The high-side MOSFET is then turned on in ZVS. The high-side FET turns off when the primary winding is draining current from the switching node, so the node reaches zero volts and the low-side MOSFET is turned on in ZVS.
Secondary winding is connected to a rectifier, such as a voltage double circuit or a full bridge circuit or any other rectifier circuit.
Windings are wire windings.
Windings are planar windings printed on a substrate.
Primary and secondary windings are planar windings printed on the same substrate.
Primary windings are printed on one side of the substrate, and the secondary windings are printed on the other side of the substrate.
Primary winding is printed on the inner layers of the substrate.
Secondary winding is printed on the inner layers of the substrate.
Windings are a combination of wire windings and planar windings.
One inrush current diode is placed between an input terminal and the source terminal of the low-side MOSFET, in order to limit the MOFET stress due to the startup charge of the capacitor.
One inrush current diode is placed between an input terminal and the drain terminal of the high-side MOSFET, in order to limit the MOFET stress due to the startup charge of the capacitor.
One inrush current diode is placed between the switching node and the source terminal of the low-side MOSFET, in order to limit the MOFET stress due to the startup charge of the capacitor.
One inrush current diode is placed between the switching node and the drain terminal of the high-side MOSFET, in order to limit the MOFET stress due to the startup charge of the capacitor.
One voltage clamping device (zener diode, Transient Voltage Suppressor, Metal Oxide Varistor or similar) is placed between an input terminal and the source terminal of the low-side MOSFET.
One voltage clamping device (zener diode, Transient Voltage Suppressor, Metal Oxide Varistor or similar) is placed between an input terminal and the drain of the high-side MOSFET.
One voltage clamping device (zener diode, Transient Voltage Suppressor, Metal Oxide Varistor or similar) is placed between the switching node and the source terminal of the low-side MOSFET.
One voltage clamping device (zener diode, Transient Voltage Suppressor, Metal Oxide Varistor or similar) is placed between the switching node and the drain terminal of the high-side MOSFET.
One or more diodes provide both inrush current protection and voltage clamping protection

### Concept B - Insulated Converter Used as a PFC

A PFC comprising an isolated converter, the isolated converter comprising a transformer including a primary winding and a secondary winding arranged in a forward configuration;
in which a first node of the primary winding connects to an input source, such as AC or DC input, and a second node of the primary winding connects to an upper switch and a lower switch via an half bridge node or switching node;
in which the primary winding and secondary winding are arranged on the same core and configured to have a weak mutual coupling k.
and in which the Power Factor Correction is obtained by controlling the converter in order to absorb a current with almost the same waveform and phase of the input voltage and a low harmonic content.

Optional feature:
The input source is AC or rectified AC.

### Concept C - Battery or Supercapacitor as Storage Element

An isolated converter comprising a transformer including a primary winding and a secondary winding arranged in a forward configuration;
in which a first node of the primary winding connects to an input source, such as AC or DC input, and a second node of the primary winding connects to an upper switch and a lower switch via an half bridge node or switching node;
and in which the primary winding and secondary winding are arranged on the same core and configured to have a weak mutual coupling k, and in which the storage element is located on the secondary side, after a rectifier circuit.

Optional features:
The storage element includes one or more batteries.
The storage element is a supercapacitor.

### Concept D - Primary Side Capacitor Used as Storage Element

An isolated converter comprising a transformer including a primary winding and a secondary winding arranged in a forward configuration;
in which a first node of the primary winding connects to an input source, such as AC or DC input, and a second node of the primary winding connects to an upper switch and a lower switch via an half bridge node or switching node;
and in which the primary winding and secondary winding are arranged on the same core and configured to have a weak mutual coupling k, and in which one or more primary side capacitors are used as storage elements.

Optional features:
The mutual coupling k is about 0.5.
The mutual coupling k is about 0.9.
A storage capacitor is connected to the drain terminal of the upper MOSFET and the source of the lower MOSFET.
A storage capacitor is connected to the drain of the upper MOSFET and one terminal of the primary winding, a second storage capacitor is connected to the same terminal of the primary winding and the source of the lower MOSFET.
The converter is supplied with an AC or a rectified AC voltage and operates as a PFC. When the power absorbed from the input is higher than (or less than) the power delivered to the load, the exceeding (or needed) power is stored in (or withdrawn from) the storage capacitor.
In case of an temporary input voltage drop, the converter is able to provide power to the load by extracting it from the previously charged stored capacitor.

### Concept E - Light Load Conditions

An insulated converter comprising:
a transformer including a primary winding and a secondary winding arranged in a forward configuration;
in which a first node of the primary winding connects to an input source, such as AC or DC input, and a second node of the primary winding connects to an upper switch and a lower switch via an half bridge node or switching node;
a load located at the secondary side circuit; in which the turn off time of the isolated converter is adapted or changed in a continuous way.

Optional features:
The primary winding and secondary winding are arranged on the same core and configured to have a weak mutual coupling k.
The primary winding connects to two switching MOSFETs, namely an upper MOSFET and a lower MOSFET, and in which the duty cycle on the primary side is reduced by controlling the upper MOSFET.
upper MOSFET is turned off when the voltage at the capacitor is at its maximum.
the converter is configured to restart under zero volt or zero current conditions after an amount of time in which both the upper MOSFET and lower MOSFET are turned off.
The converter is able to achieve more than 90% efficiency under light load conditions.
Light load conditions refer to a load that is less than 10% than the peak load.

### Concept F - Rectifier MOSFETs with Delayed Turn-off

An insulated converter comprising:
a transformer including a primary winding and a secondary winding arranged in a forward configuration;
in which a first node of the primary winding connects to an input source, such as AC or DC input, and a second node of the primary winding connects to an upper switch and a lower switch via an half bridge node or switching node;
in which the secondary side circuit includes a rectifying circuit and a load;
and in which the turn off time of the rectifying circuit is delayed in order to reflect part of the energy received on the secondary side circuit back to the primary side circuit via the coupling between the primary winding and secondary winding.

Optional features
The turn off time of the rectifying circuit is delayed by a specific time duration that is determined in order to regulate the output voltage or current at the load.
The delay is implemented by a closed-loop controller, such as a Proportional,

Integrative and Derivative (PID) controller.
The delay is increased to reduce the output voltage or current at the load.
The delay is determined or calculated by a digital controller.
The delay is implemented using an analog circuit.
One or more of the rectifying switches are turned off with a certain delay, and one or more switches are turned off with no delay.
The converter is configured to provide PFC and output power regulation.
The delayed turn off technique is used to have an extra degree of freedom and easily

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1-28. (canceled)

29. An electromagnetic device comprising:
(i) a single core having a central leg and two lateral legs connected to each other with end members, in which the central leg and the two lateral legs each comprises an air gap, the air gap of the central gap being smaller than the lateral legs air gaps;
(ii) two inductors having windings arranged around one of the end members; and in which the multiple inductors are configured to have a weak mutual coupling k where k is determined by selecting the ratio between the central gap and the two lateral gaps.

30. (canceled)

31. The electromagnetic device of claim 29, in which the device is configured such that reducing the central gap size reduces the coupling between the two inductors.

32. The electromagnetic device of claim 29, in which the central gap is half as big as the lateral gaps.

33. The electromagnetic device of claim 29, in which the central gap is four times smaller than the lateral gaps.

34. The electromagnetic device of claim 29, in which the mutual coupling k is less than 0.5.

35. The electromagnetic device of claim 29, in which the mutual coupling k is less than 0.35.

36. The electromagnetic device of claim 29, in which the mutual coupling k is more than 0.5 and less than 0.95.

37. The electromagnetic device of claim 29, in which in the windings of the inductors are either wire windings, planar windings printed on a substrate, or a combination thereof.

38. The electromagnetic device of claim 29, in which the windings of the inductors are planar windings printed on the same substrate.

39. A PFC converter comprising the electromagnetic device as defined in any of claim 29.

40. The PFC converter of claim 39, in which the mutual coupling k is selected based on one or more of the following: parameters of the magnetic core, type of MOSFET, input voltage required, and output voltage required.

41. The PFC converter of claim 39, in which the current needed to drive the multiple inductors is reduced by implementing interleaved multi-phase operations.

42. The PFC converter of claim 39, in which the mutual coupling k is selected in order to minimize the global losses.

43. The PFC converter of claim 39, in which the mutual coupling k is determined to be able to discharge the drain of the active MOSFET used in the PFC converter.

44. The PFC converter of claim 39, in which k is less than 0.4 and the PFC achieves 99% efficiency with an output power of about 300 W.

45-136. (canceled)

137. The electromagnetic device of claim 29, in which the winding of the first inductor is arranged on a portion of the end member between the first lateral leg and the central leg, and the winding of the second inductor is arranged on a portion of the end member between the central leg and the second opposite lateral leg.

138. The electromagnetic device of claim 29, in which the winding of the first inductor and the winding of the second inductor are wound in opposite directions.

139. The electromagnetic device of claim 29, in which the device is configured such that the magnetic energy of the flux path of the first inductor is substantially concentrated within the first lateral leg air gap and the magnetic energy of the flux path of the second inductor is substantially concentrated within the second opposite lateral leg air gap.
